(19) United States
(12) Patent Application Publication
(10) Pub. No.: US 2005/0264472 A1
(43) Pub. Date: Dec. 1, 2005

(54) Display methods and systems

(76) Inventor: Rodger H. Rast, Gold River, CA (US)

Correspondence Address: RODGER H. RAST, 11230 GOLD EXPRESS DRIVE, SUIT 310 MS 337, GOLD RIVER, CA, 95670, US

(21) Appl. No.: 10/670,432

(22) Filed: Sep. 23, 2003

Related U.S. Application Data
(60) Provisional application No. 60/413,199, filed on Sep. 23, 2002.

(51) Int. Cl. G09G 3/00

(52) U.S. Cl. 345/30

(57) ABSTRACT

A method and system of controlling element activation within arrays subject to row and column address signaling. The display, or other form of output device, is configured with circuitry for controlling element activation. The multiplexed row and column signals are utilized for commanding activation of the element, whereas power is constantly provided for driving the display element. By way of example, an embodiment is described wherein the row and column lines can be driven from providing steady-state power to selecting the element for activation or deactivation during the next multiplexing interval. Additional display embodiments are described to suit various applications.

### CROSS-REFERENCE TO RELATED APPLICATIONS

This application claims priority from U.S. provisional application Ser. No. 60/413,199 filed on Sep. 23, 2002.

### STATEMENT OF FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

This invention pertains generally to display systems and more particularly to a method of controlling LED display arrays.

2. Description of the Background Art

Conventional row and column multiplexed displays typically comprise LED display elements or incandescent light elements that are connected between row signal and column signal. Each element is only activated to an ON-state by applying power to the associated row while grounding the associated column for the element (or the converse). The intensity of the element being determined by the relative amount of time the element is active. A number of drawbacks exist for these displays, a major problem being the lack of intensity of active elements as the maximum percentage of time the element is active is dependent on the depth of multiplexing.

For example consider a graphic LED display array of 640 elements wide by 480 elements in height, considering for now only a monochrome display, and ignoring for now the use of multiple colors. If the display can be multiplexed six levels deep by dividing the 480 vertical elements into 80 rows, each having 6 vertical elements. The 640 horizontal elements may be divided into 128 columns of 5 horizontal elements each. This arrangement would be a common arrangement for a display array, in particular one in which the LEDs are contained within a module that is 6 pixels high and 5 pixels wide. A driver chip of a first polarity output is then connected to each of the 80 rows with each driver chip capable of driving the 6 lines of elements within its row. Another set of different drivers with a second output polarity, is connected to each of the 128 columns with each driver chip capable of driving the 5 lines of elements within its column.

The preceding describes a substantially conventional way for creating a large display array. Although a huge number of drivers are required within this display array, it will be appreciated that the maximum intensity of any one LED is severely reduced as the LED may only be active a maximum of 1/6 of the total time, thereby intensity suffers. It is for this reason that the pixels of large outdoor displays are often driven individually, whereas the amount of drivers is extended another six fold.

Accordingly, a need exists for implementing multiplexed displays that do not suffer from an intensity loss with respect to multiplex depth. The present invention is inexpensive to implement and fulfills that need and others. The present invention includes other display enhancements and non-display related enhancements.

### SUMMARY OF THE INVENTION

The present aspect of the invention describes a method of address multiplexing an array of display elements which improves multiplexed display intensity. A method is described for multiplexing display elements without a loss of contrast, such as for outdoor displays. The control of display element “activation triggering” is determined in the present invention by row and column signals, however, the power for driving the elements are supplied by other means. In this way the display can be multiplexed to reduce wiring and driver needs, while maintaining high intensity light output from the devices.

The technology addresses similar problems as those described in patent application Ser. No. 10/612,221 filed Jul. 1, 2003 in sections LED lighting along with provisional patent application 60/394,160 filed Jul. 1, 2002, and the application entitled “A System And Method Of Driving An Array Of Optical Elements” Ser. No. 09/924,973 filed Aug. 7, 2001, and provisional patent application Ser. No. 60/223,659 filed Aug. 7, 2000, all of which are incorporated herein by reference. The application also claims priority from U.S. provisional application Ser. No. 60/413,199 filed on Sep. 23, 2002 which is also incorporated herein by reference.

A number of embodiments are described according to this aspect of the invention, for example (1) quad-state row and column driving, (2) separating activation signals from power signals, and (3) extending element active periods.

An aspect of the invention is to increase the available intensity when driving multiplexed display elements.

Another aspect of the invention is to increase display intensity while retaining the same row and column display drive scheme.

Another aspect of the invention is to provide for separating activation (control signals) from power signals.

Another aspect of the invention is to provide a mechanism for quad-state row and column driving where multiple voltage states exist for row and/or column lines distinguishing drive power and signal.

Another aspect of the invention is to extend the active periods of the display elements for increasing display brightness, irrespective of the use of display multiplexing.

Further aspect and advantages of the invention will be brought out in the following portions of the specification, wherein the detailed description is for the purpose of fully disclosing preferred embodiments of the invention without placing limitations thereon.

### BRIEF DESCRIPTION OF THE DRAWINGS

The invention will be more fully understood by reference to the following drawings which are for illustrative purposes only:

FIG. 1 is a schematic of quad-state row and column display elements according to an aspect of the present invention, shown connected in a row and column driver configuration.

FIG. 2 is a waveform of row and column signals according to as aspect of the present invention, showing the use of two positive potentials and two negative (ground) potentials.

FIG. 3 is a schematic of a simple mechanism for driving rows between two positive voltage levels.

FIG. 4 is a schematic of a simple quad-state row and column (QRC) LED according to an aspect of the present invention, showing an SR flip flop responsive to row and column voltage states controlling LED activity.

FIG. 5 is a diagram of wireless activation LED (WALED) devices according to another aspect of the invention, shown connected to a printed circuit board.

FIG. 6 is a schematic for a version of a wireless activation LED (WALED) according to an embodiment of the present invention, showing signal received through an antenna.

FIG. 7 is a schematic of a display LED (EIMDE) according to an aspect of the present invention, which is configured to allow extending the active interval of the display element beyond the multiplex interval.

FIG. 8 is a diagram of a display LED (EIMDE) according to an aspect of the present invention, shown manufactured with the integrated capacitor and circuitry.

FIG. 9 is a side view of a USLED display module wherein LED elements are connected to a first printed circuit board and control circuits are coupled to a second circuit board which is electrically connected to the first circuit board according to an aspect of the present invention.

FIG. 10 is a side view of a USLED display module wherein LED elements and control circuit are attached to different portions of a flex circuit according to an aspect of the present invention.

FIG. 11 is a side view of a USLED display module manufactured with control circuit assemblies extending from the rear of the printed circuit to which the display elements are connected according to an aspect of the present invention.

FIG. 12 is a side view of a USLED display module with surface mount LEDs or similar on the facing portion and control circuits on the rear portion according to an aspect of the present invention.

FIG. 13 is a flowchart of array position addressing according to an aspect of the present invention.

FIG. 14 is a block diagram of a circuit element configured to respond to array position addressing according to an aspect of the present invention.

FIG. 15 is a flowchart of PCB location specific programming of electronic units in a pick and place apparatus according to an aspect of the present invention.

FIG. 16 is a flowchart of peer programming of array elements according to an aspect of the present invention.

FIG. 17 is a top view of an adaptable knob legend employing electronic ink, or similar, according to an aspect of the present invention.

FIGS. 18A and 18B are top views of a selection knob according to an aspect of the present invention showing legend modification in response to rotation.

FIG. 19 is a top view of a raised knob containing electronic ink legends according to an aspect of the present invention.

FIG. 20 is a side view of the knob of FIG. 19.

FIG. 21 is a top view of another form of raised knob containing electronic ink legends according to an aspect of the present invention.

FIG. 22 is a side view of the knob of FIG. 21.

FIG. 23 is an edge view of a wheel knob containing an electronic ink legend according to an aspect of the present invention.

FIG. 24 is a side view of the wheel knob of FIG. 23.

FIG. 25 is a top view of a trackball style knob having electronic ink (or similar) legends according to an aspect of the present invention.

FIG. 26 is a side view of the trackball legend knob of FIG. 25.

FIG. 27 is a top view of a display having an electronic ink area (or similar) subject to being written in response to manual intervention according to an aspect of the present invention.

FIG. 28 is a side view of the display of FIG. 27.

FIG. 29 is a top view of a planar display having a section whose legend is written in response to manual intervention according to an aspect of the present invention.

FIG. 30 is a top view of a planar display having a section whose legend is written in response to movement of a wiper according to an aspect of the present invention.

FIG. 31 is an underside view of a ceiling fan unit containing display elements according to an aspect of the present invention.

FIG. 32 is a underside view of the ceiling fan unit of FIG. 31 showing a displayed time value in response.

FIG. 33 is a schematic of circuitry for controlling the display shown in FIG. 31 and FIG. 32 according to an aspect of the present invention.

FIG. 34 is a perspective view of a piano key, or similar, configured with an electronic ink legend according to an aspect of the present invention.

FIG. 35 is a cross-section of display elements of FIG. 34 according to an aspect of the present invention.

FIG. 36 is a transaction card incorporating an electronic ink region according to an aspect of the present invention.

FIG. 37 is a schematic of a point-of-sale system incorporating an electronic ink writing portion according to an aspect of the present invention.

FIG. 38 is a side view of a optical head actuator according to an aspect of the present invention.

FIG. 39 is a facing view of a piston power workout device according to an aspect of the present invention.

FIG. 40 is a facing view of a rotating piston notching pulley according to an aspect of the present invention.

FIG. 41 is a facing view of a compression-based notching device according to an aspect of the present invention.

FIG. 42 is a facing view of a athletic equipment cable pulley speed brake according to an aspect of the present invention.

FIG. 43 is a top view of a roadway surface with a vehicle traffic registration system according to an aspect of the present invention.

FIG. 44 is a cross-section view of the roadway surface of FIG. 43 according to an aspect of the present invention.

FIG. 45 is a flowchart of indirect sequencing according to an aspect of the present invention.

FIG. 46 is a block diagram of a monitoring system according to an aspect of the present invention.

FIG. 47 is a articulated element according to an aspect of the present invention, shown directing a laser light source.

FIG. 48 is a block diagram for a system that registers rearward object positioning according to an aspect of the present invention.

FIG. 49 is a block diagram of a data enabled tool according to an aspect of the present invention.

FIG. 50 is a block diagram of an adhesion limit prediction apparatus according to an aspect of the present invention.

FIG. 51 is a side view of a tire according to an aspect of the present invention, shown as in inset within FIG. 50.

FIG. 52 is a side view of a tire with sense strip according to an aspect of the present invention.

FIG. 53 is a cross-section of a sense rib according to an aspect of the present invention.

FIG. 54 is a cross-section of a sense rib according to an aspect of the present invention, shown subject to cornering force.

FIG. 55 is a cross-section of the sense rib of FIG. 54, shown subject to sufficient cornering force to induce traction loss.

FIG. 56 is a power generating compliant wheel according to an aspect of the present invention, showing use of a waffle core.

FIG. 57 is another power generating compliant wheel according to an aspect of the present invention, showing use of tensioned exterior strips.

FIG. 58 is another power generating compliant wheel according to an aspect of the present invention, shown implemented with compliant spoke elements.

FIG. 59 is a block diagram of a costing metric system according to an aspect of the present invention.

FIG. 60 is a flowchart for an interrupt service routine for the costing metric system according to an aspect of the present invention.

FIG. 61 is a flowchart for main service routine for the costing metric system according to an aspect of the present invention.

FIG. 62 is a facing view of an acceleration or motion sensing label according to an aspect of the present invention.

FIG. 63 is a side view of the label of FIG. 62.

FIG. 64 is a perspective view of an acceleration or motion sensing label according to an aspect of the present invention.

FIG. 65 is a schematic for the acceleration or motion sensing label according to an aspect of the present invention.

FIG. 66 is a cross-section of another acceleration or motion sensing label according to an aspect of the present invention.

FIG. 67 is a cross-section of another acceleration or motion sensing label according to an aspect of the present invention.

FIG. 68 is a perspective view of a motion platform according to an aspect of the present invention.

FIG. 69 is a top cross-section of a motion platform according to an aspect of the present invention shown in FIG. 68.

FIG. 70 is a side cross-section of a motion platform according to an aspect of the present invention shown in FIG. 68.

FIG. 71 is a block diagram of a method of directing collimated beams according to an aspect of the present invention.

FIG. 72 is a side view of an LED lighting system according to an aspect of the present invention.

FIG. 73 is a cross-section of the of LED lighting system of FIG. 72.

FIG. 74 is a schematic of a universal power adapter according to an aspect of the present invention.

FIG. 75 is a cross-section of a scrolling shade device according to an aspect of the present invention.

FIG. 76 is a cross-section view of a biasing means within the scrolling shade device of FIG. 75 according to an aspect of the present invention.

FIGS. 77 and 78 are top and side views of shade retention within the scrolling shade device of FIG. 75 according to an aspect of the present invention.

FIG. 79 is a facing view of a window actuator according to an aspect of the present invention.

FIG. 80 is a facing view of a window actuator according to another aspect of the present invention.

FIGS. 81 and 82 are side views of a track mechanism within another window actuator according to an aspect of the present invention.

FIG. 83 is a cross-section of a dip-stick tube crimping device according to an aspect of the present invention.

FIG. 84 is an edge view of a cutting blade for an electric razor according to an aspect of the present invention.

FIG. 85 is a side view of a laptop computer ventilating device according to an aspect of the present invention.

FIG. 86 is a edge view of the a laptop computer ventilating device of FIG. 85 with optional ribbed ventilation structure according to an aspect of the present invention.

### DETAILED DESCRIPTION OF EMBODIMENT(S)

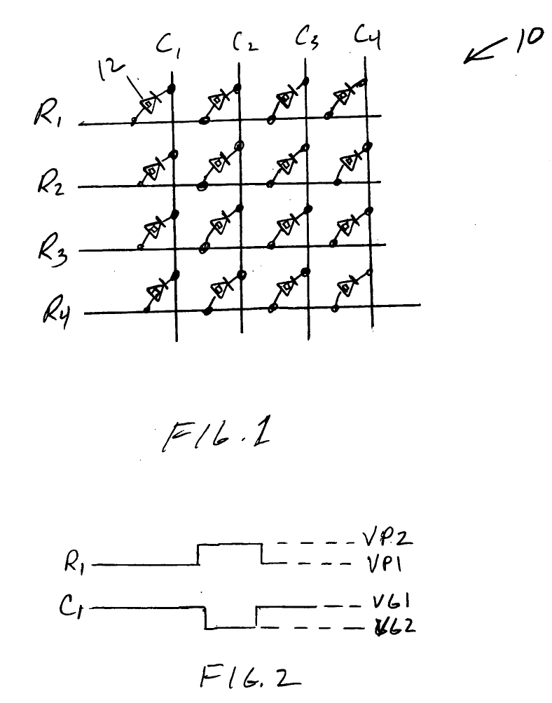

Referring more specifically to the drawings, for illustrative purposes the present invention is embodied in the apparatus generally shown in FIG. 1 through FIG. 86.

Illustrative embodiment(s) of the invention are described herein and depicted in the drawings, the invention is susceptible of embodiment in many forms and it should be understood that the present disclosure is to be considered as an exemplification of the principle aspects of the invention and is not intended to limit the invention to the embodiment(s) illustrated. Various aspects, modes, embodiments, variations, and features may be described throughout the specification which need not be implemented to practice aspects of the invention. Furthermore, preferred elements of the invention may be referred to whose inclusion is generally optional, limited to specific applications or embodiment, or with respect to desired uses, results, cost factors and so forth.

Throughout the specification numerous values and type designations may be provided for the elements of the invention in order that a complete, operable, embodiment of the invention be disclosed. However, it should be understood that such values and type designators are merely representative and are not critical unless specifically so stated. The scope of the invention is not limited to one or more specific exemplifications within a described embodiment.

The present system and method may be implemented in a number of ways, however, the following is limited to descriptions of one or more preferred embodiments of the invention that may be readily practiced and easily understood. It should be appreciated, however, that one of ordinary skill in the art can modify these embodiments, especially in view of the teachings found herein, to implement a number of variations on the embodied invention without the need for creative effort and without departing from the teachings of the invention as described and/or claimed.

1.0 Systems and Methods of Multiplexing an Array of Display Elements

A number of related embodiments are described within the present invention. Each of these embodiments allows the use of the row and column for triggering the display while not limiting the active display power.

1.1 Row and Column Signals for Triggering Activation.

The display elements may be utilized similarly to those connected in a row and column matrix, or other embodiments wherein row and column addressing, or other matrix forms are available. In the present invention the row and column signals are only utilized to trigger the element, either into a given time period of activation, or into an activation state wherein another signal is utilized to then turn the device back off again. This may be embodied in a number of alternative ways according to the invention, the following being provided by way of example and not of limitation.

1.1.1 Quad-State Row Column Driving.

FIG. 1 depicts “quad-state row and column display elements”, such as LEDs, referred to herein as “QRC LEDs” being connected in a conventional row and column arrangement 10. The schematic symbols for the LED elements 12 containing a box within the triangular portion to denote that they are not conventional LEDs. It will be appreciated that any standardized notation can be adopted for denoting that these are not conventional LEDs.

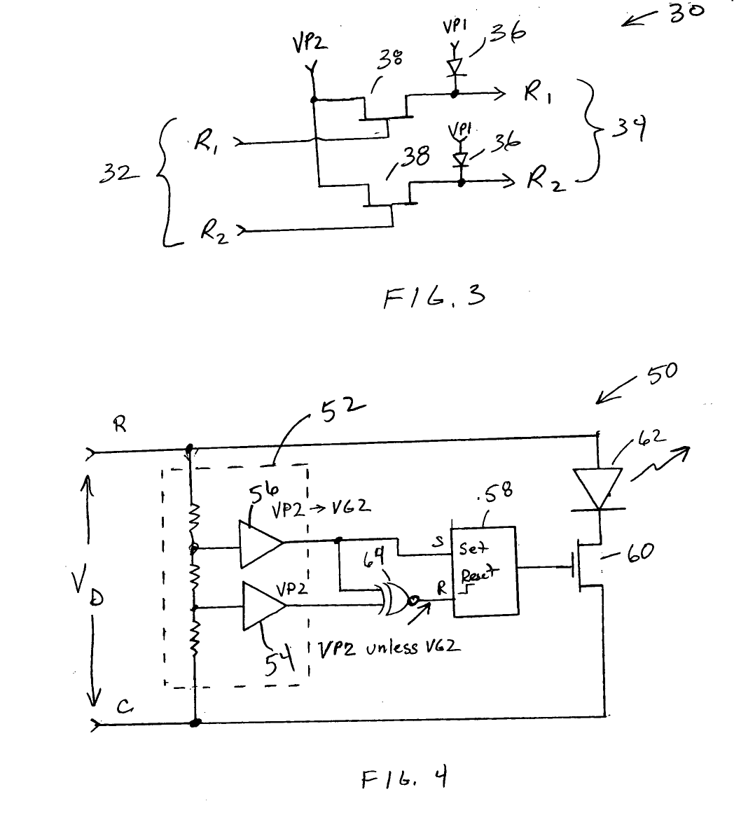

FIG. 2 depicts example signals for driving the QRC LEDs shown in FIG. 1. Power is generally supplied across the rows to columns continuously, for example each row being driven to a voltage VP1, while each column is pulled down to a voltage VG1. The potential difference between VP1 to VG1 is preferably selected to allow driving the display element to its maximum potential. In a conventional LED array, the LEDs would all then be driven to the ON state in response to the voltage potential existing between VP1 and VG1, wherein the display could not be controlled.

However, in the present invention the circuits are controlled by variations in the driving voltage. Each QRC display element is configured with a small circuit that determines when the element is to be driven into the active state. The selection of an element is determined by signals superimposed on the row and column signals. Selecting of a row occurs when it is driven to a potential VP2 wherein VP2>VP1. Selecting of a column occurs when it is driven to a potential VG2, wherein VG2<VG1. The voltage difference between VP2→VG2 being sensed by the element to trigger activation of the element.

FIG. 3 depicts a simple mechanism 30 for driving the rows between VP1 and VP2. The block diagram illustrates converting a conventional on/off row output 32 to a two level VP1 or VP2 output 34. It will be appreciated that the diode 36 provides the necessary isolation between rows which are being driven to the same potential. The switching element 38 provides the control of the high voltage VP2. A similar sort of circuit may be employed for column driving except with opposing polarity. It will be appreciated that this circuit may be utilized within a driver circuit, or less preferably to operate with an existing driver configured to reach the necessary voltages of VP2 and VG2.

The QRC LED element connected to appropriate drivers which receives this set of signals stays activated for a period which extends beyond the time during which the row and column are driven to VP2 and VG2 respectively.

A number of mechanisms may be utilized for controlling the duration of activation, including but not limited to (A) till next row (column) edge; (B) counting timing found in signals; (C) fixed time based on capacitance; (D) programmed value clocking.

1.1.1A Activate Till Subsequent Row Edge

An element is activated by setting row line to voltage VP2 and column line to VG2 (presuming a display sharing common row signals, otherwise rolls reversed). Preferably while the row line is being held at VP2 the column lines are driven to either VG1 or VG2 depending on whether the respective LEDs are to be Off or On respectively. The nesting of column times within the row times prevents false triggering

After this row has been addressed then the row signal drops again to VP1 and subsequent rows of the display are driven. After all rows are driven (depends on the depth of multiplexing not the absolute number of rows), then this row will again be driven to VP2 to update the elements within that row again.

Within this embodiment the element remains active until next edge of the row line transitioning from VP1 to VP2 (may be detected as edge, or dependent on row line dropping to VP1 and being trigger upon reaching VP2). In this way the display may be multiplexed to a far greater depth than current systems, without a loss of intensity. For example, a display may be driven utilizing a single set of row and column drivers for the entire display array, whereas currently a separate set of column drivers is required for every N rows of elements, with N being the multiplexing depth.

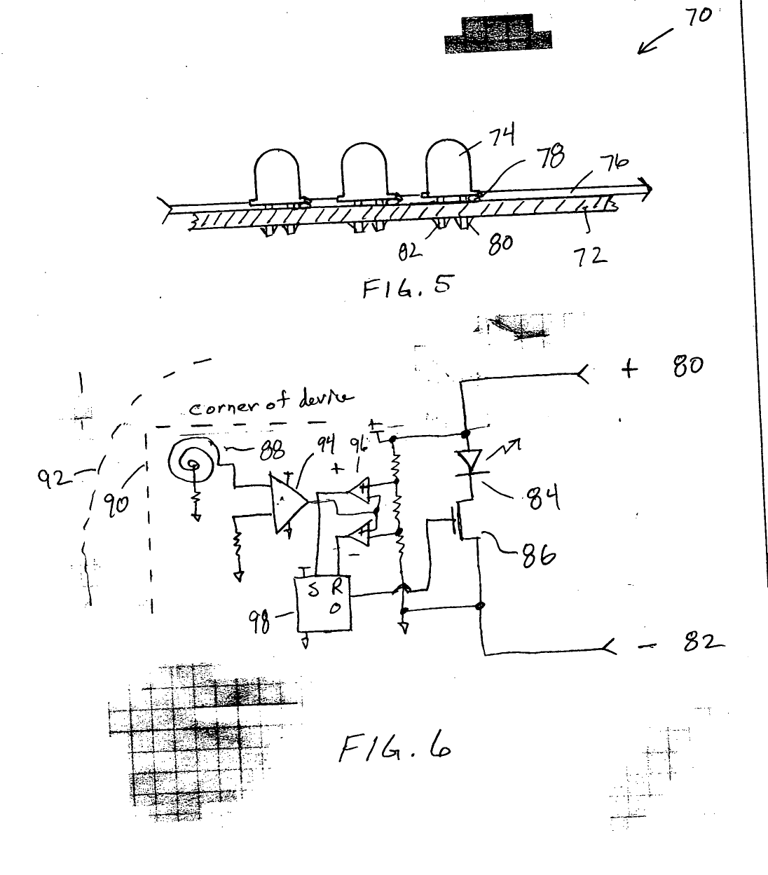

FIG. 4 depicts a block diagram 50 for a simple block diagram for the QRC LED which is configured to operate with |VP2−VP1|>|VG2−VG1|. For example, presume VP1 to VG1 is 5 volts, with VP2 to VG1 being 9 volts and VP2 to VG2 being 12 volts. This difference between row and column voltage differentials allows the circuit to easily determine whether a row or column is being driven.

The voltage applied to the diode is VD with the upper line connecting to a row and the lower line connecting to a column. A simple divider circuit 52 is shown across the input of the diode and two voltage detectors are configured to be triggered at two different voltages. A first detector 54 is triggered when the voltage difference is equivalent to (VP2−VG1) indicating a row activation without a column activation. A second detector 56 is triggered when the activation voltage is present (VP2−VG2). A simple set-reset flip-flop 58 can thus control the state of the LED driver 60 for allowing current to flow through LED 62.

It will be appreciated that the driver may be configured to provide a predetermined current while in the active state despite row and column voltage changes. This would require additional circuitry that is known in the art, or configuring driver FET 60 to also provide a current limit. Numerous LED configurations could tolerate the increased current at turn on with the circuit depicted, as it would not be retained for extended durations. Riding the fluctuations in output between cycles would actually allow the LED to switch on more rapidly and should not lead to overheating. The presence of the row signal without an accompanying column signal is utilized for resetting, and thereby deactivating (turning off) an LED that was programmed the last time the given row signal was active. For a QRC LED for which the row and column are set at VP2 and VG2 respectively, the flip-flop is set and the reset is prevented by the gating of the reset line, which is held low if the detector 56 output is active. The roles of the row and column voltage states can be reversed without departing from the teachings of the present invention. It should be appreciated that the output state is activated by excursions of the row and column voltages beyond providing a drive voltage to the display elements, wherein a number of modifications and enhancements may be made to this embodiment by one of ordinary skill in the art without departing from the teachings herein.

If noise is anticipated to be a problem, in view of the edge triggering of the reset line, it may be desirable to require that the row and column signals be qualified, such as requiring a dual transition within a given time space. In this way single transitions, such as spikes, would not effect the display output. In general voltage margins are fairly substantial within this circuit especially in view of the current being drawn, and such measures are generally not necessary.

It should also be recognized that alternative signal pairs may be utilized for triggering the QRC LED, aside from those described. The above example described amplitude triggering based on increased amplitude differentials. A similar circuit may be configured that utilizes decreased amplitude differentials, temporal differentials, phase differentials, and other differentials so long as power is still retained on the QRC LED between row activations for powering LEDs which have been selected by the method of the invention.

It should be noted that the described embodiment above provides a simple ON/OFF control of each pixel, wherein providing shades of gray would require that the pixels be turned on and off for intervals to provide the desired intensity. It will be appreciated, however, that the present invention may also be configured for activating an element for a given amount of time.

1.1.1B Counting Timing Found in Signals

The duration for which the LED is held active may be determined by using a counter within the QRC LED that registers clocks available on the row, column, or combination for communicating count value associated with the duration the element that is to be held active.

For example, a simple clock may be embedded within the row or column signal which can drive a counter within the QRC LED. Alternatively signals present on the row and/or column lines may be utilized or augmented to provide active duration clocking.

A count value is then passed at the time of activation, such as in response to a signal duration (i.e. length that signal across QRC LED=VP2−VG2), or clocks received within the signals as a count. Once activated the LED is held active as the count is modified (i.e. decremented) until the count reaches a terminal value, at which time the LED is deactivated. This allows the software to set the intensity of each LED, wherein the refresh intervals can be far less frequent than would be required otherwise for a given range of intensities. This counting may be implemented in a number of ways without departing from the present invention.

1.1.1C Fixed Time Based on Capacitance

Rather than embedding a clock within the row and column signals or utilizing the row and column clocks, the count value may be in response to a capacitive clock within the QRC LED. The clock circuit counts down (or up) a time loaded with the active duration value until it reaches a terminal value, at which time the LED drive goes inactive. It is preferable that capacitance variation be constrained, or that the circuit be configured to correct for any variance in capacitance values that could otherwise affect programmed LED intensity.

1.1.1D Analog Signal Duration Programming

This method is easy to implement although in certain applications it may be preferable to limit capacitance variation or to correct for it from one QRC LED to another. The length of the column signal in the present embodiment was limited by the length of the row signal, however, the length of the column signal may be modulated to communicate an activity duration. For example, a narrow column signal would translate to a short activity period for the LED while a longer column signal would translate to a longer activity period. It will be appreciated that the longest of these controlled activity periods preferably coincides with the arrival of the next row signal, which will set another activity period. In terms of implementation: during the time period over which the column signal is active at VG2 while row is active at VP2 a capacitor is charged. After the activation signals are no longer present, the capacitor is discharged at a slow rate while a comparator compares the capacitor voltage to a threshold. Upon crossing the threshold the output of the comparator signals the LED driver to deactivate the LED. It will be appreciated that the non-linearity of the duration programming may be precompensated for when the length of the column signals is determined, so that the charging and discharging does not necessarily require circuits for linearizing the input length of the column signal in relation to the time for which the LED is maintained in an active state.

1.2 Separating Activation Signals from Power Signals.

Departing from the conventional arrangement of row and column lines as described above, the backplane in the present inventive aspect carries the row and column signals separately from a power and ground plane for providing display element power. The separation of the row and column activation signals from the backplane may be accomplished in a number of ways. Described by way of example and not of limitation are: (A) row and column activation may be detected wirelessly; (B) row and column may be detected on additional signals.

1.2A Wireless Row and Column Signaling.

Each wireless activation display element, herein referred to as a wireless activation LED (WALED) is connected across a single power plane (power and ground common to all WALED elements) and contains a driver circuit adapted with a circuit to detect a nearby event associated with a row and column line. It should be appreciated that the approach may be utilized for other output elements such as other forms of displays, mirror actuators, mechanical actuators, and so forth without departing from the teachings herein. Upon detecting a nearby event the LED is activated for a predetermined or selectable time period, such as until deactivated or a specific time elapses, or a counter value terminates. A number of characteristics may be sensed by the WALED, such as electrical field strength, magnetism, capacitance, RF energy and so forth.

By way of example a mesh of row and column wires may be placed over an array of WALEDs connected to a power and ground plane. The row wires being retained closely to one surface of the WALED and the column wires retained closely to another. A potential between the row and column lines is sensed by a circuit within that segment of the WALED, wherein the WALED is triggered to activate. Additional information as to intensity or duration of time the LED is to be active may be also communicated wirelessly. The exterior of the WALED may even be configured, such as with notches, grooves or the like into which the row and column lines are inserted so as to assure that the proper distance is maintained between the wires and the WALEDs. The wire mesh may be preformed and cut to size for use with different displays. It will be appreciated that unlike conventional row and columns, these wires carry a negligible amount of current and thereby can be of a very small cross section. The row and column may also be carried directly on the power plane wherein the signal is picked up on the underside of the WALED.

FIG. 5 depicts a cutaway view 70 of a portion of an array of WALEDs being addressed wirelessly by a row and column. A circuit board 72 is shown having only power and ground traces to which WALEDs 74 are connected. Row and column traces or in this case layered wires 76, 78 are shown adhered to the top surface of the circuit board in orthogonal directions. Each WALED is connected to a power trace 80 and ground trace 82.

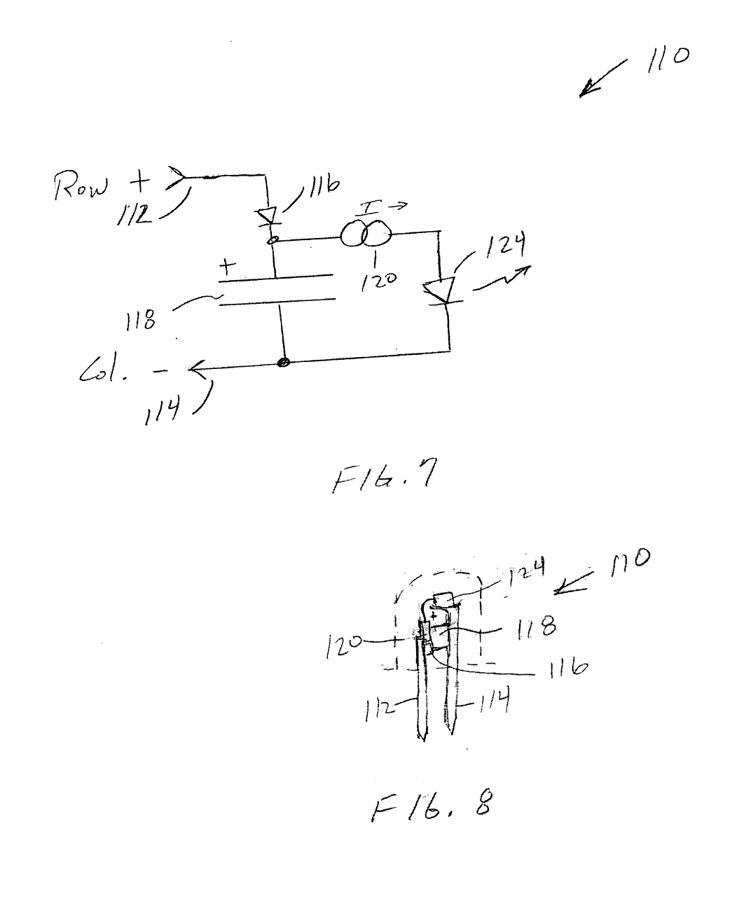

FIG. 6 depicts a simplified schematic for the WALED 74. An LED 84 is connected in series with a driver 86, depicted as a simple MOSFET switch. Power 80 and ground 82 connections are at either side of the LED 84 switch combination. A wireless sensor, in this instance an electrical field detector 88 is represented as a coil located at specific location near the periphery 90 of the embedded circuit, which is preferably close to the edge of the display element 92. It will be appreciated, however, that the signal may be picked up from the side, or underside (less preferably above due to loss of light) of the WALED package. An electric field may be produced in either of two polarities depending on the relative voltages applied between the row and column. Row positive and column negative for a first polarity, and row negative and column positive for a second polarity. The electrical field is then amplified in a differential amplifier 94 which if a sufficient electrical field is presented between the row and column will generate either sufficient positive or negative voltage to exceed either the positive or negative threshold of comparators 96. A positive going direction in this embodiment (may be configured in many ways) is used to trigger a set-reset flip-flop 98 into an active state wherein the output activates the driver 86 allowing LED 84 to switch on driven by the power across the power and ground lines.

Upon driving the row and column in the opposing polarity the reset line of the flip-flop is triggered and the LED is deactivated.

In the present embodiment the row and column drivers would preferably generate a positive first row signal and negative column signals for each column to be activated. Then column signals dropped and row signal dropped, wherein the next row goes positive and then each column to be selected goes negative. This proceeds through all rows. A time delay may occur between multiplexing passes depending on the depth of multiplexing utilized. Then a reverse field is driven on each line (row to ground with column signal high) to reset the flip flop. All rows may be driven into reset in a single sequence, or each row may be reset prior to setting the row in the positive direction. Alternatively, power may be interrupted on the power bus after each mux pass to reset the flip flop before the next pass.

It should be appreciated that electric field detector 88 may be implemented in any convenient manner as known to one of ordinary skill in the art. Additionally, other characteristics may be sensed as described previously. Furthermore, the use of row and column lines as per the description may be alternatively reversed.

1.2B Wired Row and Column for Activation.

This is another variation that requires the LED to be configured with additional pinouts for receiving row and column data. The circuit may otherwise operate similarly to the wireless description above and to the QRC LED elements previously described. The pinouts may be conventional pinouts with four pins exiting the underside of each LED and connected internally to the driver circuit for the unit. Alternatively, the extra pins may exit the sides of the LED housing for connection to a matrix or other set of signal pathways. It should be appreciated that although conventional through-hole LEDs are depicted, all embodiments of the invention may be implemented in display elements of various topologies, such as surface mount, flip-chip, bump packages, and so forth without departing from the present invention.

This embodiment can be implemented similarly to that of FIG. 5 and FIG. 6, however utilizing a direct voltage potential between row and column instead of a field strength sensor.

1.3 Extending Element Active Period.

This variation of display array control provides for extending the active interval of a multiplexed display element (EIMDE) beyond what can be achieved for its given depth of multiplexing. The present aspect of the invention can be implemented within largely conventional display arrays so that multiplexing may be utilized even for displays requiring high contrast such as outdoors and so forth.

Within this aspect of the invention each display element (or other form of output element) is configured with a front end charge storage element, such as a supercapacitor, coupled to a preferably constant current driver for supplying a fixed amount of current to the element. In use power is applied across the row and column for a particular element for a brief interval at high current levels in excess of the maximum current draw for the LED, or other display element being controlled. The high current rapidly charges the capacitor. The amount of time that the charging is applied determines the active duration of the element. Current is then supplied from the charge on the capacitor to drive the display for an extended period of time. For example, supplying charge across the row and column for a period of 100 uS to sufficiently charge the capacitor for driving the display for a period of 10 mS. This 100 fold increase in active period, for example would allow 100 rows of elements to be driven per each scan. It should also be appreciated, however, that to drive a 20 mA LED during the whole scan cycle would require that the capacitor be charged at slightly more than 100 fold increase in charge current, in the present example that would be 2 A. The bussing in some systems may not be able to support that level of multiplexing, wherein the charging can be reduced to rates in line with the depth of multiplexing.

A charge current limiting device, such as a resistor, or FET, may be utilized to limit the rate at which the capacitor charges. The system may be trimmed so that each display element has a generally fixed relationship between the charge time and the time for which a display element is driven. Alternatively, the polarity across the row to column may be reversed to discharge the capacitor if more accurate timing control is desired.

It is not necessary to linearize the transfer function from charge time period to LED active period as the circuit driving the display can determine the amount of time it should apply power across the row and column to yield a given active duration.

A number of tradeoffs and drawbacks must be considered with this approach. (1) Power can only be supplied to the LED while the capacitive voltage exceeds the forward voltage drop of the diode (typically from 2V-4V depending on the diode). (2) Charging the capacitor to sufficiently high voltages for providing longer term power can result in huge losses within the constant current circuit. For example if the capacitor is charged to 6V with 3V being required at the LED, then half of the power being extracted from the capacitor is lost in the driver at peak voltage, although this reduces as the voltage drops. (3) Utilizing a very high value of capacitor and/or a fast scan rate could reduce the problems with the V discharge curve. For example, with scan rates on the order of 10 mS a capacitor on the order of between 10 mF to 500 mF at 4V or 5V could provide sufficient capacitance to sustain the current drive for a sufficient period of time. At faster scan rates, such as 1 mS to complete a full scan, the amount of capacitance is accordingly reduced. (4) The charge voltage of the capacitor is only depleted down to the Vf of the diode on each scan pass wherein only the depleted charge need be restored. However, upon power-up it may be desirable to run a special cycle to charge the capacitors up to that threshold level, such as by supplying a lower voltage row and column signal to each element. The lower voltage will reduce the current draw into each element. (5) The discharge profile problems associated with a capacitor are largely solved by providing an energy storage device capable of generating power at a substantially fixed voltage output, such as a battery, fuel cell and the like. However, these energy storage elements need to be able to charge very rapidly and be extremely inexpensive for widespread adoption. (6) The discharge profile problem may also be solved by utilizing a switching style current source which actually down converts the voltage on the storage element, such as supercapacitor, to drive the LED. In this approach it would be challenging to implement a conversion circuit at a sufficiently low cost and high reliability to serve in this application. These factors must be considered with this approach as they have significant impact on cost and efficiency.

This embodiment allows the display elements to be multiplexed deeply while maintaining a high intensity and high contrast output. Furthermore, scanning speed may be reduced because the intensity may be programmed by setting the active time period within each scan for each LED. The system is easily integrated within existing display array technology.

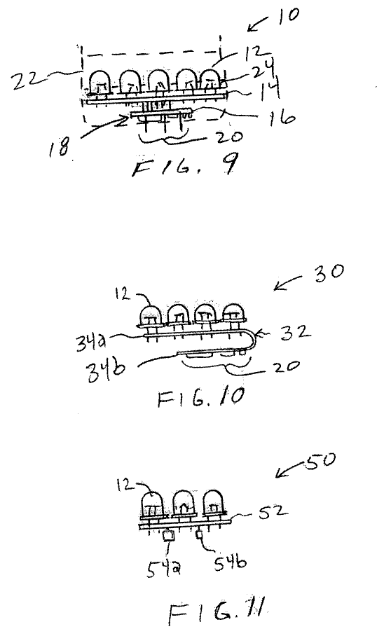

FIG. 7 depicts a simplified schematic 110 of the EIMDE (may also be referred to as a Super CAPacitor LED, or “SUPERCAP LED”. Power is applied almost traditionally between row 112 and column 114. However, the power is preferably applied at a higher voltage and current than that for driving a conventional LED. Through diode 116 (an optional resistor could be utilized but it is preferred to use appropriate resistance in row driver) 117 a supercapacitor 118 is very rapidly charged. The diode 116 provides isolation that prevents the charge from capacitor 118 from charging other uncharged (set to off), or less charged capacitors on the row. Preferably, the drive voltage is set at a level wherein the internal resistance of the row driver in combination with the resistance of the diode is sufficient to limit current flow. Additionally, it will be recognized that due to the high rush current requirements the bus lines should be very large so that capacitor charge rates are not significantly impacted by trace resistance. It will be appreciated that any convenient form of power isolation may be provided by one of ordinary skill in the art without departing from the present invention.

As capacitor 118 charges, a driver element 120, exemplified as a constant current source, allows current to flow for driving the LED. It will be appreciated that constant current drivers typically allow for maintaining the closest match of LED brightness. Typically, the constant current level of the constant current driver would be set near the maximum sustainable current for the particular LED element chosen. Alternatively, any convenient LED driver circuit may be utilized for allowing a controlled amount of power to be extracted from the capacitor per unit time for operating the LED.

Therefore, the duration of the light output is determined by the time over which the proper voltage appears between the row 112 and column 114 for charging the capacitor 124. As a result the intensity for each LED 124 can be set based on the amount of charge loaded on capacitor 118. The multiplexing rate and size of the capacitor may be chosen such that if the capacitor is charged for sufficient time during one multiplex scan, that sufficient power will be available for powering the LED at the constant current rate until just prior to the arrival of the next multiplex scan. In this way no excess power is left on the capacitor and yet 100% duty cycle of the LED, resulting in full LED intensity, can be achieved independently of the depth of multiplexing.

To manufacture the device the supercapacitor may be molded within the LED housing beneath the LED die. The LED and other elements may be physically connected to a portion of the supercapacitor, therefore utilizing it as a circuit board.

FIG. 8 depicts one possible method of manufacture, wherein supercapacitor 116 is formed with broad connections on each end. To the positive end are connected a circuit containing a diode 116 on one end associated with a lower contact and a driver 120, such as a constant current driver, on a second end associated with an upper contact. A lead 112 may then be connecting spanning both diode and driver which is later cut so that a separate input and output connection are made to the supercapacitor. Alternatively, separate connections may be established to lead section, or a wire bonded from the driver directly to the LED. The driver may be alternatively bonded with the LED itself and a wire connection made to the supercapacitor. It will be appreciated that the above alternatives are provided by way of example, wherein the described SUPERCAP LED may be fabricated in a number of alternative ways, while the circuit itself adapted in numerous ways without departing from the teachings herein.

2.0 USLED—Method of Manufacturing a USLED Modules.

This aspect of the invention relates to the manufacture of Universal Synchronous LED devices as described in a copending application incorporated herein by reference, entitled “A System And Method Of Driving An Array Of Optical Elements” Ser. No. 09/924,973 filed Aug. 7, 2001, and provisional patent application Ser. No. 60/223,659 filed Aug. 7, 2000, along with additional USLED technology included within provisional patent application Ser. No. 60/394,160 filed Jul. 1, 2002. The reference describes the use of the USLED technology on single display elements or on multiple display elements combined within a module. Each USLED element is configured to receive control signals over a power bus to which it is connected. The element, or module, itself contains the circuits for detecting signals on the power bus in response to which the element, such as an LED, has its state controlled.

2.1 USLED Module Manufacture Overview.

The present inventive aspects describe the creation of modules incorporating USLED technology. Modules may be constructed in a number of different ways without departing from the teachings of the present invention. These modules may incorporate any desired number of display elements of various colors. The elements may be connected to a single USLED control circuit or to multiple elements. The display elements themselves may be LEDs such as bi-pin mounted units, surface mounted devices or may rely on any other convenient mounting configuration (i.e. bump lead, flip chip, and so forth). The display elements may alternatively comprise other forms of discrete elements, such as mirror elements, optical switch elements and so forth.

Adding a USLED circuit within a module requires a connection to the LEDs and board real-estate for the circuit elements. If sufficient spacing exists between the through holes of bi-pin LEDs then the USLED circuit elements may be mounted along with the LEDs. This may be true of sparse LED arrays that can be utilized in signs for augmenting underlying graphics, and some other situations. In many cases however, insufficient spacing exists between the LEDs, in particular if the module is designed for use within a large dense array of LEDs. In those cases the module must accommodate the dense pin arrangement from the LEDs and the interconnected USLED circuit elements. Alternatively, LEDs may be surface mounted on a first surface with USLED control circuitry mounted on the opposing printed circuit board surface, interconnected with vias between the layers. It should also be considered that power dissipation from the USLED circuits can cause heat buildup if excessive thermal resistance exists from the circuits to the module exterior.

A number of alternatives exist for packaging the modules, a few of these alternatives being exemplified below. It will be appreciated that the spacing between elements within these packages is shown for representational clarity and is therefore not necessarily to scale.

2.2 USLED Module Example Embodiments.

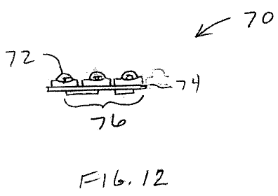

FIG. 9 depicts a module 10 wherein a series of discrete LEDs 12 arranged in a 5×7 matrix of LEDs are connected within a single USLED module. LEDs 12 being connected to a circuit board 14 which is in turn connected to a piggy-back circuit board 16 that contains the USLED circuits 18 for controlling the 35 LEDs within the module. Three output pins 20 are shown for connecting the USLED module. It will be appreciated that a single USLED circuit can extract data for controlling the intensity of the 35 LEDs directly from the power and ground plane as described within the USLED description, while additional common signals may be utilized to simplify the signal extraction process. An optional housing 22 is shown surrounding the module which is also shown potted in a non-conductive resin material 24 up to and including the base of the LEDs, such that corrosion is prevented from occurring on the delicate circuit traces within the circuit boards and interconnections, and to increase the structural integrity of the module. Housing 22 is shown providing a shroud which can be beneficial in outdoor lighting situations. It will be noted that the tops of the USLED circuit elements are maintained close to the rear of the module so that heat may be transferred to a surface to which the module is connected. A metal area may even be included within the rear of the package, or the housing itself being metallic, wherein the thermal conduction to the rear surface, to which the module is attached, is increased.

The housing and potting are not shown on the following modules, although it should be appreciated that a housing and/or potting would normally be utilized for protecting each such module.

FIG. 10 depicts a smaller module 30 with through hole LEDs 12 which are connected to a flex circuit 32 having a first end 34a that connects to the LEDs and a second end 34b that connects to the USLED control circuits.

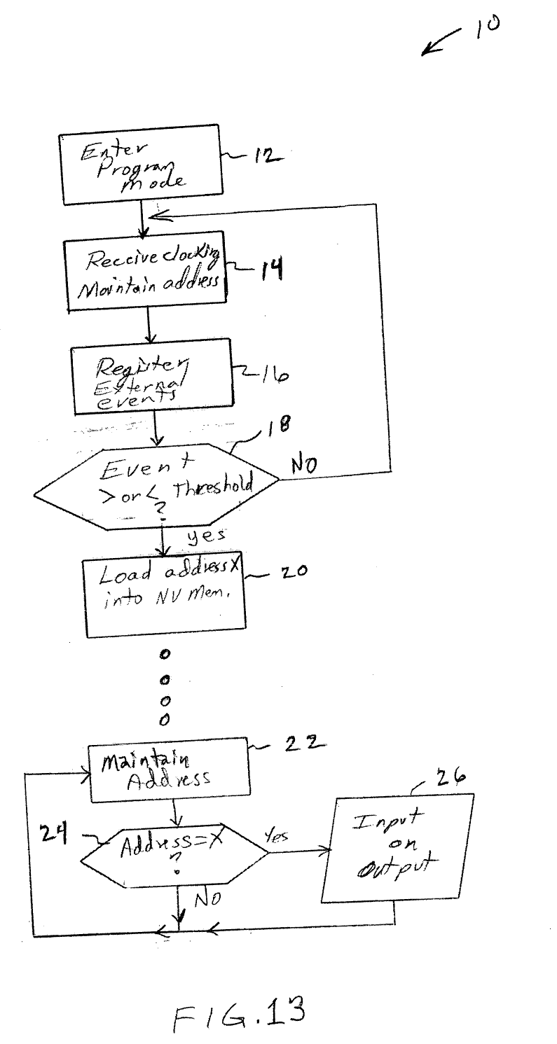

FIG. 11 depicts an LED module 50 wherein a small set of LEDs 12 are connected to a circuit board 52 from which two separate packages containing USLED circuits are mounted as SIP packages, or similar. The SIP arrangement requires a small foot print as the circuit devices are not retained flush with the board. However, wave soldering can prove difficult with the elements being mounted from alternate sides of the board. Alternatively, the SIP circuit elements may be mounted from the same side of the board as the LEDs, whose position may warrant being raised to accommodate the ULSED circuit packages.

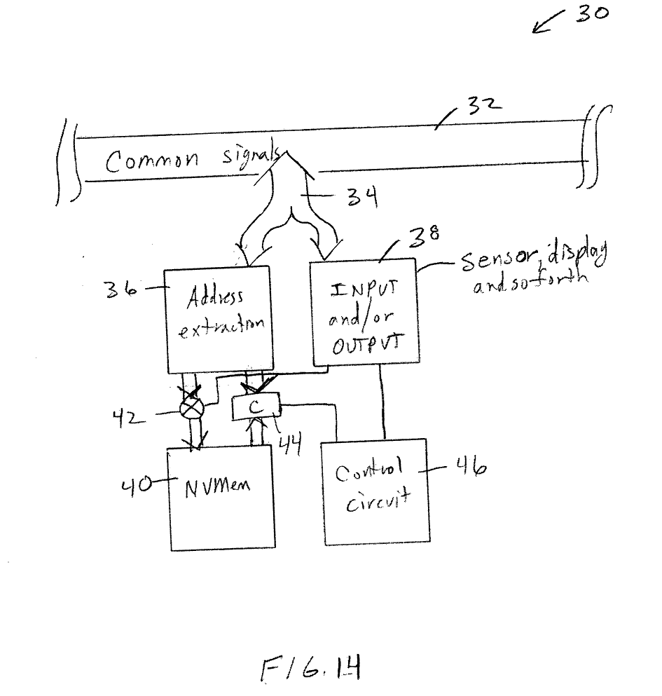

FIG. 12 depicts the mounting 70 of surface mountable LEDs 72 on a circuit board 74, or other carrier capable of being configured with circuit traces (this applies to the other embodiment as well). The USLED circuits are then mounted to the opposing side of the circuit. The use of a flex circuit as shown in FIG. 10 may also be practiced with surface mount LEDs, wherein it has the advantage of allowing all circuits to be assembled to the surface of a single circuit board, although otherwise the flex circuit is more costly and requires more space than the single circuit board module.

3.0 Method of Address Programming an Array of Elements.

This aspect of the invention relates to programming the activity of elements within display arrays, such as the Universal Synchronous LED devices described in a copending application incorporated herein by reference entitled “A System And Method Of Driving An Array Of Optical Elements” Ser. No. 09/924,973 filed Aug. 7, 2001, and provisional patent application Ser. No. 60/223,659 filed Aug. 7, 2000, along with additional USLED technology included within provisional patent application Ser. No. 60/394,160 filed Jul. 1, 2002.

3.1 Overview of Array Address Programming.

To provide a method of communicating relative position information to elements within an array for registering an address wherein they can respond based on location within said array, while not requiring a cross-point grid, or sequential element-to-element counter operation to take place.

The present invention is applicable to USLED displays and similar devices which incorporate what is being referred to herein as Array Position Addressing (APA) that allows the elements to be controllably addressed, such as from common bit streams, without the need of individual row and column lines, or sequential information being decremented or serially passed along a string of elements.

The included application refers to the elements within the array being addressed as display elements using Array Position Addressing (APA), wherein it should be appreciated that these may be any form of display element as well as other output elements, such as movable mirrors within a MEMs element, valves, and so forth. Furthermore, the circuit elements within the array may less preferably comprise input elements or elements with a combination of input and output functions. By way of example the devices may comprise sensors, such as image, audio, pressure, temperature, magnetic, and so forth, wherein their electronic address is set in relation to their physical position, such that their response back to a controller is associated with the address on the backplane, or common signal bus, wherein the data may be correlated with position without the need of mapping identifiers on individual elements to physical addresses.

One aspect of APA on USLEDs which was described in the prior copending application is that of providing in-situ optical programming wherein the USLEDs are programmed from an optical source array (generally a matching, or a superset, of the target USLED array) which programs a position address into each USLED on the target array. After programming, each display element retains, such as in FLASH memory, the address within the array that it is to be responsive to.

The present invention expands on the in-situ optical programming previously described. It will be appreciated that the optical programming technique provides an unambiguous trigger for setting the addressing within a non-volatile memory to an address as found on the power plane, or a separate signal(s). This trigger condition may be provided in a number of alternative ways as described herein.

(1) Laser scan—the light source may comprise a laser light source configured to scan across optically sensitive elements in a pattern that is synchronized with the addressing that is being generated over the bus. The laser source may be scanned by using a mechanical translation stage wherein it physically moves over the area to be programmed, or a light directing means, such as a moving mirror which deflects the light toward the subject display element.

It will be appreciated that a mechanical translation stage retained sufficiently proximal to the set of light sensitive elements may be utilized instead of a laser source for triggering the address loading within the elements.

(2) Light Masking—the light to a particular light sensitive APA element may be selectively provided by way of a mask that allows the light to reach only one element. Alternatively, masking may be performed with converse logic to mask light from reaching all but the masked off element. The mask may be moved on a translation table, or other means of masking off one, or all but the selected element(s).

(3) Field intensity scan—The magnetic or electrical field intensity is raised to select a given element. Preferably the element is first placed into a programming mode, such as by altering the voltage to the device (i.e. raising it to a programming voltage), having the element remain in a program mode until programmed to an address in a given range, and so forth. The field intensity may be registered within the element according to a number of known techniques, such as the use of an inductive loop. The unit has a field threshold that upon being crossed when in program mode causes it to load an address register with the address count which has so far been registered. It will be noted that field intensity varies with square of distance wherein selectivity is easily achieved.

The programming may be performed with any convenient device producing a sufficiently selective pattern of field intensity such that other elements are not inadvertently triggered. By way of example, a stylus or wand device providing proximity signaling for setting single elements of areas of pixels, and so forth.

One preferred method of programming is by creating a conductive row and column grid for positioning proximal to the unit wherein the voltages between active row and column set up a sufficient field intensity for exceeding the programming threshold. To increase the available field strength the grid may be configured with conductive extensions which can increase the proximity of the conductors to the element itself. These conductors may extend on either side of the element, over the top of the element, or otherwise be retained proximal so that sufficient field strength is achieved.

For a very simple programming device, for example considering a display that is assembled by a user in a desired configuration, a simple one magnet may be configured for being easily drawn over an array of elements in synchronous with the addressing being sent. For example, a counter could display the element number and the user then touches the magnet to, or near, the element and then moves on to select the following element and so forth.

“Noise” (proximity) programming—in a similar manner the noise being coupled to the element could be utilized for triggering programming. This is an AC version of the field strength triggering above, wherein the triggering is responsive to a given threshold of AC. Furthermore, the threshold can be conditioned to a particular pattern being received as a field strength. Anyone experimenting with electronics will have noted that that a finger touching near the input of an op-amp couples the 60 Hz lighting noise, along with any other spurious signals, into the input. This coupling may be utilized in noise programming. A noise signal which may contain a predetermined signal is passed nearby or in contact with the element, which senses the “noise” exceeding a given threshold and programs the attached element accordingly. Preferably, the program mode is only activated in response to a high programming voltage and/or signals received that pull the device into a program mode. No connection need be made to the device.

Capacitive programming—in a similar manner proximity of a material near the element may be utilized to sufficiently change the capacitance of a capacitor within the element to exceed the programming threshold. For example, a portion of the exterior of the housing forms a capacitor that couples a signal into the device for programming. A material may be brought into proximity, or contact with the element to be programmed which is synchronized with the APA addressing.

(4) Sensor address programming—Each element can be similarly made to respond to a condition for triggering programming. For example the sensitivity may be linked to the particular condition that the sensor is configured to sense. By way of example and not of limitation, the threshold may be established by pressure changes, such as applied to a pressure sensor that is in programming mode. By way of further example, the sensor may be a temperature sensor, or similar element, wherein a temperature change can be used to trigger programming. Less preferably, any form of sensing element may be utilized that can be individually addressed according to the characteristic being sensed.

It will be appreciated, therefore, that the in-situ programming of the address within the element may be made responsive to a number of conditions that trigger loading of the address from a signal source, bus, backplane, or similar without departing from the teachings of the present invention.

3.2 Description of Example Embodiments.

FIG. 13 is a flowchart of the method 10 according to the present invention, showing blocks 12 through 20 illustrating an address programming sequence and blocks 22 through 26 depicting an operating sequence.

Programming mode is entered at block 12, such as by receiving a predetermined signal, a predetermined operating voltage, or an alternative condition signifying that the element should be prepared to program an address. The element receives clocking from the common set of signals and maintains an address according to block 14. Upon registering a predetermined event (or one of many) as per block 18 a comparison is made to determine if this event meets the conditions for address loading. If so, then the address is loaded into the non-volatile memory at block 20 wherein during operation the element can discern to which address it is to respond based on the physical position to which it was programmed.

During operation the element maintains an address at block 22, such as a counter upcounting an address value. The address of the count is compared with the address loaded in the non-volatile memory at block 24 during programming. If a match is found then the element responds to the address by inputting or outputting data from the common set of signal as per block 26. It will be appreciated that outputting data from the set of common signals may comprise outputting an intensity or color to a display element, tilting a mirror a given amount, or other forms of output. Inputs may comprise sending collected data from a sensor over the common signals, or communication of other data over the common signals.

FIG. 14 depicts a block diagram 30 of a circuit element configured for responding to an address according with programming that is set based on the physical position of the element. A set of common signals 32 are interconnected 34 between an array of the circuit elements, this may an array of from one to any number of desired dimensions. An address extraction circuit 36 operates to determine the address on the common signals in response to clocking signals detected therein. For example, the clocking may be utilized for incrementing one or more count values corresponding to an address. An input and/or output section 38 operates to sense trigger conditions of one or more inputs for controlling programming and it may be utilized for communicating data over the common signals which has been gathered from the input. I/O section 38 may also include output portions, such as display elements, mechanical positioners, valves, optical transmissive controllers, and so forth, in response to addressing. A section of non-volatile memory 40 allows the circuit element to be programmed to an address corresponding to the position of the element within the array. An address being loaded from address extraction circuit 36 to the non-volatile memory in response to an input within I/O section 38 reaching a sufficient level to activate a switch 42 allowing the address being maintained to be loaded within the memory 40. During operation of the unit, the address being maintained by address extraction circuit 36 is compared with the programmed address within the non-volatile memory 40 within comparator 44. Upon a match occurring a control circuit 46 is activated wherein it controls the I/O circuit for collecting data from the set of signals for output to a display or other output element, or the communication of data from the input device, such as from a sensor, over the set of common signals 32.

It should be appreciated that the set of common signals may comprise power and ground, or it may comprise a multiplicity of signals routed commonly to an array of elements. It will be appreciated that a number of arrays of elements may be interconnected with different sets of signals interconnecting them without departing from the teachings of the present invention.

3.3 Addressing within Pick and Place Equipment.

Establishing APA style location addressing for elements in an array may be alternatively performed at the time each individual element, such as display element, is bonded into the array. It will be appreciated that conventional programming equipment programs each element with the same program code. While serialized devices are programmed with different serial numbers, but there is no need for matching the serial number with a location.

An aspect of the present invention includes a pick and place system, or similar means (referred to generically as a pick-and-place system or simply PnP system) of loading a printed circuit board, or other electronic parts substrate or carrier device, (referred to herein generically as a printed circuit board or simply PCB) with electronic elements to form an array (1D, 2D, 3D, regular, sparse, or irregular).

The PnP system is adapted with a programming head configured for receiving an unprogrammed electronic element, such as an LED display element, having a known relationship to the location on said PCB at which the element is to be electrically connected (inserted, attached, bonded, joined, and so forth and combinations thereof). The programming to be loaded to the element is then updated in response to the location in the array that the electronic element is to be connected. After programming, it is preferable (though in some cases cost prohibitive) to test the electronic element at the programmed address to assure it is correctly programmed. If correct, then the electronic element is allowed to pass through for being placed and connected to the PCB. If the unit does not function at the correct address, then it is rejected and another unit is loaded into the programming head and programmed to the same location address.

The programming head may connect to the device and apply programming in any desired manner. Electrical connection is established with the element under programming (EUP), while additional non-connection inputs may also be utilized, such as light detection and so forth, to provide additional information or trigger information to the element. For example a multileaded element may be programmed solely through its leads, by entering a programming mode and loading data into the part. A device with fewer leads, such as certain USLED devices, may have only power and ground pins, wherein a trigger signal can be received by flashing a light upon the LED element. The LED operates in a sense mode in this scenario, when the device is powered to the programming voltage (or otherwise set in programming mode), wherein an address counted by the EUP from signals piggybacked on the power bus, is loaded into non-volatile memory in response to the light trigger. Other elements can be similarly programmed in response to other forms of sense input, such as pressure, RF energy, acoustics, and so forth. It will be appreciated that a number of alternative programming mechanisms exist for various types of EUP devices, whether programmed solely through electrical connection or augmented with sense inputs, such as for triggering.

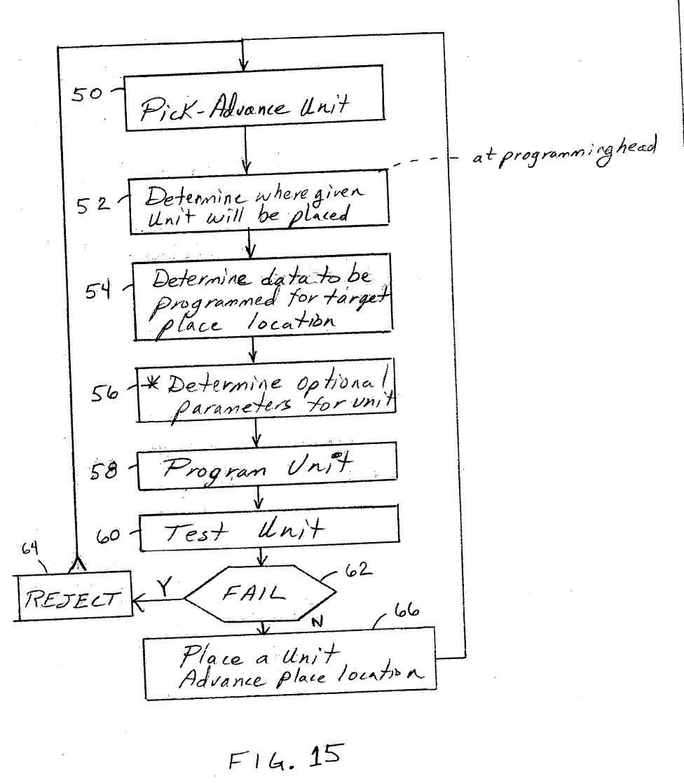

FIG. 15 is a flowchart of a method of setting location addressing within a pick-and-place system according to an aspect of the present invention. Block 50 represents a pick advance step wherein the electronic unit (which is to be placed for connection on a PCB) is advanced along the queue. Typically advancement occurs as the result of a pick (from reel, bulk, or other repository of elements) after the head of the unit queue has been placed into, or onto, the PCB (or similar).

It should be appreciated that the pick and place equipment may have a queue size of only one, wherein a unit is picked, programmed, and then placed into, or onto, the PCB without being moved through queue intermediate the pick and programming step or the programming and place step. In either case the pick or advance of the queue represented by block 50 brings a new unit into the programming head.

A determination is made as per block 52 as to where the given unit loaded in the programming head will be eventually placed on the PCB. This determination can be table driven or calculated in response to the location of the element in the queue toward placement, the location for the next placement and the placement route being followed. A simple equation for this is given by L_{pcb}=(Lₚ+L_{q})_{placemap}. The location L_{pcb} is the location (target) where the unit is to be placed on the PCB when it emerges from the queue (if a queue exists). The location Lₚ is the current placement location on the PCB or similar, and the location L_{q} is the position in the queue of the unit as registered as a number of units from reaching the placement head. The ( )_{placemap} is the modulo for the placement map, it will be appreciated that a unit in the queue may be placed on a subsequent PCB if its location is beyond the current PCB upon which units are being placed.

Data, preferably comprising a location address such as an APA address, is then determined as represented by block 54 in response to the position to which the specific unit being programmed is to be placed. Optionally at block 56 additional parameters for the unit may be determined, for example selected units within an array may be specially programmed with features suited to their position on the PCB (i.e. providing line terminations, altered output response, or other operational change dependent on position to be placed).

The unit at the programming head is then programmed with the data, along with optional data if necessary as per step 58. The programmed unit is then optionally tested as per block 60, preferably the test includes checking if the data has been properly programmed into the unit. By way of example in a USLED device addressing can be generated on the power lines and the output of the LED checked to assure that it generates correct light output response to the location address programmed into the device. The method of testing a device depends on the characteristics of each device and device testing is well known to those of ordinary skill in the art. Unit failures as detected at block 62 are rejected as per block 64, wherein the unit is dropped from the queue and another unit picked to replace it. On rejected units a placement has not occurred wherein the place location Lₚ does not increment. Typically these units are binned in one or more failure bins, while the software executing the programming and placement of the system tracks the failures and modes thereof.

If the programmed unit passes the test then it continues in the queue toward the place location as represented by block 66 and is advanced in the queue for each unit placed.

As modern placement equipment can operate at high rates of speed, it should be appreciated that a number of queues may be established leading to multiple programming heads, wherein the place head sequentially retrieves a unit from each queue. In this situation programming is performed based upon location information that takes into account the number and status of each of the queues.

4.0 Method of Address Programming Using Peer Location

Includes by reference the application entitled “A System And Method Of Driving An Array Of Optical Elements” Ser. No. 09/924,973 filed Aug. 7, 2001, and provisional patent application Ser. No. 60/223,659 filed Aug. 7, 2000, along with additional USLED technology included within provisional patent application Ser. No. 60/394,160 filed Jul. 1, 2002.

4.1 Overview

Programming of physical position of elements within an array of circuit elements based on proximity to one or more neighboring elements. An array of peer programmable circuit elements (PPCEs) are connected to a set of common signals, which may comprise a ground and power line over which both power and data are conveyed, or may include additional common lines.

Each PPCE element is adapted with memory locations, preferably non-volatile, within which an address for the circuit element within the array may be retained. The address in NVMem is loaded during a programming operation, which preferably occurs during a peer-to-peer programming operation.

During conventional operation, (non-programming mode) the PPCE is responsive to the address loaded in the NVMem and it will input data from the common set of signals into the circuit element for controlling some aspect of the element, such as a display output, mechanical adjustment, and so forth; and/or collect information, such as from one or more sensors, optical elements, transducers, and so forth.

The present invention provides for programming of the address based on a nearby PPCE which is already programmed. In this way programming (pre or in-situ) a single PPCE thereby provides a seed from which the remainder of the elements in the array can be automatically programmed based on position.

The method may be utilized in arrays of one, two, or three dimensions and any pattern of array may be supported, such as linear, row and column, hex, 3-D matrix, and so forth.

Each PPCE is configured for communicating a directed trigger to a nearby PPCE. The trigger is preferably qualified if any opportunity for false triggering exists, such as in relation to ambient conditions, such as light in a light triggered PPCE. Qualification may for example take the form of an ID or other pattern within the trigger that further distinguishes it from non-trigger events. The trigger may be communicated optically (UV, visible, IR, etc.), with other forms of electromagnetic radiation (RF, inductive), magnetically, mechanically, chemically, vibrationally, acoustically, thermally, or by other means of communicating a trigger condition from one PPCE to another PPCE.

By way of example and not limitation, the following discussion will be directed at PPCEs configured for use in a two dimensional array arranged as horizontal rows and vertical columns as it is the easiest to visualize; however, it should be appreciated that the technique is available for use with any array arrangement.

In this embodiment each PPCE is adjacent to four neighbors designated N-Top, N-Right, N-Bottom, and N-Left. In order to facilitate programming of the entire two dimensional array from a single seed, each PPCE is preferably adapted to communicate along both a row and a column.

By way of example, and not of limitation, the trigger signal is communicated down for a row change and right for a column change, whereas the trigger is received from the left along the next column within a row and from above within the first element in a new row.

In this embodiment, a PPCE preferably generates a column signal only if it is the first element in the row, and the 2-D array is seeded from the upper left corner. As addressing commences within a programming mode, the seed generates both a column and row trigger. The next row trigger may be generated at the start of the row wherein the next row is triggered into loading its address when that count reaches the next row address, or it may generate the next row trigger at the end of its row. The generation of column triggers operate similarly, wherein the trigger may be generated toward a subsequent PPCE in the row when the given PPCE has decoded its own address, therein relying the following PPCE to recognize that the next sequential column is the column it is to be programmed to; or the column trigger may be generated at the end of the selected address wherein the trigger can substantially coincide with the following interval wherein the following PPCE in the row need only load in the address at the subsequent timing transition for the column. It will be recognized that the next row address need not be separately communicated to following elements within a row because the trigger indicates that their position is within the current row of the address, wherein they will program their counted address into their NVMem upon receipt of the next set of clocking.

The trigger, as mentioned, may comprise any of a number of physical qualities, such as light, electric fields, magnetic fields, motion, vibration, chemical communication, and so forth. For example, consider an array of PPCE with each PPCE having a pair of electrodes near the periphery of the circuit facing downwardly to the next row, and a pair of electrodes near the periphery facing to the right. Similarly, a means for sensing the electric field (i.e. antenna coupled to sensitive amplifier) may be provided at the left and top direction near the periphery of the device. It can be appreciated that by applying a sufficient voltage across the electrodes an electric field may be setup that can be registered by an adjacent PPCE. Furthermore, the signals generated may be required to follow a predetermined sequence to eliminate false triggering. These triggers are preferably only generated when the device enters a programming mode, such as entered by doubling the normal operating voltage, or in other ways.

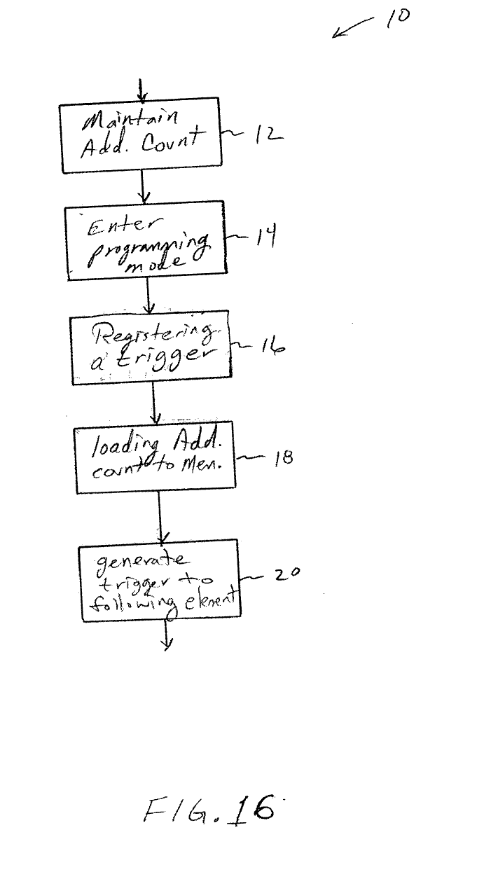

FIG. 16 depicts the method 10 of peer programming for position within an array. The address count is maintained in block 12 wherein the PPCE maintains the address count, such as in response to clocking detected within the common signals. The PPCE is entered into programming mode (it may have been set for programming mode prior to the maintenance of the address, such as if the operating voltage is changed) as per block 14. A trigger is registered as represented by block 16 from a nearby PPCE, preferably an adjacent PPCE in a particular direction. The trigger then causes the PPCE to load the maintained address into memory, as represented by block 18. The address may be loaded immediately or at a predetermined temporal offset from the trigger, such as upon a subsequent clock edge on one or more signals within the common set of signals. The PPCE which has just been programmed generates a trigger to a subsequent PPCE causing it to be programmed.

4.2 Other Aspects

Using a separate redirector—each PPCE need only communicate along a single path within a single dimensional array, OR if a redirector is utilized when programming the array wherein the redirector orients the addressing to the next location. By way of example, with optical PPCE having an LED output, the output from each PPCE may be coupled to the next column of PPCE down to the end of the row wherein the light is then coupled downwardly to the next lower row (or alternatively upper row) wherefrom the redirection is performed in the opposing direction and so forth so that addressing snakes its way over the surface of the array.

It will be appreciated that the technique can be modified by one of ordinary skill in the art without departing from the teachings herein.

5.0 EInk—Control Knobs Having Programmable Legends

Included herein by reference is application Ser. No. 10/066,495 filed Feb. 2, 2002 along with additional electronic ink embodiment described within the provisional application docket number RAST070102 filed Jul. 1, 2002, and the provisional application entitled “Display Systems and Methods Utilizing Electronic Ink” Ser. No. 60/267,115 filed on Feb. 7, 2001.

5.2 Overview

Apparatus and method for providing control knobs with reprogrammable legends, such as may be programmed according to the function or position of the knob. It will be recognized that conventional rotating control devices for receiving user input either provide a fixed legend on the rotating portion of the control pointed to by a mark or other indicator on the nearby stationary housing, or the converse wherein the legend is on the stationary housing and the indicator is on the rotating dial, knob, or other rotating input control.

The present invention utilizes electronic ink, or similar technology, that provides selecting the optical properties of a surface in response to the application of a magnetic field (or other electrically controlled property) which is retained in a non-volatile manner.

The following conventions are generally utilized in the following description.

(1) eInk—The term “eInk” is utilized for describing any material or structure whose optical properties are altered in response to electrically controlled characteristics and remain set in that new state even when those characteristics are no longer present.

(2) knob—the term “knob” will be generally utilized herein to refer to any rotating control input device, including flat wheel controls, raised knobs, edge-view knobs, and so forth.

The area of the knob legend is adapted with a region having a section of electronic ink and at least one electrode. The section of eInk is then programmed in response to knob rotation from a stationary set of electrodes that are retained proximal to the surface of the eInk section. Measurements of knob value whether digital or analog can be used to determine the rate at which the knob is moving to set the speed of writing to the eInk on the legend as well as for controlling the parameter, function, or whatever, that the knob is provided for.

Alternatively, the eInk may be provided on a stationary surface and the knob may contain the moving electrode which writes the surface as it is moved.

It either knob embodiment it will be appreciated that the knob may be multiturn knob wherein the current position is written on the legend as the knob is rotated. For example assume a control providing a change of 10 units per rotation as the knob is rotating through its first 360 degrees the legend string “1 2 3 4 5 6 7 8 9 10” is displayed, as the knob passes through its second rotation the legend string “11 12 13 14 15 16 17 18 19 20” are displayed and so forth. In this way there is no need to utilize other means for tracking the number of rotations or of having a separate display. This form of knob may be utilized for setting frequencies, volumes, intensities, and any other single axis parameter.

The knob itself may be a multiturn analog potentiometer whose resistance value changes may be determined so that the current position and rate of rotation may be determined. In this way the knob provides an indication of the position of the control and the position information is not lost when power is removed due to the static nature of the eInk. The knob may provide an output such as a digital binary output (i.e. rotary encoder), which allows the system to determine what setting the present position should represent and is capable of “setting” the control to any desired position, generally that at which it was set last. A single element potentiometer may also be utilized wherein the wiper has no end stops, so that multiple turns may be input.

It should be appreciated that the teachings may be utilized on any knob element, either single turn, multiturn, and so forth in which it is desired to display information on a legend in response to rotations of the knob.

5.2 Description of Example Embodiment(s)

FIG. 17 exemplifies an adaptable knob legend 10 as a planar circular knob 12, a portion of which 14 is adapted with electronic ink having a backing electrode and an optional front electrode allowing the area to be erased in total or in sections. A pivot 16 is shown for knob 12 which is contained in a housing 18 the edge of which is shown in phantom with a portion of the knob extending therefrom allowing the user to rotate the knob while viewing a portion of the legend. Preferably, pivot 16 is connected to an encoder, or potentiometer, for registering the motion and/or absolute position of knob 12.

A support member 20 is shown adapted with an array of electrodes 22 which is retained proximal to the surface of the electronic ink legend. Electrodes 22 are connected to a control circuits for modulating the voltage on the electrodes to allow programming the electronic ink into either a first state or a second state as wheel 12 is rotated. Preferably, the electrodes are set to a first voltage in reference to the backing electrode of the electronic ink for programming it to a first color state, and to an opposite second voltage in relation with the backing electrode to program it to a second color state. It will be appreciated that as the wheel is rotated, numbers, characters, and other information may be printed on the electronic ink legend in response to its movement and positioning.

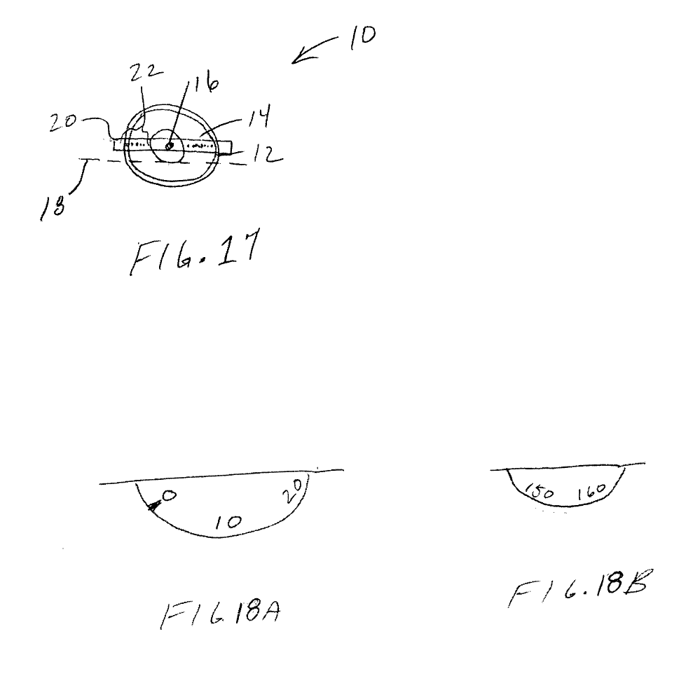

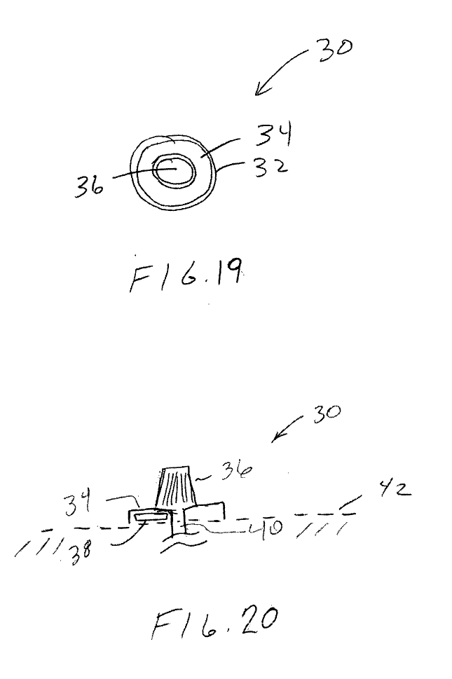

FIG. 18A and FIG. 18B depict adaptable knob legends, such as for a volume control, or frequency selection. In FIG. 18A a knob is shown with a zero position showing and the legend indicating “0”, “10”, and “20”. Rotation of knob 12 is sensed by the encoder or potentiometer connected through the pivot 16, as read by control electronics. The control electronics then modulate what is printed on the electronic ink of knob 12 as it is rotated.

The adaptable legend knobs may be configured in a number of shapes, formats, and styles without departing from the teachings of the present invention.

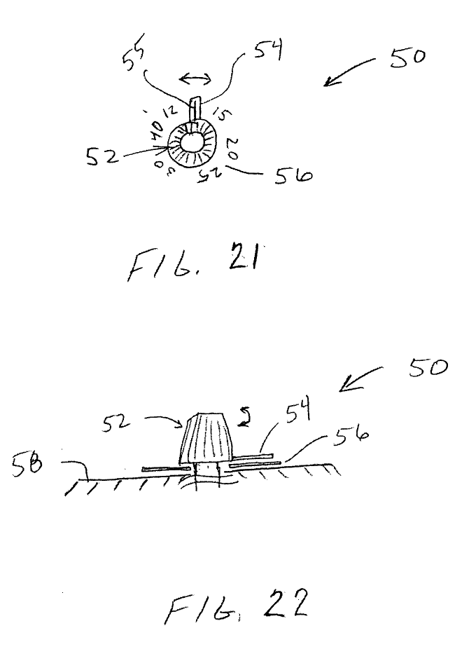

FIG. 19 and FIG. 20 exemplify a raised knob 30 having a circular base 32 attached to which is electronic ink 34 (over the surface or beneath a transparent section) in the center of which is a raised protrusion 36 for manually rotating knob 30. An group of electrodes 38 is shown beneath the circular base 32 for programming electronic ink region 34 to a first or second state. One or more additional groups of electrodes may be placed for programming the adaptable label. A shaft 40 extends from knob 30 which connects to a rotary encoding means (not shown). Connection from group of electrodes 38 to a control circuit may be provided through a housing 42 connecting thereto, or alternatively through shaft 40, or other means of establishing an electrical connection. Furthermore, said group of electrodes 38 may comprise a transponder circuit adapted for receiving data for setting the legend.

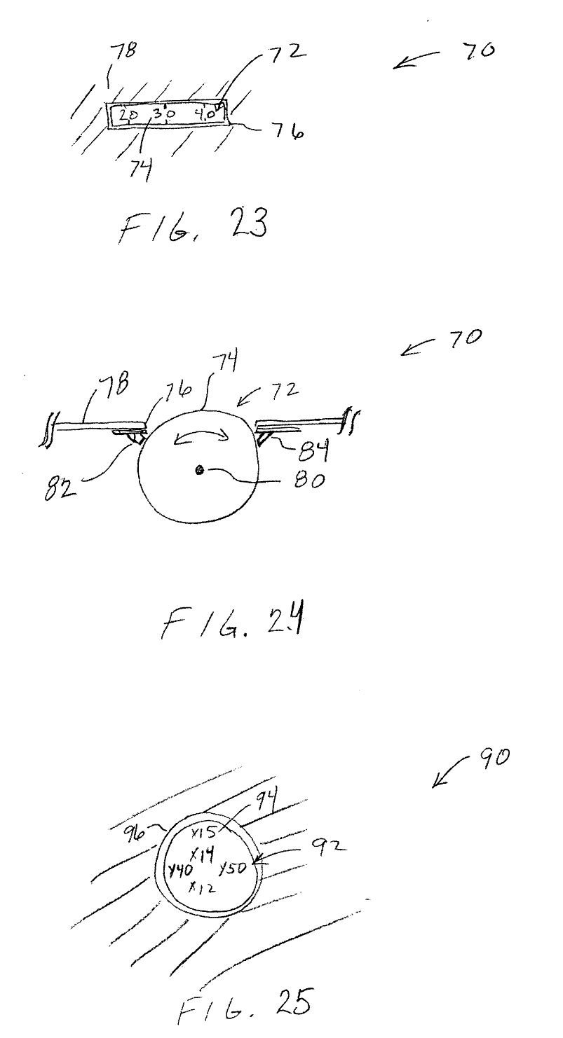

FIG. 21 and FIG. 22 exemplify another embodiment 50 of a knob 52 having a indication member 54, such as protruding from the body of knob 52, that allows a position in relation to an adaptable legend 56, preferably attached to a housing 58, to be selected by a user rotating knob 52. Indication member 54 is adapted with a plurality of electrodes 55 which are adapted for generating electric fields proximal to adaptable legend 56. The electronic ink legend 56 preferably is provided with at least one surface electrode and connected so that the voltages to which the electrodes within the plurality of electrodes is driven is sufficient to set selected portions of adaptable legend 56 to either a first or second display state as said indication member 54 is passed over the adaptable legend. For example, a controller activates the electrodes 55 on knob 52 upon commencing a subsequent rotation of the knob to set new display values for the electronic ink legend. In this way the knob may be allowed to control different types of values having different units, and may be used for multiturn control. Electrical connections are made between a controller (not shown) and the plurality of electrodes 55 within indication member 54.

In addition, the value being controlled may be modulated in response to the rotation of the knob. For example, a first rotation allows the knob to display volume, whereas in response to a second rotation (or other selection input such as pressure “clicked” selection or other input form) it may display bass, and upon a third rotation treble.

The adaptable legend may be configured with a row and column array (circle and radial) of electrodes, wherein the entire legend may be reprogrammed at once to display the new function and units as the knob is rotated past a given location. More preferably, the new function and units may be displayed as the knob is pressed or pulled (sensed by a switch or other means) to move from one value to another. Alternatively, upon activation of other controls (i.e. pushbuttons etc.) the adaptable legend may be reprogrammed to indicate a new function being selected.

FIG. 23 and FIG. 24 exemplify another embodiment 70 of an edge-view knob 72 having an electronic ink 74 front surface with at least one included substantially planar electrode. A portion of knob 72 preferably protrudes through an opening 76 in housing 78. Knob 72 rotates on pivot 80 and its rotation and/or position may be registered by control electronics receiving a signal from a rotational encoder, potentiometer, or similar value changing device (capacitor, inductor, etc. whose value changes in response to rotation). Electrode bar members 80 and 82 are depicted on either side of opening 76 for programming the portions of electronic ink 74 on knob 72 to a first or second color state while writing a legend on the surface of the knob.

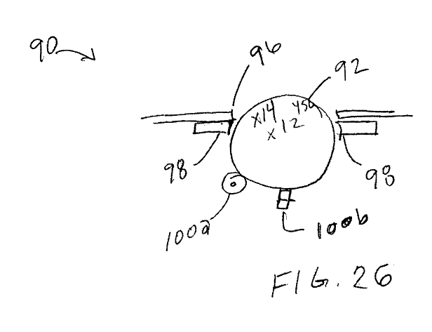

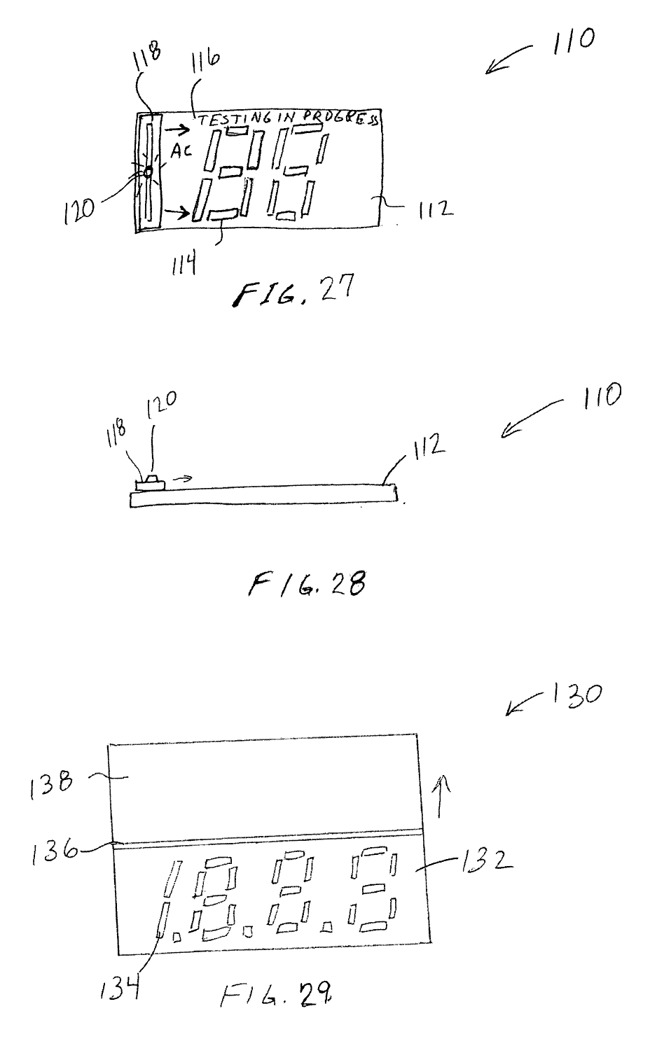

FIG. 25 and FIG. 26 exemplify an adaptable legend 90 in two dimensions. A trackball-style control 92, shown as a ball, with an adaptable legend 94 is retained within an aperture within a housing 96. Mechanisms are depicted for detecting the X and Y motion of the ball 100a, 100b. This is similar to the earlier embodiment, however, the control can move in two dimensions. A bar electrode 98 preferably encircles the opening so as to be held proximal to the electronic ink surface of the trackball-style control 92.

It will also be appreciated that the surface of ball 92 may be adapted with electronic ink having pixel controlling electrodes for modulating the pixels within the electronic ink material for displaying an adaptable legend.

Additionally, other information may be displayed along with the legend, such as warnings and so forth. If utilized with a digital control whose output provides only information on rotation of the knob, as opposed to a potentiometer which outputs a resistance value, the setting value displayed on the legend may be initialized to any desired value, and the displayed value may be made to jump forward or backward in response to additional inputs. It will be appreciated that a multiturn potentiometer, however, has a fixed output value at a given position, wherein the setting and associated legend may not be arbitrarily initialized to any desired value.

Displaying legends or other semi-fixed text, graphics, or indicia, to a dynamic display. Dynamic displays, such as eInk, LCD, OLED, and others are capable of displaying changing data, such as numerical, textual, or graphical information. Due to cost considerations many of these displays are configured with fixed fields instead of being just a fully programmable matrix of pixels. For example, a display for a voltmeter may contain 3½ digits of information displayed as seven segment digits, with a few fixed legend fields, such as “AC”, “V”, “A”, “mA” and so forth. It will be appreciated that controlling such a display requires a little over a dozen control lines from a processor.

To utilize a graphic display would require a more expensive display with perhaps 240×80 pixels of information but also the drivers and additional software overhead for controlling each of the 1820 pixels.

Therefore, although the use of limited fixed field displays is very cost effective it does not readily allow for the display of limited use messages, such as warnings, information, or additional data that does not otherwise fit within the fixed fields of the display. For example, in a voltmeter display it may be desired to indicate a problem with the unit, or the input, or provide additional information at the request of the user.

The present aspect of the invention provides a simple mechanism for providing the additional information on demand. The display, or portions thereof, or extending from the display are overlaid with a section of eInk providing at least one of the electrodes (although two opposing electrodes may be provided to facilitate system controlled erasing). An electrode “screed” is adapted for being moved over at least this portion of the display for programming the eInk section. As the electrode screed comprises a single row of electrodes which are activated to print the surface as they move, a large message can be written on the eInk with very few control signals. In this way the display itself as well as any extensions of the display may be utilized for indicating notes, providing messages, and so forth, without unduly increasing the cost of the display.

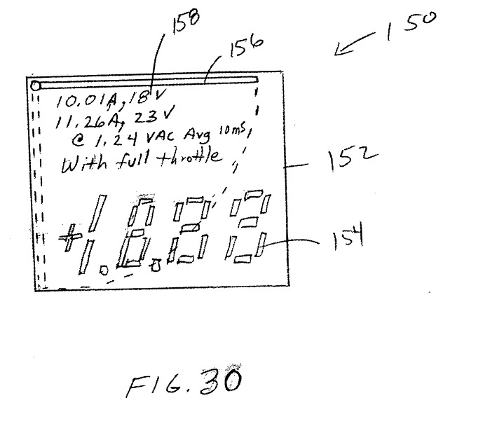

FIG. 27 and FIG. 28 exemplify another embodiment 110 wherein a display 112, such as LCD, LED, electronic ink, other display form is shown having fixed display fields 114. Electronic ink portions 116 are overlaid or integrated within display 112 and adapted for being programmed to a first or second display state as electrodes within electrode bar 118 are slid over the surface of the display. An optional display element 120, such as an LED, are utilized for indicating that a message is ready to be displayed, and that the user should move the screed over the display to display the message. The pixels of electronic ink are programmed in response to voltages being modulated on the electrodes within electrode bar 118 with respect to the voltage applied to an electrode on the opposing side of the electronic ink. In this way pixels may be set to a first or second state (optionally electronic ink may be set to multiple states as described in the application included herein) without the need of a huge number of control lines for setting the state of each pixel. This allows for a low cost display to be produced which is capable of displaying any desired text or graphics, pixel based, message.

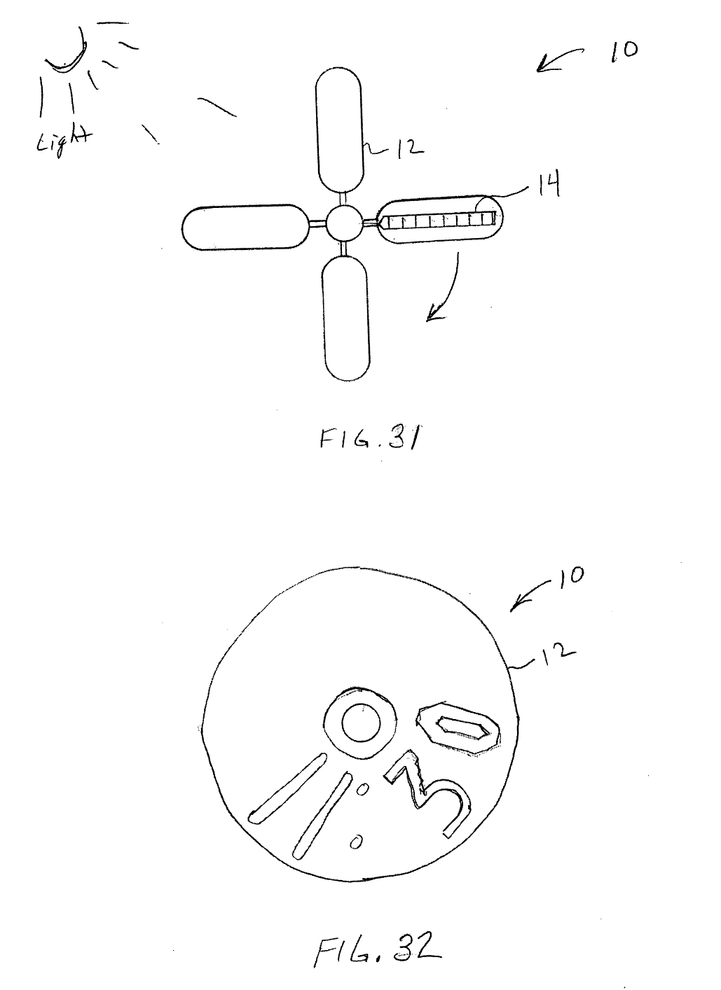

FIG. 29 exemplifies another embodiment 130 in which a display 132 having a generally fixed display fields 134 is adapted with an electronic ink region 138 and a horizontal slider 136 with a series of embedded electrodes. As slider 136 is moved over the electronic ink 138, the voltage is modulated on the embedded electrodes to program the pixels of the electronic ink (in conjunction with an opposing electrode beneath the electronic ink held at a selected voltage).

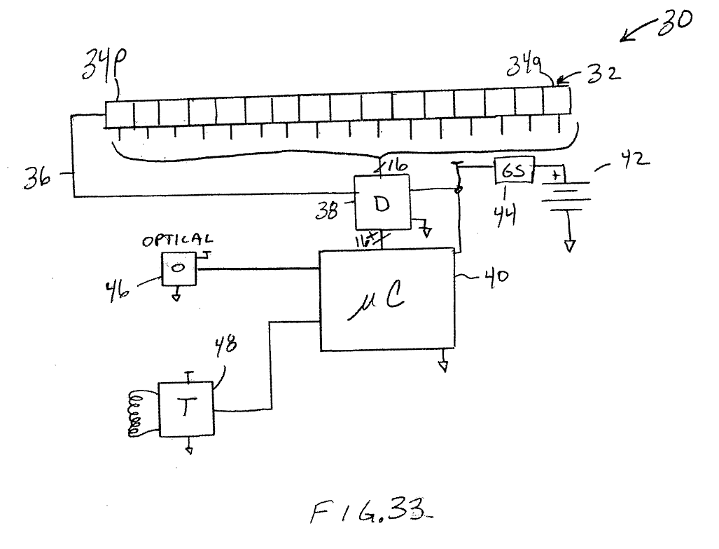

FIG. 30 exemplifies another embodiment 150 in which a low cost display 152 having conventional segment outputs 154 is augmented with a rotating electrode bar 156 for controlling an area of electronic ink 158 retained on or proximal to the display. Information may be displayed by wiping the electrode bar 156 as its electrodes are modulated to write pixel quantities of information onto the electronic ink area 158 under which an opposing electrode is retained.

It will be appreciated that the moving electrode bar in these and other embodiments may be driven by any desired mechanisms, such as manually, geared motors, muscle wire, solenoids, and so forth.

It will be appreciated that a number of display types may be implemented by one or ordinary skill in the art without departing from the teachings found herein.

5.3 Additional Embodiments

The following embodiments may be implemented following the teaching of embodiment already described, wherein the “manual intervention” for writing the display is replaced by a motion generated by the motion of the system.

A vehicle window—portion of window containing eInk (full or sparse distribution) which is programmed as the material is retracted into the window frame wherein an electrode array programs the state of the display.

Sliding window—an electrode array on a stationary portion of the window programs the eInk on a portion of the window as it passes nearby.

6.0 EInk—Rotation Displays

Included herein by reference is application Ser. No. 10/066,495 filed Feb. 2, 2002 along with additional electronic ink embodiment described within the provisional application docket number RAST070102 filed Jul. 1, 2002, and the provisional application entitled “Display Systems and Methods Utilizing Electronic Ink” Ser. No. 60/267,115 filed on Feb. 7, 2001.

6.1 Overview

An inexpensive method of displaying text or graphics at what appears to be a stationary position from a member subject to repetitive motion. The method and apparatus are particularly well suited for use with electronic ink displays.

It will be recognized that conventional moving element displays provide a row of elements that changes their display output as they move through space wherein the optical persistence of our vision ties the pixels outputs so that we can see text or graphics displayed. One example is a clock created by a pendulating row of LEDs that are modulated in response to the controlled motion of the pendulum. Another example is a row of vertical LEDs arranged on the side of a Frisbee™. These displays are presently constrained to certain application within which the speed of motion is controlled or there is little need for accurate synchronization wherein the display is modulated without regard to the actual pattern repetition speed.

In a number of repetitive systems, controlling the speed of the repetition is not possible, or practical, while it may be necessary to maintain synchronization of the display output. The present application overcomes these drawbacks and describes a number of devices that incorporate a moving display array.

Embodiments are described for displaying on a device subject to repetitive motion, wherein the display position within the repeating pattern is synchronized using a sensor. A common repetitive pattern is that of a rotating element, although a number of other common repetitive patterns exist, such as the leg of a pedestrian which is subject to the repetition of their stride, and so forth.

The relative position within the repeating pattern may be determined by a number of mechanisms including:
absolute position sensing—using a acceleration sensor, a compass, a sensor configured for sensing a nearby object not subject to the repeating motion.
relative position sensing—sensing changes in external conditions which are expected to substantially follow a pattern as the cycle is repeated. By way of example, a light sensor coupled to a processor wherein light intensity patterns are correlated to the location within the repeating pattern (i.e. in a rotating object light intensity may be higher on one side than the other).

The relative position within the pattern is sensed so that a trigger position may be determined along with the relative time (or position within the pattern) between each subsequent pixel. At a first location the display elements are set to display a first row of pixels. Then, based on the relative changing of position, subsequent pixels are then displayed by changing the output of the display elements to output the second row of pixels and so forth.

6.2 Description of Example Embodiments

FIG. 31 exemplifies a ceiling fan 10 having rotating blades 12. A display device 14 is shown attached to the rotatable blade 12 for displaying desired information such as temperature, date, time, or other forms of information. The display device comprises a position detection sensor (direct or indirect), an electronic ink display, and a controller for registering sensor data and determining relative position to which said row of electronic ink elements is modulated. Optionally the display device may contain a transponder unit, or other form of communications link, wherein data may be received by the display unit for display. Additionally/alternatively the communication link may be utilized for controlling aspects of the display, such as relative position in the pattern, character types, modes of display (i.e. how information conveyed) and so forth.

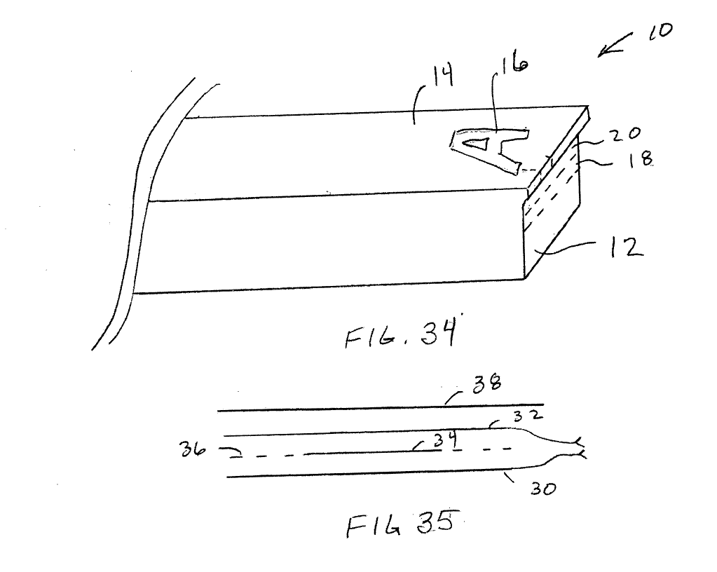

FIG. 32 depicts the display operating on a fan as it rotates wherein the time is displayed in large easily readable characters on the display as it rotates.

FIG. 33 exemplifies a circuit for the patterned movement display device 30, which is shown utilized on a ceiling fan. A low power linear display array 32, such as a row of electrodes between which electronic ink is disposed. A set of pixels 34a-34p with a connection to a first drive voltage is shown, while a common electrode 36 connected to the opposing electrode of the electronic ink. It will be appreciated that the electronic ink sphere are programmed to a given first or second color in response to the voltage polarity applied across the section of electronic ink. A driver circuit 38 is utilized for controlling the polarities, providing bias voltages as necessary, and buffering the out puts of microcontroller 40 which preferably has outputs corresponding to each of the pixels in the display. Microcontroller 40 is preferably implemented as an inexpensive microcontroller, however, it may be alternatively implemented as a dedicated circuit, programmable logic, or other control means as would be apparent to one of ordinary skill in the art.

A power source 42, shown as a battery, is configured for powering the microcontroller and display. A gravity-sensor switch 44 is shown for activating power to the display circuit only when the system is subject to sufficient movement. By way of example a conductive ball may be biased away from a closure contact by a spring, while under oscillatory movement, such as rotation, the weight of the conductive ball in response to the centripetal force closes the contact thereby supplying power to the unit. It will be appreciated that a number of alternative devices may be utilized for sensing motion and controlling supplied power in response thereto.

The present embodiment utilized light differences to detect its relative position as it travels about a circle. An optical sensor 46 allows the microcontroller to periodically register light intensity levels from which a repetitive pattern is found from which digit output synchronization is provided. For example the time for each pixel is determined based on the period of oscillation, while the starting point for each display pass is determined according to some location within the pattern or an offset thereof.

For communicating control information and/or display data a communication link 48 is shown. This link is preferably a one-way link for a simple display, but may be configured as a two way communication link if the display unit is configured for collecting desired information, such as temperature, for communication to a remote location.

The above design may be utilized in a number of applications, such as upon wheels (i.e. bicycle, motor vehicle, wheel chair, etc.). In a wheel type application, however, it may be desirable to have the unit alternatively, or additionally, sensitive to pressure (if it contacts the ground), force of gravity, inductance, or other detectable variable that changes with respect to rotational position, wherein a position fix may be determined for synchronization purposes.

The above design may be adapted for the legs of clothing, wherein the display output is synchronized to the pattern of walking so that the message can be properly displayed, similar to a portion of the arc subtended by the fan.

7.0 EInk—Optional Legends

Included herein by reference is application Ser. No. 10/066,495 filed Feb. 2, 2002 along with additional electronic ink embodiment described within the provisional application docket number RAST070102 filed Jul. 1, 2002, and the provisional application entitled “Display Systems and Methods Utilizing Electronic Ink” Ser. No. 60/267,115 filed on Feb. 7, 2001.

7.1 Overview

This aspect of the invention provides a low cost display of method if displaying user selected legends in selected applications. The system and method allows for controlling fixed eInk legends capable of being activated and deactivated. These legends may be utilized on keys or other inputs. One such application is for the keys of a musical instrument.

It will be appreciated that the beginner or novice may benefit from having a legend displayed on each key, however, during a concert or when played by a non-beginner, it would generally be more desirable to not display a legend on each key surface. Current technologies for controlling a display are expensive and difficult to implement on musical instruments, piano keys, saxophones finger positions, guitar finger positions and fret positions, and other keys wherein a learning curve or situation may make the display of legends desirable.

The following example is in regard to a piano keyboard, although it will be appreciated that this is applicable to any form of key input device, in particular other instruments.

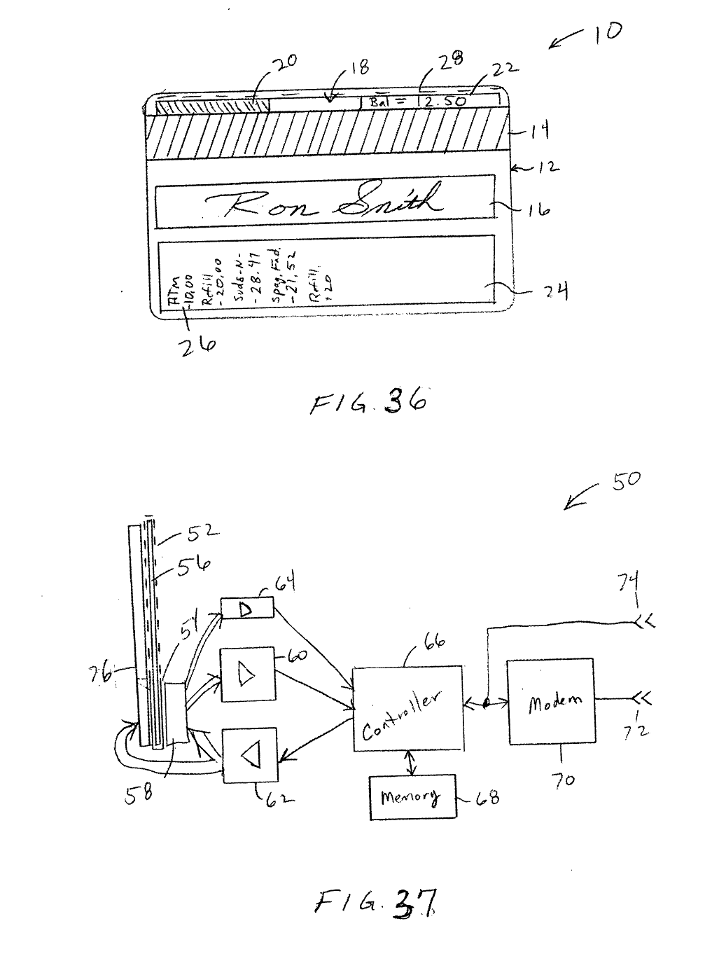

FIG. 34 depicts a selectable legend piano key 10. The present invention allows each of the piano keys to be set to display a legend or not to display a legend. For example a little battery powered module may be utilized for changing the state of the legend from off to on, or from on to off. It will be appreciated that the electronic ink is static wherein it remains in a given display state once programmed.

The body of key 10 has a face 12 and a top surface 14. A legend 16 is shown displayed in the electronic ink. Contacts 18, 20 are provided, such as on the front of the key for controlling the display state (color) of the electronic ink legend. A module having two electrodes outputs at desired voltage may be touched to the front of a key in a first orientation to set the legend to ON and a second orientation to set the legend OFF. The unit can preferably be slid across the front of the keys in a first or second orientation to set all the key legends to either ON or OFF.

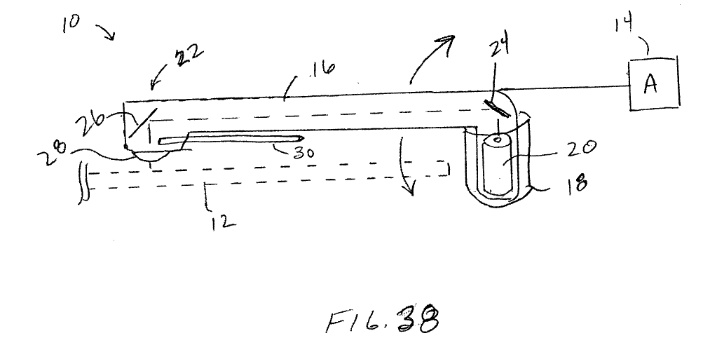

FIG. 35 depicts an exploded view of the optionally displayed legend. Under and upper electrodes 31, 32 are set to cover a full area between which the legend material lay be located. A portion of electronic ink 34 in a desired legend pattern is retained between the electrodes with an optional colored filler 36 in other areas near the electronic ink to maintain a smooth layer. While a covering 38 is preferably provided to protect the electrodes and electronic ink.

By applying a sufficient voltage across electrodes 30, 32 the eInk is set to a first or second state (ON or OFF) depending on the polarity.

Selectable legends may be manufactured in a number of different ways. By way of example the electrode layers with sandwiched electronic ink may be formed as a decal, or adhesive appliqué, wherein it is attached to the key surface (or other input) and then covered with a protective material.

To make an adhesive appliqué, a first conductive material with an adhesive backing is then overprinted with the outline of the desired legend printed with electronic ink. The areas surrounding the electronic ink may be printed in a non-active background color. A substantially transparent electrode (such as screen printed) is then fabricated on the surface over the electronic ink.

The present invention may be described as an apparatus for optionally displaying legends over an instrument key in response to an external stimulus, comprising:
a first electrode;
a electronic ink legend containing text and/or graphics overlayed on said first electrode, wherein said electronic ink capable of changing display state in response to the application of a sufficient voltage differential; and
a second electrode overlaying said electronic ink legend;
wherein said second electrode is sufficiently transparent to allow said legend to be seen through said second electrode;
wherein application of a first polarity of a sufficient voltage across the two electrodes sets the electronic ink into a first color, while an opposing polarity sets the electronic ink into a second color state.
   8.0 EInk—Displays on User purchased Cards

Included herein by reference is application Ser. No. 10/066,495 filed Feb. 2, 2002 along with additional electronic ink embodiment described within the provisional application docket number RAST070102 filed Jul. 1, 2002, and the provisional application entitled “Display Systems and Methods Utilizing Electronic Ink” Ser. No. 60/267,115 filed on Feb. 7, 2001.

8.1 Overview

To provide for displaying changeable information on user purchased cards, tickets and so forth. Transactions are often performed utilizing various forms of transaction cards, such as charge, debit, house branded, fixed value cards, club cards, bus fare cards, and a growing list of applications. Presently the only method of retaining data on these cards would be to print a permanent marking on them for informing the user of information, this would both complicate the point of sale equipment and increase the chance of failure due to the messiness of ink and the associated hardware.

The present invention provides a system wherein data such as balance, or transaction related information, may be temporarily printed on the transaction card for the convenience of the user. The information may comprise a simple balance such as for a fixed value card, or transaction value reminders that provide the user within information about the transactions that have been executed recently.

The present invention may be utilized with flexible cards that are utilized for controlling transactions, such as at point of sale devices. The cards may be hard plastic, such as typical credit cards, or the thin disposable types of cards, such as found in relation to train fares, library fees, and the like.

A portion of the card if configured with a section of electronic ink and an underlying electrode. The electronic ink section of the card is then updated with new printed information upon being passed through a reader machine.

The cards may retain account or value information upon a magnetic stripe, a circuit (i.e. a smart card), or other means for retaining information. It will be appreciated, however, that magnetic strip cards are the most common form of transaction card in use. By way of example, and not of limitation, the discussion that follows will refer to the use of a magnetic stripe, however, it is to be appreciated that the other means of retaining information may be alternatively utilized. The electronic ink section may be implemented over or near a magnetic stripe on the card, which contains digital information that may be read by the machine.

8.2 Cash Card Example

A fixed value card, (that may be reloadable) contains a magnetic stripe for card information and at least of portion of electronic ink. As the card is swiped information may be printed on the electronic ink section. This may be a predetermined information, such as a “fuel gauge” indicating the amount remaining on the card. The user can then readily see how much remains to be spent on the card. Presently, the user must attempt to remember how much remains on the card.

The information may also comprise receipt type information detailing information about the purchase. The information printed on the card is preferably subject to user selection, so that the use can determine what information gets printed to the card. The user also preferably can reset, or clear all or portions of the displayed information, such as when the information is no longer available. If receipt information is recorded on the card then the user need not log the transaction or retain a separate receipt as the card itself can detail the transaction. The user then can more easily track expenses, and will also know what remains on the card, or how much spent in a given period.

The tracking feature is also well suited for use by children, thus allowing the parents to see what has been spent on the card and for what purpose.

One aspect of the invention provides that the type of information printed on the card is determined by the type of card that was issued. For example a cash value card may be issued wherein each purchase, by default, is printed on the card and cannot be erased. This type of locked in featuring allows the cards to be utilized in different ways, such as the above described monitoring of transactions.

The cards may be utilized for bus fares, train fares, taxi fares, movie rentals, paying of university fees, telephone calls, laundry services and a vast number of applications.

The eInk within the cards is written to by a section of electrodes whose voltage is modulated, in similar manner to a dot matrix print head, as the card is fed through the machine. Cards utilized with point of sale terminals, in which only the upper part of the card is slid, will preferably contain the eInk above the magnetic stripe so that it is accessible as the card is slid through any point of sale system. Access to an underlying electrode of the electronic ink is provided by way of a conductive stripe, or similar, wherein the opposing electrode behind the electronic ink is held at a first potential while the second electrode is modulated to a second voltage potential to write those pixels for viewing or a third voltage (opposing second voltage in relation to the first potential). The application is similar to that described for use with labels within the application included by reference herein.

FIG. 36 depicts a charge card 10 according to the present invention. This card as shown may exemplify either a refillable fixed value card or a conventional charge/debit/or other convenience card. The card is conventionally shaped 12 of any desired material, (plastic, paper, etc.) and preferably providing a magnetic stripe 14. Long term charge cards generally provide a signature line 16 and optionally a picture, or biometric data (either on the card or data encoded on the magnetic stripe).

An optional electronic ink field is shown at the top of the charge card above the magnetic stripe upon which information may be printed as the card is swiped through a point of sale machine. It will be appreciated that any desired information in relation to the transaction may be printed on the electronic ink. The value printed in this area is preferably erased and a new printing performed with each swipe.

If the card 10 shown is a refillable fixed value card, then the electronic ink 18 may be utilized for displaying a “fuel gauge” 20 according to how much value remains on the card or how much has been spent so far. Additionally, a textual balance is shown 22. Another section of electronic ink 24, is shown on the opposing side of card 10, wherein additional information may be printed, preferably within a second pass of the card through the machine, such as for printing transaction information 26. The activation of the electrodes for writing the electronic ink is controlled in response to an optical detector, and/or optical recognition device, that determines the next open location to which an entry may be printed.

A conductive extension 28 is shown connecting to an electrode within the electronic. The conductive extension 28 provides a means for making electrical contact with an opposing voltage electrode beneath the electronic ink which is being written to in response to changing the voltage state of the electrodes within the electrode array retained proximal to the surface of the transaction card. The conductive extension is preferably formed as conductive paint or material upon which the electronic ink is deposited. It will be appreciated that to impose a voltage across the electronic ink requires an electrode at a first polarity on a first side of the electronic ink and an electrode at a second polarity on a second side of the electronic ink. In the present invention, the buried electrode provides a common electrode beneath the electronic ink that operates in concert with the modulation of the voltage on electrodes within the array of electrodes to write on the electronic ink. For example, the common electrode may be held at a first potential, wherein each of the electrodes within the array are set to provide either a positive or negative voltage in relation to the common electrode so that writing or erasing of the colors occurs within the electronic ink area. It will be appreciated that a number of mechanisms may be utilized for connecting to a common electrode, such as making the card conductive.

When utilizing a point of sale terminal configured for using the present invention, the user may insert the card in the reverse direction after they paid for the purchase by inserting it in the forward direction. In this way the controls for the POS terminal need not be changed only the circuits and software.

It is preferable, however, that the POS device provide additional controls for the card, such as resetting the transaction information, and controlling what is to be logged on the transaction data.

The data stripe associated with the present invention may contain information that informs the system what is to be printed on the electronic ink, alternatively check boxes on the card, or other optically readable text or graphic elements may be incorporated to indicate to the POS system what and how data is to be written to the section(s) of electronic ink as found on the card.

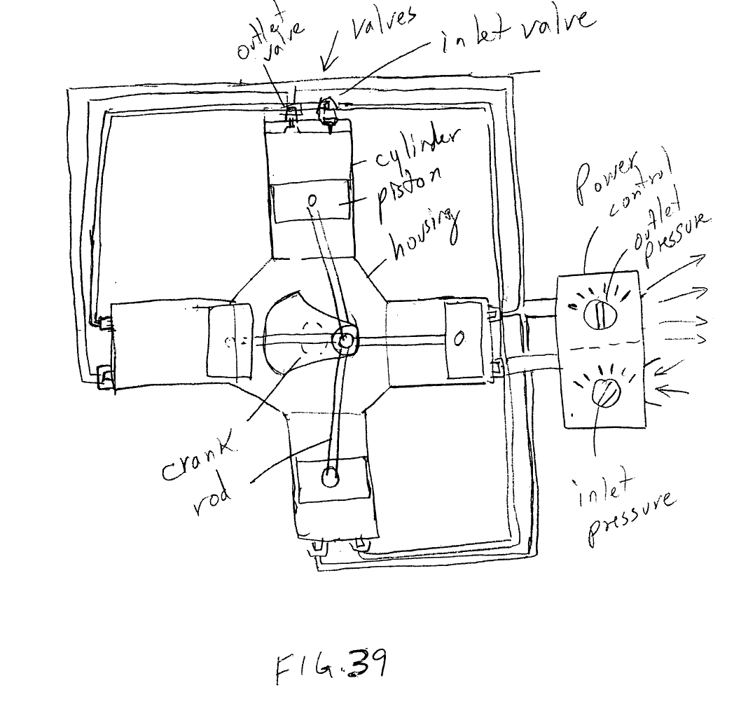

FIG. 37 exemplifies a block diagram for a point of sale (POS) system 50 upon which the present invention has been implemented. A card slot 52 (long), or short edge engaging slot 54, is provided for receiving the transaction card 56. A set of heads 58 is shown being retained proximal to a portion of card 56 containing the magnetic stripe, and having a magnetic read head, an array of electrodes, and a means for electrically connecting to a second electrode associated with the electronic ink, such as conductive whiskers, or a conductive wheel. Optionally, an optical detection head may be incorporated within the set of heads 58 so that open locations on the electronic ink may be detected for writing upon, wherein lines of writing may be stored without overwriting one another.

Conditioning circuitry 60, 62, 64 is shown for the magnetic reader, electronic ink electrodes, and optical detector, respectively. The signals are conditioned prior to receipt by a controller 66 with memory 68 that controls magnetic data collection and the voltage potentials being applied to the electrodes for writing the electronic ink. Controller 66 may be connected through a modem 72 for connection 74 to external equipment, such as cash registers, or computers, at the retailer associated with the POS terminals. The data may be transferred by other means as well (i.e. communication standards such as firewire, CAN, USB, BlueTooth wireless, etc.) as represented by direct connection 74.

A vertical array of electrodes 76 is also shown on the reverse side of the card reader to allow all or a portion of this area to be written to.

The combination of magnetic stripe and electronic ink may be utilized for communicating specials or other information to the user in both electronic and visual form. By way of example, a special offer may be printed on the electronic ink with a corresponding code magnetically written to in a queue of offers within the magnetic stripe (assuming the magnetic head possesses both read and write capability). The queue should have sufficient capability to allow a series of offers to be encoded therein. An additional magnetic strip may be alternatively provided for retaining this information. The user can make use of the special offer on their return visit (assuming that it is soon enough so that the particular offer in the queue has not been overwritten).

The present invention may be described as a transaction card for executing transactions, comprising:
a body member;
a magnetic stripe on said body member configured for being read by a point of sale system; and
a section of electronic ink adhered to said body member and configured with electrodes accessible to a properly configured point of sale terminal for writing on said electronic ink section.

The present invention also describes an apparatus for accessing transaction cards for both reading from their magnetic stripes and for writing to a section of electronic ink provided on the transaction card, comprising:
a housing configured for accepting said card;
a magnetic reader configured with a read head positioned within said housing for reading the data from the magnetic stripe of a transaction card being inserted therein;
means for establishing electrical contact with a first electrode section within a area of electronic ink on said transaction card as it is inserted within said housing;
an array of electrodes forming a second electrode section configured for being retained sufficiently close to said transaction card for writing data and or graphics to the electronic ink portion of the transaction card in response to the voltages applied between said first and said second electrode sections; and
a controller operably connected to said magnetic reader for registering the data collected from said transaction card and connected to said means and said array of electrodes for writing information on said transaction card.
   9.0 OFXHD—Hybrid Use of the Read-Write Head

Includes by reference the application entitled “OFXD Drive (Optical Fixed Head Drive)” Ser. No. 60/394,160 filed Jul. 1, 2002 which is included herein by reference.

9.1 Overview

Provides a middle ground approach to that described for speed and cost effectiveness. The Optical addressing channel is utilized in combination with a traditional moving reader head. The optical addressing head may span just a portion of the disk surface, preferably innermost or outermost tracks or other tracks that are easily accessible, or be configured so that it can only read selected tracks. A substantially conventional head can span the tracks to provide slower access.

If a combination approach is provided then the tracks needing the fastest access speed can be located on those tracks accessible to the optical read head while the remaining tracks can be accessed conventionally. This also allows readily accessed programs to be loaded in the tracks accessed by the fixed head device without altering the position of the moving head.

10. OFXHD—Remote Laser and/or Detector

Includes by reference the application entitled “OFXD Drive (Optical Fixed Head Drive)” Ser. No. 60/394,160 filed Jul. 1, 2002 which is included herein by reference.

10.1 Overview

To reduce head weight to speed access to the disk. The laser transmitter, and/or receiver are located remotely from the portion of the head that is aligned with specific tracks for writing and reading. The optical energy, preferably toward the ultraviolet end of the spectrum to provide high density recording, is directed over a distance, and directed at the head onto the disk using lenses, or other optical correction elements. Similarly the detector may be located remotely and the reflecting optical energy that is reflected from the disk being directed to the remote detector.

The optical energy may be directed to or from the head in any desired medium, such through free air, a gaseous environment, a vacuum, or using light pipes or fiber optics. The optical energy may be directed using mirrors or curving sections of light pipes.

As a result of moving the laser and/or detector remotely, the head weight may be substantially reduced, while fabrication costs may also be reduced. Remoting the transmitter and/or detector does not effect the actuation of the head when seeking a desired track. It will be appreciated that any conventional actuator may be utilized for controlling the head motion.

FIG. 38 depicts a simplified diagram of a remote transmitter/receiver head 10. A disk media 12 is shown upon which data is to be optically read and/or written. An actuator 14 is represented connected to an arm 16 connected to a pivoting base 18 which contains a transmitting laser 20 at a suitable wavelength. The optical energy from laser 20 is shown directed to head assembly 22 by a first mirror 24 and a second mirror 26 to a lens assembly 28. It will be appreciated that lens 28 and/or head assembly 22, or arm 16 itself, may be aerodynamically configured, such as with wings 30 or other air directing means, to provide for the correct flying height above the disk surface to facilitate reading and/or writing according to generally conventional techniques.

This method provides a number of benefits which aid in reducing weight and cost of the head positioning system while increasing the speed of the disk rive.

The present invention may be described as a disk drive head configured for optically accessing tracks on a media, comprising:
a movable arm adapted to provide movement over a portion of the disk surface;
an actuator operably coupled to a proximal end of said movable arm to impart rotational or linear motion at a distal end thereof;
a head assembly on said distal end of said movable arm, said head assembly adapted for directing optical energy to and/or from said disk surface;
a optical element positioned remotely from said distal end of said arm; and
means for coupling optical energy between said optical element and said head assembly.

The movable arm is adapted with a pivoting axis about which the head assembly can rotate out over the surface of the disk. The optical element is mounted proximal to the pivoting axis of said rotating arm. The head assembly is adapted with at least one lens for communicating optical energy to and/or from said disk surface. The means for coupling said optical energy comprises at least reflective element for redirecting said optical energy. The means for coupling said optical energy comprises at least one light pipe. The means for coupling said optical energy comprises at least fiber optic elements. The head assembly is adapted for flying above the surface of said disk at a sufficient distance.

This aspect of the invention may also be described as a method of coupling optical energy to and/or from a head assembly to a rotating disk media for accessing said disk media, comprising:
(a) remotely positioning an optical element in a positioning arm or assembly, which is not colocated with said head assembly, to reduce or eliminate the travel distance of said optical element;
(b) adapting said head assembly for communicated the optical energy to and/or from said optical element to the surface of said disk media.
   11.0 Automatic Haircutting Device

Including by reference provisional application entitled “Automatic Haircutting Device” docket RAST070102 Ser. No. 60/394,160 filed on Jul. 1, 2002.

11.1 Overview

To maintain a more constant suction pressure from the vacuum source when cutting hair.

The distance from distal end of the comb device and the vacuum opening are retained at a generally fixed distance. (Although this may be manually adjusted for selecting ranges of hair length or for compensating for hair thickness.) Changes in the length of the hair cut are then determined by movement of the cutting head within the housing, instead of moving the comb device which alters the distance from the vacuum intake and the head of the user and the suction pressure.

Changing of the cutting head location may be utilized as an alternative to moving the comb device as described in the prior application, or it may be utilized in combination with it so that both may move to optimize the vacuum force.

11.2 Additional Aspects

Include an electrostatic generator wherein the vacuum opening is charged to attract hair which facilitates the hair moving into the vacuum chamber.

Multipass operation—the device can be programmed to make the cuts in passes. This is preferable in some cases when the hair does not feed properly into the vacuum intake of the housing. The programming performs the cutting in a number of passes, wherein the user can follow the necessary pattern more than one time to achieve the desired result.

The present invention may be described as an apparatus for automatically cutting hair, comprising:
a housing adapted for connection to a vacuum source;
an intake within said housing adapted to draw in hair under vacuum pressure;
a comb assembly attached proximal to the intake end of said housing;
a movable cutting head within said housing; and
means of electronically controlling the position of said moveable cutting head within said housing in response to the position of said apparatus.
   12.0 Piston Power Workout Device

Embodiments of the piston device structured in a manner like a radial engine, or a gnome engine (rotating radial), such as from one to four cylinder. A “+” sign shaped configuration is easy to mount, and may provide about the right about of “notching” as described in the patent.

12.1 Overview

The use of a gnome configuration, has some advantages as to cooling (since spinning) while paddles on the exterior can provide some additional drag (these may be extendable). Unfortunately controlling the valve operation can be more difficult, in particular if remote electronic or mechanical control is desired.

Materials are preferably selected such that as the piston mechanism heats up the compression actually decreases, therein reducing the risk of damage to the unit. Therefore, the cylinder should expand in diameter more rapidly than the piston. Unlike a combustion engine this device preferably operates near room temperature to reduce material requirements and safety risks.

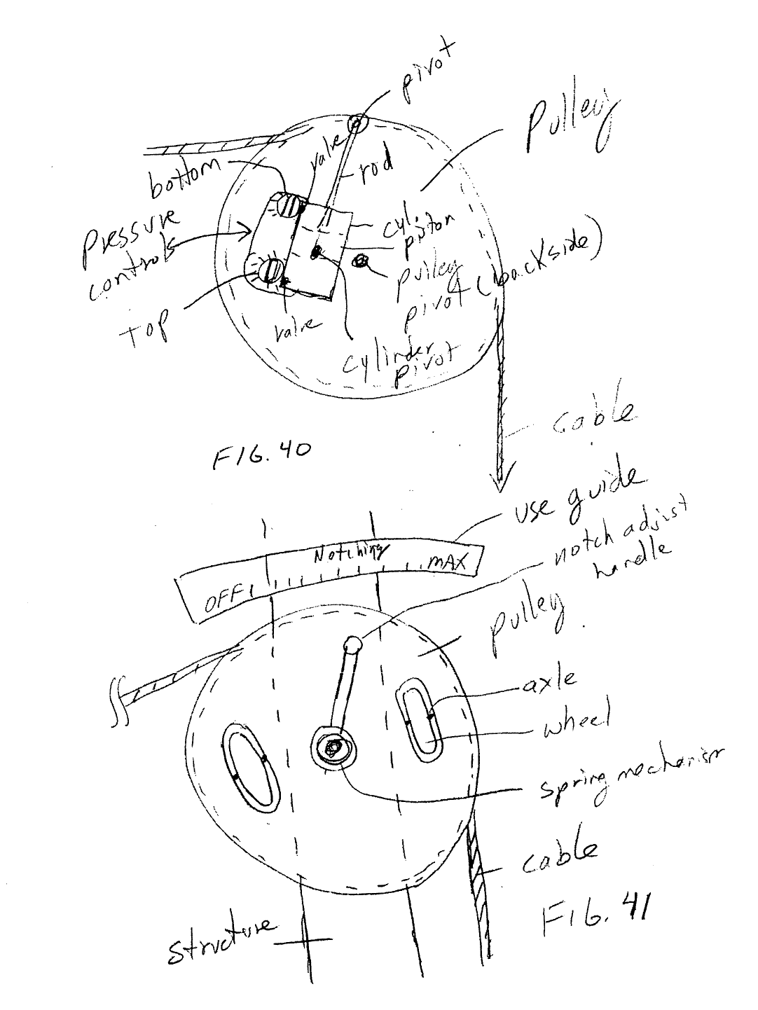

FIG. 39 depicts a four cylinder radial design with plumbing to route the inlet and output pressures to a power control, shown with separate controls for inlet and outlet pressure, although these coupled to a single control. The valves on each cylinder are one way wherein the separate inlet and outlet plumbing may be provided to a central controller. It will be appreciated that either the inlet or outlet valve may be configured to intake or exhaust without being plumbed to the pressure regulator, wherein the opposing intake or outlet becomes the controlling element for controlling the amount of force required to move the input of the weight machine.

13.0 Piston Power—Notching Pulleys

13.1 Overview

Adding “notching” to pulleys for conventional weight training machines.

A number of ways are available to conveniently add notching to existing systems, such as to the pulleys. Wherein the tension required varies during the pull.

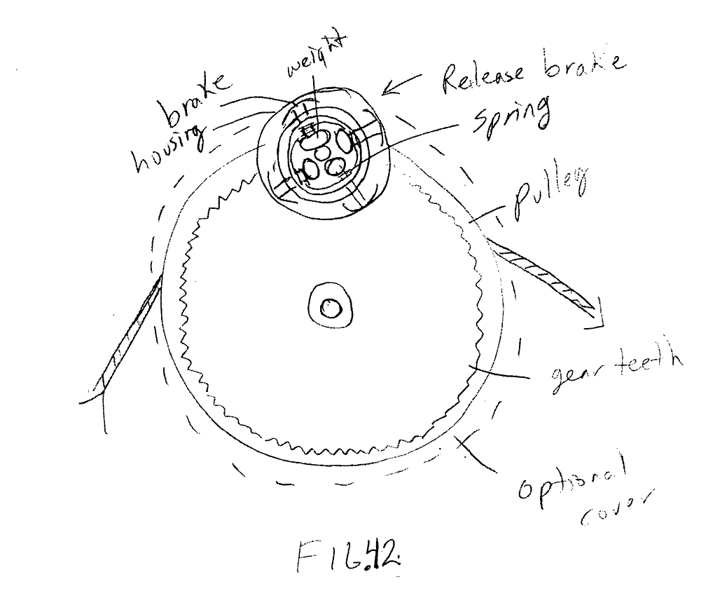

FIG. 40 depicts a rotating piston “notching” pulley. A piston rod is attached near the exterior of the pulley connected to a piston that is slidably engaged within a cylinder having an external pivot point that pivots at a stationary location (adjacent to the pulley pivot). The piston-cylinder can provide fixed valves for letting fluid in and out. The diagram is shown with two controllable valves. Alternatively a single control may be utilized for controlling both flow valves.

It will be appreciated that a single valve may be utilized that connected between the top of the cylinder and the bottom to control the amount of pressure required to overcome the movement. A closed system facilitates the use of liquids, but unfortunately can reduce the feel of the notching and reduce or eliminate the desired sounds.

As the pulley rotates about a backside axis, the piston moves about the front side of the pulley connected to a second axis. The user can set the desired amount of notching by adjusting the valve settings. Preferably the valves prevent flow until sufficient pressure builds up on that side, whereupon the pressure is exhausted. The intake pressure can be set to allow free flow of air into the cylinder. Alternatively, the compression can allowed to free flow with the intake air restricted, but not a very “natural” arrangement.

FIG. 41 depicts a simple mechanical arrangement for providing notching. Compliant wheels, such as silicon wheels, are attached to the pulley which depending on the amount of standoff of the pulley as set by the control, strike a structural element, shown as the upright. The axle on the pulley may also provide additional compliance, such as having a flex connection, or spring loaded axles mounts. Extra compliance can provide for a larger range of notching to be provided. The wheels compress, or move, when they strike the structure, wherein the operating force increases. A notching pulley may be configured from any convenient mechanical means without departing from the teachings of the present invention.

A magnetic notching element may be constructed (not shown) wherein the magnetic attraction (and/or repulsion) between portions of the pulley and other element is utilized for creating a simple notching effect. For example, with magnets coupled into the interior of the pulley (e.g. replacing the wheels in FIG. 2 with magnets) which are brought proximal to a large ferrometallic portions of the weight machine, such as steel structure, the effect is changes to the force as the pulley moves. The addition of alternating N and S magnets in relation to magnets mounted on the structure, (or other location) can provide increased notching at a slightly higher cost. The magnets may be made removable or the pulley configured with variable positioning to change the attraction of the magnets to the structure.

14.0 Piston Power—Speed Brake

14.1 Overview

Adding a release brake to a cable operated strength training machine. If the device slips from the hands of the user the brake engages to stop or slow the decent of the weights to prevent injury, damage, and noise. In addition, the unit may be set to restrict the maximum speed at which the weights are moved. It will be appreciated that ballistic weight pumping is not very effective, but certain unsophisticated persons like the appearance of it. The device therefore can increase the load placed on the cable when ballistic weight pumping is attempted.

A centrifugal brake is coupled to one of the cable pulleys, wherein upon the brake engages in response to the speed of motion. To increase the rapidity of action of the device it is preferably that it is geared up from the pulley motion. It will be appreciated that the pulleys are often large and the rotational velocity to drive a centrifugal brake limited. Therefore, by gearing up a coupling the activation of the device can be simplified. It may be possible in some instances to utilize conventional centrifugal clutch mechanisms for use in engaging engines as they reach sufficient RPM setting, however, in this case they are utilized to provide a braking action.

FIG. 42 depicts a pulley with inner peripheral gear teeth which engage a centrifugal brake. The centrifugal clutch shown rotates about 50× the pulley by virtue of its small pinion gear engaging the large gear track. The brakes within the unit are biased toward center wherein centrifugal force drives the brakes out toward the interior of the housing to induce drag. The brake shown uses four pads coupled to sliding rods which terminate at weights within a rotating inner housing. A biasing means is provided to bias the weights toward the center, which is depicted as springs acting to push the weight toward the center. An optional housing is shown to cover the whole pulley so that the gear teeth are not exposed. The centrifugal clutch mechanism may also be coupled to the pulley using a compliant wheel without the need of gearing, such as a rubber that contacts an inner track, however, the braking force is then limited to the traction between the clutch and pulley wheel. Furthermore, once traction is broken the speed is generally unrestrained as the dynamic friction (wheel sliding) is less than when it stays coupled to the pulley. An alternative is to provide a wavy pattern gear engagement wherein no sharp end gear teeth are exposed, yet the coupling force is retained; this may also provide for smoother operation.

Although a specific centrifugal sensing mechanism is described above, it should be appreciated that the present invention may be practiced using any form of velocity sensor coupled to a braking device.

The present invention generally describes (1) a weight training machine having a brake to stop free weight release as described herein, (2) a pulley device for use in a weight training device as described herein, and (3) a method of limited the unrestricted free fall of weight on a weight training machine as described herein.

15.0 HardBLite—Traffic Monitoring—Offset Unique Sound-Gen Structures

15.1 Overview

Included herein by reference is application entitled “Reaction Advantage Anti-Collision Systems and Methods” Ser. No. 09/730,327 filed Dec. 5, 2000.

Simplify registration of sound for determining number and speed of vehicles traversing past a traffic registration system.

Patterns of lateral structures are formed over portions of roadway surface. These patterns are misaligned on a lane by lane basis in relation to the microphone wherein sound being generated by one of said patterns as the vehicle traverses it will not be subject to substantial audio interference from other pattern structures on other lanes.

Each pattern preferably comprises a substantially unique pattern of either spaces, structure widths, structure heights, and structure audio responses (within the set of lanes upon which the structures exist) so that a particular audio pattern is generated in response to traversal of the structures, and can be readily discerned as to which lane was traversed and the speed over which the traversal occurred.

The structures for generating the sound in response to tire traversal may comprise: grooves formed in the road surface (i.e. when surface applied, surface cut, etc.), structures added to the surface of the road (i.e. paint, adhered strips, texturing, and so forth). It will be appreciated that these lateral structures may be created from one or more of the materials. Variation in width, spacing, structural cross-section, and material provide for generating different sound patterns for a given set of tires under a fixed set of conditions. Using the same material for each lateral strip and varying strip width and spacing allows for creating substantially unique sound patterns which can be matched to the pattern of the structures for determining which lane a vehicle has traversed. The speed with which the pattern is traversed is indicative of the speed of travel.

Furthermore, during testing of the lateral structures a number of additional sound metrics should be discerned wherein the type of vehicle, weight, and so forth may be readily determines.

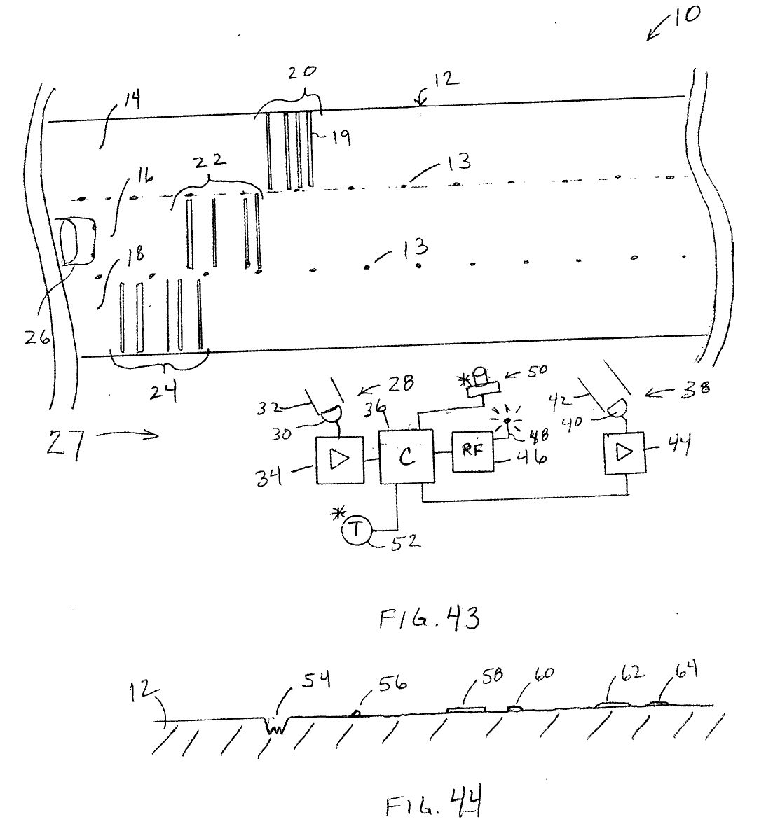

FIG. 43 exemplifies the use of the present invention 10, wherein a roadway 12, shown with roadway dividers 13 (i.e. Bot's dots) forming three lanes 14, 16, 18, each with lateral acoustic generating structures 19 in patterned groups 20, 22, 24 that generate a unique pattern of sound for each lane in response to a vehicle 26 traversal thereupon.

Alternatively, the same pattern may be created for each lane, wherein the sounds may be discerned from one another based on spatial orientation in relation to one or more acoustic pickups, or differentiated in relation to the sounds generated by the vehicles traversing the structures (i.e. different engine sounds, tire to roadway acoustic characteristics, and so forth), and other differentiable characteristics.

A means for registering traversal acoustics 27 is exemplified as comprising a means for detecting roadway acoustics 28, such as comprising a microphone 30, sound director 32, and signal conditioning circuits 34. A means for processing the acoustic information 36 preferably comprises a microprocessor, or DSP (digital signal processing) circuit adapted with software for performing digital signal processing. Alternatively, a neural net processing element or other circuit element capable of discerning acoustic patterns within the registered acoustic information may be utilized. Additional processing elements and acoustic registration elements may be utilized for processing the sound emanating from the roadway as vehicles pass over the lateral structures. A second means for registering traversal acoustics 38 is shown again by way of example comprising microphone 40, sound director 42, and conditioning circuit 44.

Although a microphone configured to register airborne acoustics is a traditional manner of registering acoustic information, it should be appreciated that acoustics are transmitting through the pavement surface itself. Therefore, a transducer such as an acoustic transducer, surface wave device, accelerometer, and other devices capable of registering vehicle traversal over the lateral structures 19, may be utilized.

Information being extracted from the acoustic information, such as the number of cars passing by, speed information, accident information, vehicle types, and so forth are communicated by way of any convenient form of communication link, such as wired connection, wireless connection, and so forth. The information may be communicated to other similar units, or to other roadway equipment, such as in a relay manner, or it may be communicated directly to a site that processes the information. A wireless RF device 46 with antenna 48 is shown by way of example for communicating the registered information for use.

Optionally a camera is shown 50 which is configured to capture still or moving images in response to, or in synchronous with the acoustical registration. For example, it may be desirable to capture images and speeds for a large truck as it travels along the road, or to capture images of vehicles traveling at a high rate of speed, for example over 100 mph. It will be appreciated that the acoustics may be utilized in conjunction with image capture to serve a number of purposes.

Additional parametric data may be collected for use at the site, such as temperature data from one or more thermal transducers 52, which may be located to gauge air temperature, roadway temperature, and so forth. Other forms of sensors may be utilized to detect light levels, humidity, precipitation, rain, and so forth.

As vehicles 26 pass over the groups of lateral structure 20, 22, 24, a set of unique acoustics are generated for each group, depending upon the pattern and composition of the lateral structures, and the speed and tire characteristics of the vehicle. It will be readily understood that processing techniques devised for voice recognition may be applied for extracting information from the registered acoustics. The pattern of sounds generated by the different groups of lateral structures are more readily discerned as a pattern of sound is created with temporal spacing that matches the structure being traversed for a given speed. Therefore, the presence and speed of the vehicle is easily determined, and additional metrics may be extracted in similar manner to voice recognition algorithms for extracting acoustic characteristics.

Furthermore, the means for registering the acoustics can additionally discern information about the vehicle itself, such as classifications as to large truck, small truck, motorcycle, electric car, economy car, sports car, luxury car, and so forth.

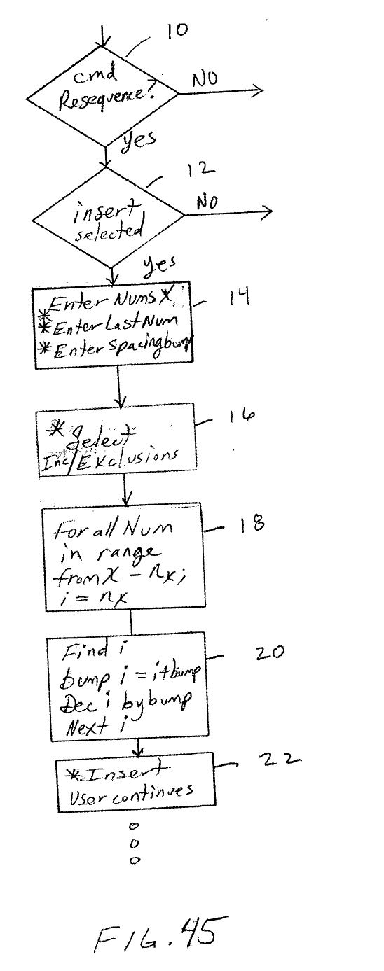

FIG. 44 depicts a roadway surface 12 configured with a number of different forms of lateral structures 19. A groove, or channel, 54 is shown cut into the roadway, a wire 56 or similar structure, a strip 58, 60 attached to the roadway, or a painted strip 62, 64. It will be recognized that the lateral structure may comprise any material or adaptation of the roadway that is adapted for generating a different sound than that surrounding roadway surface. Furthermore, lateral structure 19 may comprise a continuous strip, or a series of structures generally aligned in a lateral region, such as an array of cylindrical protrusions. Lateral structures 19 may span all or a portion of the lanes and it may be configured in any desired patterns along the roadway.

The means for registering traversal acoustics 27 may be housed in a number of locations, or existing equipment for detecting roadway information. By way of example, the circuits may be housed within emergency roadside telephone units, structural elements, vertical signs, horizontal sign, under bridges, on light poles, and so forth. The units may be wired to an existing source of power (i.e. AC power, or power from existing unit such as solar) or operated from separate solar power, fuel cells, batteries, and so forth.

The present system generally describes a system for detecting information about vehicles traversing a roadway surface, comprising:
a plurality of lateral structures attached to or within a roadway surface and adapted for generating a sound discernable from the surrounding roadway surface upon being traversed by a vehicle; and
means for registering traversal acoustics as vehicles traverse said lateral structures, wherein the number and speed of vehicle traffic is detected.
   16.0 HardBLite—Qualifying Alert Signals

Included herein by reference is application entitled “Reaction Advantage Anti-Collision Systems and Methods” Ser. No. 09/730,327 filed Dec. 5, 2000.

16.1 Overview

Preventing alerts from being annunciated in vehicles that are not in a position to benefit from the alert signal. The patent application included by reference described qualification of the alert signal using position data and/or heading information. This application expands on the use of qualification data with regard to the signal.

w/GPS system:

(1) More accurate GPS—GPS system use is more beneficial within the system since accuracy increased because restrictions have eased. Vehicle position may be known within 10M.

(2) GPS Roadway Identification

A preferred feature of a GPS system, in relation to the present invention would be for it to use its position information in combination with its map data base to determine what road it is on. This is performed by logging coordinates as the vehicle travels and comparing this track with the map. Additionally, it is preferred that the GPS software also determine an error bar for the roadway determination. For instance a percentage confidence, should accompany the indicated roadway. This is accomplished by measuring the fit between the positions in the log and the roadway surfaces listed within the database of the map. The comparison should take into account speed changes so that turns from roadways can be recognized and so forth. It will be appreciated that in certain situations, especially when the driver may be changing roads, the GPS signals are unreliable, or other confusing situations may arise in which the GPS may not be certain as to which road it is on, although this should be infrequent. By generating not only a roadway identification, but an indication of probably error, the system utilizing the roadway can determine how the data is to be utilized.

The GPS roadway data is valuable for communication by automatic crash reporting systems such as described within the application, wherein the GPS can furthermore communicate the distance from other roads and such as it is more “people friendly” to have a road and a distance from an onramp heading in that direction than it is to have a coordinate. Furthermore, this data may be utilized for qualifying event alerts as generated by the RAAC (reaction advantage anti-collision) system.

(3) Heading and Location information

It is important that the alerts be properly qualified before an alert is generated. The system should not be generated alerts that are not pertinent to the driver, if it does then the driver will either turn off the system, or ignore the alerts.

The present invention attempts to improve qualification by always sending information on both direction of travel and position. The following are a number of ways of providing this.

(A) Heading & Position—The direction of travel is determined, such as by a compass, or by analyzing the changes in location over time. The qualification data sent should include both a direction (heading) for the vehicle and a set of position coordinates.

The anti-collision system within a receiving vehicle, according to how it is programmed, determine how pertinent the information is. (i) A fixed offset may be added to the heading of the receiving vehicle to determine the heading range that is pertinent. (ii) The qualification software can determine a heading range of significance based on its own history of movement. For instance, if it is entering or within a long sweeping turn to the right, then the heading range should be expanded toward the right, since vehicles ahead would have a heading oriented more in that direction. (iii) The heading range can be qualified further if the GPS has determined on what it is traveling, wherein the upcoming curves in the road can be evaluated in determining the range of headings which may be pertinent given the location on the road and known speed of the vehicle.

(B) Heading range & Position—Additional information is provided by the transmitting vehicle to aid in qualifying the alert. One aspect is for the sender system to compute a range of headings for which the alert should pertain. The range of headings is preferably determined based on the heading range that the transmitting vehicle has experienced within a given period of time. For example, knowing that the signal really only need be pertinent to vehicles following within 10S of the primary vehicle, the primary vehicle computes what range of headings it has experienced within the last 10S and can use this as the range. It will be appreciated that on driving down a straight road the alert can be selective as to secondary vehicles which annunciate the alert. On a curving road, however, the range of valid headings associated with a pertinent even alert can be expanded based on the curvatures of the road. A range of heading data may then be sent for use by the receiving vehicle in making the qualifications.

(C) Historical Data—(i) Coordinates—Rather than compute headings and a range, the unit could transmit a series of coordinates that occurred, over a short prior period, that may be utilized by the receiver in qualifying alert signals. For instance it may send a series of 10 coordinates taken at 2S intervals thereby spanning 20S. (ii) Headings—A series of headings could also be sent for use in qualifying the alert. These headings span a predetermined length of time as known to both the sender and receiver, unless additional information is provided on the time the headings were valid. (iii) Roadway info—The sender can pass along a roadway identifier and travel direction for use by secondary vehicles in qualifying the signal. This is the easiest for the secondary vehicles to qualify, however, it requires the largest amount of data transfer, especially unless roadways are provided with identifiers.

w/o GPS:

Other information is communicated as a motion history by which the receiving vehicle can qualify the alert signal for pertinence. This is preferably a set of headings, or a heading range as described above. Preferably a range of headings is determined by the primary vehicle based on motion over time (up to approximately 10-30 seconds depending on speed, conditions, type of event, and severity of event). Alternatively a set of headings may be communicated that were taken over a given period of time. If the receiving vehicle is on the same road as the transmitting vehicle then it should have experienced a similar set of heading over that period of time. The time span should generally be short, as the vehicles which would find the information most pertinent are those following nearest the transmitting vehicle. By way of example, the period of time may be such as a period of 30S wherein readings were taken 5 seconds. The receiving vehicle can adjust the portion of the history evaluated by a predetermined following offset, and may also add additional factors if the signal has been regenerated wherein the distance to the lead car is obviously extended. Other parameters may be interest, such as speed history, although it is not uncommon for different lanes of the same road to be moving at distinctly different speeds.

17.0 Software—Indirect Sequences

Included by reference “Indirect Labeling within Drawing/Text Editors” within application docket number RAST070102 filed Jul. 1, 2002.

17.1 Overview

To minimize the resequencing efforts when changes occur within a document. This describes additional information for the included reference.

Applicable to word processors, spreadsheets, and other SW wherein a sequence of numbers, or other identifiers is used to refer to elements. For example, reference numbers being described within a patent application document.

It is often time consuming to add a reference number wherein all the numbers beyond a give number must be resequenced upwardly, or when deleting a reference number wherein all reference numbers above the deleted number would need to be realigned downwardly.

The numbers need not be identified, but the user can specify an “insertion” operation, wherein a number (character string, mixed character & numeric) and so forth. The example will describe a numeric string for clarity, although others forms may readily be performed.

The user specifies an “insertion” of a new number, and selects to “bump” numbers at or above that value by a selected amount (generally depending on the spacing between consecutive numbers in the sequence. (i.e. reference numbering may be set at increments of two, such as 10, 12, 14, 16, 18, . . . etc.). The operation can do an automatic find and replace of all numbers at or exceeding the inserted number. If other numbers, or similar references utilized, then the user can preferably elect to do a selective replace, wherein a find operation is performed on numbers at or exceeding the number to be inserted and the user can elect whether to make the bump change or not. Once the other numbers are changed, the user can then readily use the new number (or character string based element) for which space has been made in the sequence.

FIG. 45 is a flowchart which exemplifies one embodiment of the present method. Upon a resequence command from the user being entered at block 10 a check is performed for insertion at block 12. If insertion is selected then the user enters information about numbering at block 14, such as Nums X, last number, number spacing. Then at block 16 the user can select inclusions and exclusions. Then the program finds all numbers in the given range and can update according to blocks 18 and 20. After which at block 22 the user can continue operating on the program or doing other insertions.

Also consider the case of swapping occurrences of two elements (changing designators). Even a mapping scheme to alter a number of elements within a sequence.

The present method also applies to graphics packages, CAD programs, and so forth as they deal with textual entities as well that are in a sequence.

That elements are in a sequence can be denoted when created to make the identification easier perhaps denote each sequence in a different color, wherein multiple overlapping sequences may be supported.

The present embodiment can be described as a method of controlling indirect sequences of elements and the resequencing thereof as described herein.

18.0 Time Correction—User Maintained Offsets

Included herein by reference the description of correcting a clock in software as described within docket RAST070102 a provisional application filed Jul. 1, 2002.

18.1 Overview

To allow the user to control their own time reference. If a computer clock is tied to a network clock, the network clock may indicate a time that is before or after the clock that the user would normally use to track their own times. For example, some users want their clock to indicate a few minutes prior to the actual time so that they won't be late for meetings and so forth. Otherwise they may not want their clock to maintain the same time as the network based clock. Furthermore, the user may want their clock indicating a different time zone that the network clock.

Furthermore the method may be utilized with other clock sources, such as an atomic clock based value communicated to the system by way of a radio-frequency communication.

An input is provided for the user to enter and/or change a time offset value. The system stores the input value and adds or subtracts this value from the time received from an external clock value source each time the time value is calculated. The external clock source may be a network clock, an RF received atomic clock value, or clock value information received from any other external source for use in setting the displayed clock value. The time offset may be preferably set in to any desired value of seconds, minutes, and hours. The default value is zero.

This feature is preferably automatically commenced if the user attempts to alter the displayed clock setting when the system is configured for utilizing an external time value for setting the displayed clock value. The user is alerted that the clock is automatically set according to the specific external clock based value (network time setting, atomic clock value, etc.) and the user is prompted to enter an offset from the network based time, if they so choose. The difference between the time the user is trying to set and the external time value can be loaded into a preliminary offset value that upon being confirmed by the user becomes a time offset value from the network based time.

A second embodiment can provide the offsetting function for use with atomic clocks and other similar sources of time information. The value is received periodically and corrected by way of the user offset value before being used to set the display clock value.

The present system generally describes a method of controlling the displayed clock time on a computer device that has been configured for loading a time of day value from an external source, comprising:
displaying information about the network based time setting;
receiving a user offset value for use in offsetting the displayed clock value from that provided by said network based time setting;
storing said user offset value; and
adding said user offset value to said network based time setting in determining the clock value which is to be displayed.

Aspects of the inventive method include: adapting the method for use on personal computers connected to a network said user offset value as either a positive value or a negative value said user offset being expressed as seconds, minutes, hours, or a combination thereof.
further comprising detecting a user attempt to change said displayed time clock value which triggers the displaying of information about the network based time setting, along with the additional steps. Wherein the time difference value associated with the user attempt to change said displayed time clock value is considered a preliminary user offset value from said network based time setting, wherein user is informed that the displayed clock value is determined by a network based time setting wherein they may change, or delete the preliminary offset value, or upon confirming it becomes said user offset value to which the clock is adjusted.
   19.0 Simplified Embodiment of Reception Sentry

Included herein by reference, the “Reception Sentry” with provisional patent application docket number RAST070102 filed Jul. 1, 2002.

To discern information as to the comings and goings from a reception area. The present embodiment provides simplified embodiments which provide additional information and deployment methods over the current wired door opening sensors, hanging bells, or “electric eyes”.

The information provided by conventional door opening sensors is augmented with additional information that allow a controller and/or annunciation unit to discern the direction, coming in versus going out, of parties while it can optionally provide additional information such as if this is a coworker or a new individual.

The additional information is used to qualify the door opening information for altering the response thereto. In this way personnel are alerted to the type of traffic for which the door has been opened.

A number of embodiments are described herein, that provide additional information. This additional information is received by a controller circuit which correlates the door motion with the additional information and generates an appropriate alert in response thereto. By way of example, an audio response, such as a door opening chime, may be muted or have its sound altered if the door was opened from the inside. Additionally, or alternatively, if a known party is utilizing the door then the sound may be modified to indicate that condition as well.

The controller unit may house the circuits which register the additional information or this information may be communicated to the unit by wired connections or wireless connections.

Alternatively, the controller circuit may be housed with an annunciator configured for receiving door opening detection, such as the change in state of a switch. The controller is adapted to receive the additional information over a wired or wireless connection, wherein the annunciations are adapted based on the additional information.

INPUT SENSOR for Additional information:

Proximity Detector

These may sense the presence or proximity by utilizing any convenient ultrasonic, optical, infrared, inductive, capacitive, or other measurably effect altered by the presence or motion of parties within an entry area.

(1) a proximity detector is utilized for sensing the presence or motion of an individual toward the door from the inside of the room (typically a reception area).

(2) a proximity detector may be utilized for sensing presence, or motion, within a given area so that “known parties” can indicate their presence to the controller. For example, waving a hand in an area where otherwise persons entering or exiting would not normally obstruct. In this way the system registers the door event as “friendly” (that of a known party) and responds accordingly. The “known party” detection may alternatively, or additionally, comprise the use of a hidden switch which is activated by known parties for qualifying door motion, and/or the presence of an individual within a given area.

Sensitive Floor Mats

(1) A sensitive floor mat generate an indication that persons are within the reception area.

(2) A sensitive floor mat may be used on the exterior for registering entry, wherein it is activated prior to, or at the time the door is being opened.

(3) Sensitive floor mats with multiple sense areas can register the motion of one or more parties within the reception area to determine what is the nature of the traffic when the door opens.

(4) A wireless self-powered floor mat may be implemented wherein the movement of piezoelectric elements generates a charge that is utilized for powering an RF transmission of the event to a remote location, such as the RF input of the controller. In this way mats may be placed where ever desired without the need of wiring or the maintenance headaches associated with the use of batteries. Sufficient piezoelectric elements are utilized for generating enough power to generate the RF signal. Preferably the power generated charges a capacitor, and is triggered at a predetermined charge level.

Acoustic Registration

Sounds are registered and discriminated to extract the additional information. An acoustic signal processing means, such as a DSP circuit or neural net, is adapted to discern specific patterns of sound to provide additional information in relation to a door opening event.

(1) Detect from which direction the door is being opened. The sound of the door latch being disengaged and the door being opened is generally different depending on the direction of motion. Especially if a person is standing between the audio transducer the door latch when leaving, wherein the attenuation will be apparent in the audio signal.

(2) Detect motion through the area. This may be augmented by providing mats or areas over which the sound of foot traffic may be detected.

(3) Detect specific sounds, or phrases. These may be keywords used by “known” parties to identify themselves as such when they enter, and/or exit, through the door. For upon entry employee “Joe” announces, “Joe here”, wherein the unit matches that with a stored pattern of that phrase for “Joe” wherein he is identified as a known party.

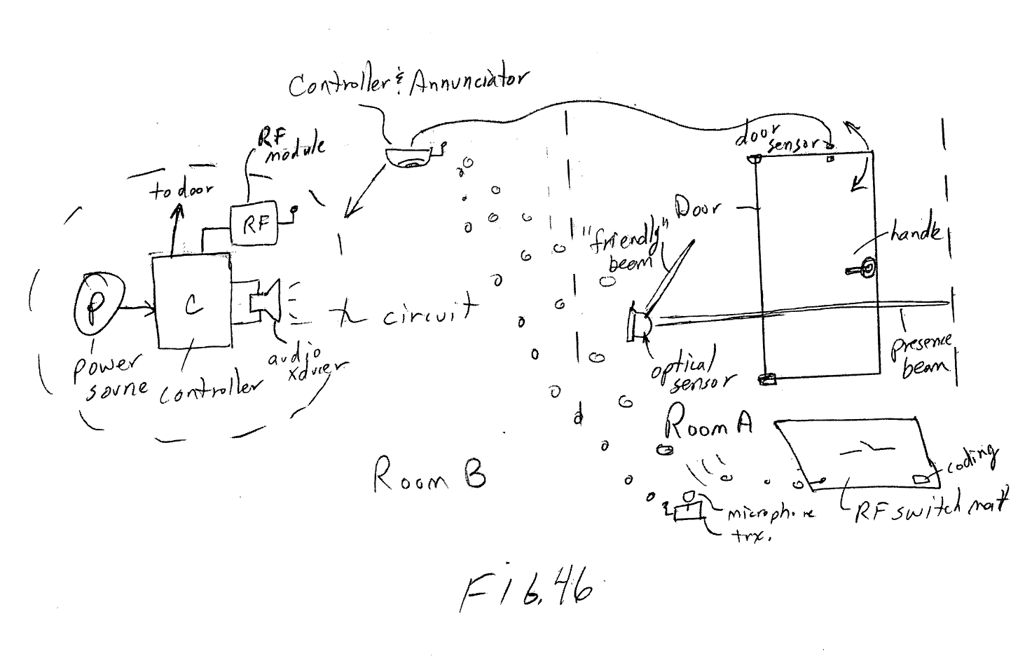

FIG. 46 depicts a simple configuration wherein “Room A” has a door through which known and unknown parties enter and exit. By way of example, a conventional wired door sensor is utilized to sense door motion, although any other means may be alternatively utilized.

Additional information is shown being registered in response to persons treading on a door mat, which is exemplified as generating an RF signal in response to being treaded upon. The floor mat may be powered from a conventional power source, or powered in response to the flexure or pressure of being treaded upon, wherein additional power may not be required. The matt is shown with a coding switch, wherein separate matts may be identified from one another. The coding may be embedded within the transmission circuit of the device wherein for instance the device contains an identifier that is generated within the RF transmission. The identifier may be contained within a programmed device, or from a small ID chip providing unique codes for the transmissions. The matt may provide more than one area that is sensed.

An optical sensor is also shown generating a preferably invisible beam across a portion of the room to detect the presence or motion of individuals through the room proximal the door. This can allow readily distinguishing whether parties are entering or exiting the room. A “friendly beam” is shown directed to an out of the way area, not normally traversed. Only a person familiar with the system would know to break this beam, such as by waving their hand through it traversing it and so forth. The system therein can utilize this to discern the type of entry/exit that is occurring.

An audio sensor is shown for use in registering audio within the room from which the direction of traversal, along with optional discernment of “known” parties may be determined. Alternatively, or additionally, the audio being received by the audio sensor may be annunciated by the controller annunciator.

The circuit within the controller and annunciator unit is shown as a controller chip which receives a conditioned signal about door status, (open/closed, or motion) and can annunciate the activity of the door, such as by generating sounds over an audio transducer. The controller according to the present invention can further qualify the annunciations it generates by detecting the direction of travel and if the parties are known.

In one embodiment the controller operates to qualify the door actions which modulates the form of annunciation being output. If the presence of an individual is detected by the additional sensors prior to the door opening, then the individual is deemed to be leaving wherein a first sound is generated upon door opening. If the door opens prior to the additional sensors registering motion, then the individual has entered, wherein the annunciation is generated of a second sound. If the party is identified as a known party, then the first or second sound being is generated, or modified if in progress, to indicate that a known party is respectively entering or exiting. Furthermore, if an exit has been detected, but the presence of one or more “unknown” individuals is still present in the area, then a third sound is generated to indicate the someone still is waiting in the room, (generally a reception area).

The present invention may be generally described by the following. (1) A system for registering information about the flow of parties to and from a given area accessed by a door as described herein. (2) An apparatus for sensing information about the flow of parties to and from a given area accessed by a door as described herein. (3) A method of tracking the flow of parties to and from an area through one or more access points as described herein. (4) A method of identifying employees transiting through a given area being monitored as described herein.

20.0 Controlling Articulated Elements—Added Embodiment

Included herein by reference, application entitled “Controlling Articulated Elements” Ser. No. 60/394,160, filed Jul. 1, 2002, and application entitled “A System and Method of Preventing Aircraft Wingtip Ground Incursion”, as docket number “TipTracker_{—}02” as filed as a CIP on Sep. 16, 2002.

20.1 Overview

To control the directional output of a laser or similar directed source of illumination. An apparatus for controlling the directional output of a laser or other light source.

20.2 Description of Example Embodiments

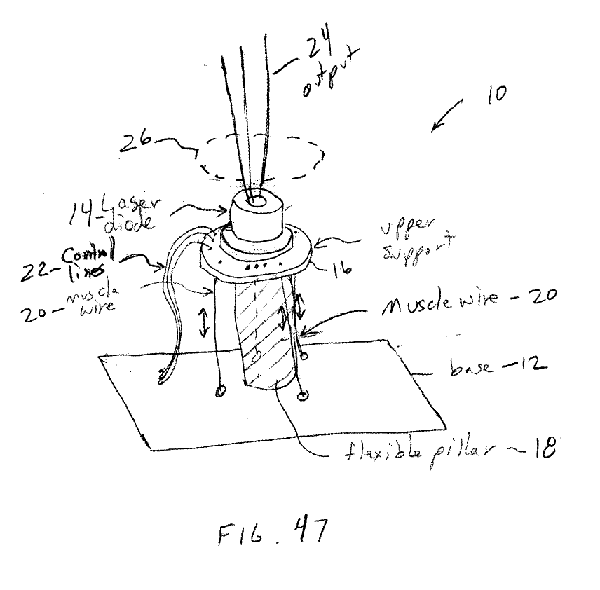

FIG. 47 depicts a laser direction modulator 10 having a base 12 a laser diode 14 (preferably with lens optics included) attached to a upper support 16. A flexible pillar is connected between base 12 and upper support 16. (Laser diode or other element may be utilized itself as the upper support 16, although less preferable.) Muscle wires 20 are connected between the base 12 and upper pillar 16. Typically at least three muscle wires would be connected so that full direction control could be established. Alternatively, fewer muscle wires may be utilized, such two, in conjunction with a biasing means (i.e. spring) wherein the biasing force can operate to provide an opposing force to the muscle wire. A set of control lines 22 connects the upper support to the control electronics, such as in base 12. The control lines preferably include the drive to the laser along with the drive signals for the muscle wires.

In operation the laser may be activated to generate a light output 24, whose direction may be altered by modulating the relative power applied through the muscle wires. Assuming three muscle wires distributed about the laser at 120 degrees polar separation. Energizing a single muscle wire causes the laser to pull toward that position, against the opposing force of the flexible pillar 18, a number of degrees that depends on the power applied to the muscle wire. By applying relative amounts of power between different muscle wires any desired direction may be pointed towards using this apparatus.

If each muscle wire between base 12 and upper support 16 is coiled or otherwise adapted to follow a longer path, then the amount of motion that may be imparted to the upper support can be increased. This occurs because, since the muscle wire contracts a given percentage in response to a given current, thus by increasing the length of muscle wire between any two fixed points, the relative amount of distance change increases.

An optional optical element 26, is shown such as a focusing lens. It will be appreciated that the distance between upper support 16 and the optical element 26 may be controlled by increasing or decreasing an overall biasing current to each of the muscle wires. For example, by applying equal currents to all muscle wires it will be noted that flexible pillar 18 will contract in response to the amount of current applied, and thus the contraction, of the muscle wires. Therefore, relative levels of current may also be applied to all muscle wires even when the muscle wires are being driven at different current levels for angling the output (insofar as maximum current is not exceeded).

It will further be appreciated that a hollow pillar may be utilized with a laser element shining through the pillar (i.e. coiled spring). This embodiment is similar to that shown in FIG. 47, however, with the laser inverted to shine through an aperture that extends through the pillar and out of the base. Of course back-to-back lasers may be utilized for generating a line that extends from either end of the device.

It will be appreciated that the present invention may be utilized with a cylinder, or other form of directionalizer, with a microphone, optical sensor, RF sensor, magnetic sensor, or other form of input device, for modulating the direction from which the signal is collected.

One application for directing a laser is described in the application entitled “A System and Method of Preventing Aircraft Wingtip Ground Incursion”, as docket number “TipTracker_{—}02” as filed as a CIP on Sep. 16, 2002, which is included herein by reference.

The present aspect of the invention may be described as an apparatus for directing the output of a laser beam, comprising:
a base;
a flexible support having a proximal end attached to said base;
a laser diode attached to the distal end of said flexible support and configured for receiving signals for controlling the operation of said laser diode; and
at least one muscle wire connected between said base and said laser diode for modulating the direction of output from said laser diode;
wherein said muscle wire is configured for connection to a signal source for controlling the contraction of said muscle wire.

And may have any one or more of the following attributes:
wherein at least three muscle wires are connected between said base and said laser diode.
further comprising an upper support base to which are attached the laser diode and the muscle wires.
further comprising a optical element retained in a substantially fixed relationship to said base over said laser diode, wherein the distance between said laser diode and said optical element may be modulated by increasing the common current supplied to each of said muscle wires.
wherein said flexible support comprises foam material or a spring.
further comprising a fixed length circuitous path member through which said muscle wire is retained between its connection with said base and said laser, whereby larger changes in distances between said laser diode and said base may be created in response to the contraction of said muscle wire through a circuitous path within said path member.
   21.0 Internet Television—Method of User Modification
   21.1 Overview

Provide user content control without content and copyright problems for broadcasters. Merging of TV and internet could bring a wealth of customized content to users, unfortunately the broadcasters and distributors of content are unable to modify this content based on copyrights of the creators of these works, as it is considered to damage their artistic expression.

The present system doesn't burden the broadcaster and distributors with hanging the content, but puts a set top box system and internet content (preferably from third party vendors) into the hands of users so that they can create merged content that suits their desires more than the content currently available.

The set top box operates similarly to a drawings package that receives vector, or other input from over the internet. This content may be described to overlay the content being received from the broadcaster to a selected level of transparency. This overlay may be provided with audio as well, wherein the audio from the internet may be played in conjunction with that received from a broadcaster, or it the volume from the broadcaster may be attenuated a given amount to provide audio headroom for the overlayed audio.

The set top box is also configured to maintain synchronization between the data collected over the internet, preferably prior to receiving the content from the broadcaster. The set top box then searches for cues within the broadcast content as described in the internet content. When those cues are found, such as an audio sequence, or video frame pattern, then the a portion of the internet data collected may be used to overlay the content from the broadcaster. The process continues so that the user can have a modified viewing/listening experience while the broadcaster can remain faithful to transmitting the program according to the auspices of the licensing agreement.

The user decides how they want to watch the programming, as far as additional commentaries, funny remarks, and so forth are concerned. The broadcaster content may be received over broadcast Radio/TV, cable Radio/TV, satellite Radio/TV, recorded media (DVDs, and so forth).

The process allows the user to extend their viewing in a number of interesting ways, the following being provided by way of example.

Funny overlays—portions of the programming are overlaid with humor of the genre, and intensity as selected by the user.

Buddy watching—a simulated partner to watch the show and occasionally comment on the show as real watching partner might. A small head shadow may be shown as well if desired.

Information overlays—Information about the programming, such as names of stars, character info, and so forth may be displayed over portions of the display to enhance the information available.

other language overlays—the audio track may be modified to eliminate offensive remarks, while other languages, or expressions may be used to replace those in the broadcast stream.

Narrative overlays—narrative overlays may be provided which describe any information the user may want to find about. This feature operates optimally in conjunction with a recorded media, as the feature can pause the play of the material while the selected narrative information is provided to the user. The elements in the broadcast stream may be used to select on what information is desired. For example the user points to a BMW car on the screen (preferably the item for which info is available is marked in some manor, such as a halo, allowing the user to move a cursor to it to request information. Or if only one item at a time, then pressing the info button when the halo (or other marking) shows up allows the user to get info.

The present aspect of the invention may be described as a method of empowering users to make their own desired modifications to audio and video content, without requiring the broadcaster or distributor to perform the changes, comprising:
(a) creating internet content to overlay portions of the video and audio of selected content elements being distributed over a communications media;
(b) wherein said creation of internet content is performed by organizations that make the content available to users of said content elements;
(c) uploading content overlays associated for desired content elements within said selected content elements;
(d) synchronizing the output of overlay files with the playback of said video and audio of said selected content elements;
(e) overlaying internet content over portions of said selected content elements to provide the desired experience as controlled by the user;
(f) wherein said uploading, synchronizing, and overlaying is performed within a set-top, or similar, device adapted for generating images and audio over a multimedia entertainment system.
   22.0 Patent Disclosure Reviewing Business Method
   22.1 Overview

A method of collaborating with companies to increase the breadth of their pending IP without incurring putting the companies at financial risk.

Advertise as patent specialist/inventor: to review patent disclosures for free*

Can find useful embodiments to add to your patent, or no charge.

IF you want the embodiments claimed then pay my hourly fee (i.e. $250/Hr,

and I'll sign over the rights.

ELSE—I'll file improvement on the patent and you may perhaps be able to purchase it at a later date.

The present aspect of the invention may be described as a method of collaborating on patents between a specialist and a company, comprising the steps of:
(a) agreeing on terms of a service offering between a specialist seeking to expand technology offerings and a company desiring more comprehensive intellectual property;
(b) receiving information from said company on a technology offering following a non-disclosure agreement with said service offering;
(c) reviewing technology offering from said company;
(d) determining extensions of the technology which may be patentable;
(e) accepting a predetermined remuneration by said specialist for assigning over rights to said extensions to said company according to the terms of the agreement, if extensions are found;
(f) accepting a signed release of said extension not wanted by said company, instead of remuneration for extensions that the company does not desire to pursue, if extensions are found;
(g) averring that no extensions were found for the technology offerings, wherein a below market rate is charged for the reviewing service; and
(h) returning or destroying materials about technology offerings according to the terms of the service offering.

The inventive aspect may also include any of the following singly or in combination.

Further comprising communicating service offering to a company that may file patent applications, prior to agreeing on terms of said service offering.

Wherein if extensions are assigned to said company then the company agrees as per the service offering to list the specialist as a patentee as required by Federal Regulations.

Wherein said predetermined remuneration for assigning rights over to the company is based on an hourly rate. Wherein said remuneration may comprise a fixed hourly rate multiplied by the number of hours spent in arriving at the extension.

Wherein said below market rate for review comprises no receipt of monetary compensation or other valuable compensation.

Wherein said below market rate for review comprises the receipt of monetary compensation at a fraction of the rate charged when extensions are found by specialist that company wants assigned to them.

Wherein said averring may take the form of a clause of a contractual instrument.

Wherein said contractual agreement comprises said service agreement.

Wherein said contractual agreement takes the form of a separate agreement returned that follows the terms of said service agreement.

Wherein said averring comprises a verbal exchange between said specialist and a representative of said company.

23.0 Securing Computer Systems Lost or Stolen in Transit

23.1 Overview

Computers are often stolen during shipment, in particular small laptop computers and the like. These devices are targets as they are small, expensive, and readily “fenced”. The present invention provides for securing the computers during transit, so that if the computer falls into the hands of someone other than the intended user, then it will not be usable, thereby reducing the value of these devices as targets.

The computer is configured with a lock that prevents the unit from being used, and even prevents the unit from being reformatted and rebuilt. The key for the lock is sent to the user in a separate package. Additionally, the device may be utilized by parties when traveling wherein, the computer is unusable without the key. The user may elect to retain the lock feature which requires the use of the key or to over ride the feature.

The lock and key may be provided in a number of alternative ways, according to the present invention.

(1) Software Lock

The boot code for the machine is configured with a key checking section that checks if a unique key exists on the machine. It is preferable that the keys be unique to each machine, wherein a key received for one machine can not be used to unlock additional machines. The key may be implemented as a routine on a floppy disk; a CD having particular codes; a dongle for attachment to the USB port, serial port, or parallel port; a key sequence PIN that must be entered at boot up to continue; a card having encoded information that is inserted within a slot of the computer; fingerprint information of the intended user sent for programming into a machine having a fingerprint scanner before it is shipped to the user.

One preferred method of providing a key is utilizing a USB dongle that contains a personal identifier for the user on the particular machine, the USB dongle may be incorporated with memory devices, wherein the device may perform a multifunction role of storing user specific files and of identifying the particular user to the machine.

Another preferred method of providing a key is with a PIN number that must be entered during the early boot sequence to allow the process to continue. These can be readily programmed into the firmware, or boot sequence software, to prevent unauthorized use without the need of additional hardware being sent to the user.

Features:

*The boot code should be capable of being self modified, wherein upon receipt the user can elect to bypass the checking for the key.

*Without a key being attached, the unit may indicate the error in a manner to aid in tracking the party with the stolen computer. For example, it may request being connected to a phone jack as additional files are needed, wherein it can contact the manufacturer by phone or by internet to indicate the serial number of the machine and allow the machine location to be traced.

(2) Hardware Locking

The hardware of the machine is adapted so that it will only operate in response to a proper key. The hardware is more difficult to bypass, however, it is more difficult to implement. The key may be a similar key as described above.

In Use

The key is separate from the locked machine during transit, such as when shipped, or when the user is traveling. When a system is purchased the key is sent to the user prior to the system arrival. The information that accompanies the key indicates how and why it is to be used, this is in a similar manner to how a credit card once received must be first activated prior to its being utilized.

The present aspect of the invention may be described as a method of preventing unauthorized use of a computer device being shipped to a user, comprising:
shipping a unique key to a user at an intended destination; and
shipping a computer device to said user that is responsive to said unique key by allowing execution to proceed in response to the presence or entry of said key.

The present aspect of the invention may be described as a method of preventing unauthorized use of a computer, as described herein.

The present aspect of the invention may be described as an apparatus for securing a computer from unauthorized use. Wherein said apparatus comprising a USB dongle device that includes an indentifier circuit that is capable of communicating with said computer through a USB port. Wherein said USB dongle device includes memory for storing the files of said authorized user.

24.0 Driving Range Automated Ball Collection System

24.1 Overview

To automatically collect golf balls on a driving range. A robotic system for automatically collecting golf balls on a driving range, or other similar location where a large number of balls need to be collected.

The unit preferably operates differently than present large scale systems which utilize sets of vertical disks between which the balls are engaged and then collected into a bin. The use of these systems in a scaled down form would be overly costly and prone to failure. The present invention provides new methods and systems for collecting golf balls that are suited for its robotic nature.

The robot may contain electronics that allow it to operate autonomously over the course, or it may receive signals from fixed units that direct the operations of the device. The use of a fixed station sending commands can reduce the power weight requirements, while reducing the likelihood of theft of the robot unit, and cost factors therein.

An apparatus for autonomously collecting golf balls on a driving range, comprising:
robotic device having,
   a drive mechanism,
   a steering mechanism,
   means for collecting or directing golf balls,
   (optional) means of detecting ball position,
   collection area or receptacle; and
   means for directing the general movement of the robotic device, to collect or direct the balls to said collection area or receptacle.
      24.2 Other Options

An automated “garage” into which the robot is received when not in use. (prevent the chance for theft while protecting it from the environment).

An automated collection station, which moves the balls collected to a dispensing station for cleaning and storage in preparation for being dispensed.

The present invention describes a few different collection mechanisms for use by the robot collection device.

(1) A ball launcher for rounding up the golf balls. The robot actually hits, or otherwise “sends” the golf balls toward a collection area. The collection area may have a collection recess into which the balls are directed, or there may be another process that then moves them into a collection recess or otherwise loads then for collection. The direction of hit is processed in relation to compass direction based on the present location of the robotic unit.

The balls may be launched using a striking device which moves through a striking path only when a ball is located and properly positioned, or it may utilize a constantly moving head, such as rotating, that when brought into contact with the ball imparts momentum to the ball to direct it fully or partially toward the collection area, or container. One preferred “launcher” uses a motor for setting a striker assembly biased by a spring, into a cocked position, upon detecting a ball the robot moves to position the ball properly in relation to the striker and then triggers the striker. The ball may be made to roll or to be directed over a portion of the ground, to reduce interference with other balls. Where the striker is positioned and the location to which the striker is cocked may be modulated to control the amount of momentum imparted on the ball being struck, such as in response to the distance to the collection container, or area, to which the ball is being directed.

(2) A ball pusher for rounding up the golf balls. The robot is configured with arms for pushing golf balls along the surface of the ground to be collected. This collection mechanism may be utilized in combination with the ball launcher approach of (1) wherein the pusher approach may be used by the same, or other robot, to direct the balls near the collection area into a collection bucket or trough.

It will be appreciated that although a raised collection receptacle may be used, it is preferable that the robot unit not be required to elevate the balls to deposit them in a collection receptacle, if this is required, then a dedicated system would be preferred such as an escalator form of device for raising balls up into a collection unit, or for directing them down tubes back to a cleaning and dispensing unit.

(3) A scoop form of collection mechanism. Since the robot collection device covers only a small footprint of the driving range and generally conforms to the surface therein, it is therefore able to collect balls using a scoop mechanism that allows for the collection of a limited number of golf balls, before being emptied.

The robot mechanism preferably provides a ball detection mechanism so that balls sparsely distributed may be identified and collected without the need to cover the entire area. For example an optical light beam, such as on a first arm, directed at a detector, such as on a second arm. In addition, the balls may be detected from light reflections from the surface of the balls, it will be appreciated that these can generate a unique reflection pattern by virtue of the spherical dimpled, and generally high reflective surface. The light source being preferably a laser light source.

The present aspect of the invention may be described as an apparatus for autonomously collecting golf balls on a driving range, comprising:
a motorized ball collection robot;
means for detecting location on said driving range of said robot to direct the collection of balls therein;
means of locating golf balls along said driving range of said robot;
means for collecting individual golf balls within said robot; and
a receptacle adapted for receiving balls from said robot.
   25.0 System and Method of Indicating Rearward Object Positioning
   25.1 Overview

Indicating the position and movement of items behind an individual, such as a pilot or driver. Many situations require in individual to be aware of what is happening all around them, not just within their field of view. Looking down at a display, such as a radar display can provide some increased field of view, however, it requires one to be viewing the screen instead of the environment and does not provide 3D positioning information.

A device that is retained in proximity to the head of a user, such as a helmet, visor, head-rest, or like wise, that indicates the presence and positioning of items behind the head of the user by stimulating portions of the back of the head and neck in accordance with the position, distance and movement of the rearward item.

The stimulation may utilize pressure, tactile sense, electric current, vibration, heat, or combinations thereof against the head of the user so that the user can sense the position, distance and motion of the item. Any of these elements whose output is capable of being sensed by an individual wearing the device is referred to as a stimulator.

A grid of stimulators is connected within a device for a user to wear. The activation of the stimulators is performed in response to activity, such as in the environment that they are unable to see.

The following describes stimulators utilized within a helmet, although other forms of attachment to a user may be utilized without departing from the present invention. It will be appreciated that stimulators may be placed in the entire suit of the wearer wherein position and distance may be indicated by virtue of this large combination of input sources. For example objects positioned below a seated wearer could be indicated on the seat of the wearer, while other rearward objects registered on a helmet device.

FIG. 48 depicts a device 10 for registering rearward positions three dimensionally. A helmet 12 is configured with an array of stimulators 14. Each stimulator has an output that may be sensed by the individual wearing helmet 12, for sensing rearward position and distance.

The stimulators 14 are connected to a driver 16 for controlling the stimulation being generated in response to information from a computer 18. External sensors 22, 24 (i.e. radar and optical image detector) are provided to detect rearward activity, such as nearby aircraft. The sensors may comprise any desired form of positional detector. The data from the sensors is received by an input device 20 and processed by computer 18 which determines the relative position and distance of an object that should be conveyed to the pilot, or other individual wearing the helmet. The computer determines if the object is pertinent to the situation, and if so maps the position onto the grid of stimulators by selectively energizing stimulators whose position on the helmet corresponds to a location in space. For example a reference point is chosen, such as a point that would lie just behind the eyes of the wearer, wherein the stimulator energized are those that lie between this artificial reference point and the object that has been detected.

The present aspect of the invention may be described as an apparatus for indicating the rearward position of objects to a user by stimulating portions of the users head that correspond to the position of the object, comprising:
a housing;
a plurality of skin stimulators arranged within said housing to be retained proximal to the skin of a user; and
a processing means configured for receiving information about objects located outside of the users forward looking field of view and mapping the positions of said objects to stimulators whose position on relative to the skin of the user correspond to the position of the object, wherein said stimulator are activated at an intensity that corresponds to the distance of the object or the relative threat represented by the object.
   26.0 Crane Terrain Clearance System
   26.1 Overview

To increase the safety of large cranes. Currently cranes rely on both the machinery itself and the operator to prevent accidents, and are subject to terrorist actions.

(1) Mapping Terrain as a Stop Limits.

Set heights of surrounding terrain into a map. A monitor then gauges positioning against the map to prevent motion into those areas. The map comprises both position and height. The position may be given as a Cartesian coordinate (latitude & longitude) and/or a polar coordinate (angle and distance). The system that prevent dangerous motion preferably takes the motion of the load (i.e. swinging) as well as the stretching of the cables when retaining the load.

(2) Remote Cutout Mechanism

Currently little protection is provided in response to an errant operator that “goes postal” or is committing a terrorist act. The present invention provides a method to allow other personnel to shut down the system. This also protects against electronic and mechanical failures.

It should be appreciated that access to a switch at the base of the crane may be easily blocked by an operator by placing an obstruction in front of the switch preventing others from shutting down power to the crane. Therefore, this remote system allows the unit to be shut down remotely.

(3) Remote Sensing

Providing additional information to the crane operator. At least one sensor is attached proximal to the hook or other attachment. The operator then can perform their operations with greater safety and need not completely rely on the accuracy of the information being provided by ground personnel.

Preferably, to allow for easy retrofitting, the system is provided as a wireless device wherein data is collected at the load and transmitted back to a receiver at the operator console. Furthermore, a two way link may be provided wherein the crane operator can verbally communicate with ground parties.

The sensor preferably comprises a camera, a microphone, one or more contact sensors, and optionally a pressure transducer wherein the operator gets feedback on the pressure being applied (lifting, or weight pressure on a load).

It is anticipated that the present invention preferably takes into account loading factors, such as load weight, load swinging, and wind speed and direction. It is recognized that the height at which an item is held above the ground is not just a function of the crane angles and cable played out, but also depends upon the amount of the load, along with wind loading factors and inertial swinging movements. Therefore, measurements taken at different load factors are thereby compensated to assure safety of the load.

This aspect of the invention may be described as an apparatus for controlling the operation of a crane.

27.0 Data Drive Mitre Box

Included by reference “Tape Measure Enhancements” described within patent RAST070102 application Ser. No. 60/394,160 filed Jul. 1, 2002.

27.1 Overview

To bridge the process between data collection and the processing of lengths of material subject to processing by portable equipment. The apparatus is particularly well suited for the cutting of moldings and other materials to a correct length and angle, although it applies to any material being processed in relation to its length.

Measure twice cut once is a maxim for contractors, handymen, and weekend do it yourselfers alike. This maxim is so well known because all of these individuals has repeatedly wasted material by incorrectly taking, recording, transferring, or performing the cut or other process being performed on the given workpiece. Material is often processed according to its length, such as making straight cuts, miter cuts, and performing other processes on material. Presently, users generally need to mark their workpieces so as to indicate locations of processing, which requires measurements be taken, recorded, and then transferred to each workpiece as it is processed. The present invention eliminates the need to record measurements and mark the length measurement on the workpiece.

A means for detecting length, such as a roller-wheel coupled to a rotational sensor, is embedded in a base member into which a section of material is to be slidably engaged. The roller wheel (or other measuring device) registers the length of material that has been fed into the machine.

By way of example, the following discussion will assume the use of a roller wheel on a miter box tool, such as utilized by a contractor, however it should be appreciated that any form of tool used by a contractor for processing of materials based on length may also be implemented according to the present invention. For example, jointers, planers, routers, table saws, laths, and so forth. The equipment is generally equipment that is semiportable, although measurements may be collected at one point and transferred to the system of the present invention for processing. Furthermore, the “table top” of the equipment may actually comprise the moving element while the workpiece is retained in a stationary position, such as in the case of hand power tools, such as so called “skilsaws”, routers, jigsaws and so forth.

Preferably a readout indicates the amount of material that has been slid past the roller. It is also preferred that the readout be a digital readout. This may be readily accomplished using a compliant wheel on an axle that is coupled to a rotational encoder that is connected to a controller circuit. The measurements are preferably indicated on a digital display, such as LED, LCD, electronic ink, and so forth.

Materials subject to different process steps depending on distance, such as different cut depths in relation to distance, are so indicated on the display. Preferably, the unit has a sensor to sense where a prior operation stopped so that if the machine is shut down for adjusting a parameter, such as cut depth, then the positional measurement data is not lost as the machine can “take up wherein it left off” to continue the processing of the workpiece.

The wheel preferably incorporates a pressure sensing element, or switch, wherein it can be sensed if the workpiece has lost contact with the wheel. If contact is lost then the measurement is of questionable accuracy, which will be noted. Upon a contact loss the unit may generate a warning, audible or indicated (display, flashing light, and so forth), and the entire measurement may be optional reset requiring the user to reenter the workpiece. Furthermore, the sensor may be sensitive to pressure and register increments of pressure, such as if the pressure applied drops below a predetermined threshold, or the trend line indicates a possible impending loss of contact, then an alert may be generated so that the user may correct the problem before measurement continuity is lost.

In a preferred embodiment data from an electronic tape measure is utilized in combination with the length detection means within the miter box or similar material processing equipment. For example the use may select a listed measurement, such as length and cut angle, whereupon the information is transferred to the miter box. As the material is slid into the miter box the measurement dial indicates the distance to the proper cut point, as 0 distance is reached the unit beeps to indicate positioning and the user can be sure to null out the reading for distance. Similarly, the angle of the cut may be checked wherein the handle is automatically, or under user control moved to the proper location for the cut. The cut is then performed accurately and a check box is then shown on the electronic tape measure.

Although a number of forms of electronic tape measure could be utilized within the present invention, a PDA with measurement head is preferred, in that it has a large interactive display allowing for a simple interface with the user. The digital tape measure may be interfaced with the miter box using an infrared link, RF link, or wired connection.

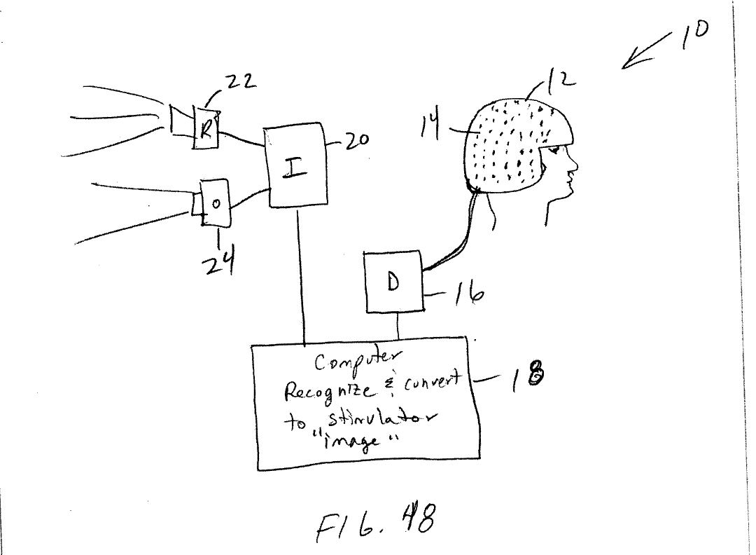

FIG. 49 exemplifies a table top tool 10 showing a table surface 10 with table surface 12. A means for detecting length 14 is provided for example by a wheel 14 coupled to a rotational encoder 16 (potentiometer, digital encoding shaft encoder, and so forth). The positional data is passed to a controller 20 which converts the revolution information into the desired distance measurements. The controller displays information on a display output 22. The absolute measurement may be displayed or a relative distance. In the present readout of “−18.375” the remaining distance is shown for making a cut of a 20.000 inch piece of material. The controller can preferably communicate through conditioning circuit 26 with an optical interface 28, RF interface 30, or wired interface 32, for receiving measurement information from a remote piece of equipment, such as the electronic tape measure.

Another aspect of the invention is a workpiece marking device coupled to a miter box or similarly fed piece of equipment. As the workpiece is processed, such as in response to the length and angle data, a marking head imprints a textual and/or graphic indicator on the workpiece which identifies it in relation to the data being utilized. For example if a list of 12 measurements for molding are provided on the PDA numbered 1-12 following the sequence of how they are to be laid out, then the corresponding number would be imprinted on each piece (preferably the backside) as it is processed.

The present inventive aspect may be described as an apparatus for correlating measurements with the processing of those measurements as described herein.

28.0 Predicting Tire Traction Loss

28.1 Overview

In racing or often in other forms of recreational driving it may be difficult to predict the how close the tires are to slipping on the roadway surface. This invention provides real time prediction of the amount of fractional G-forces remaining on a tire while it adheres to any particular surface.

When a driver pushes his vehicle into a corner at an excessive speed, the amount of traction provided by the tires may be exceeded by the centripetal force exerted and the vehicle, particularly a racing vehicle with hard suspension, may be subject to a considerable and dangerous sideways sliding as the tires transition from a static friction form of traction to a dynamic friction traction, which is less. In many circumstances such miscalculations on the drivers part may be hazardous or even prove fatal.

Reading out the G's of the vehicle and relying on the theoretical amount of G-forces which can be supported by the traction of the tires does not accommodate for differences in roadway surfaces, such as surface structure (roughness), variations in the surface profile, temperature of the road, temperature of the tire, variations in G based on fluctuations (such as over a rough surface), and so forth.

As a result the drive must trust his instincts and in many cases be driving either too conservatively and losing races, or taking a chance at spinning out and losing time, damaging his vehicle, or even causing an accident which could be fatal.

Therefore, a need exists for a system that can predict the onset of traction loss, such as for each tire on the vehicle, wherein the driver is apprised of a tire approaching the traction loss situation and can adjust accordingly. The present invention fulfills that need and provides additional advantages to drivers on the highway or at the racecourse.

It will be appreciated that a tire flexes under hard cornering. If the cornering speed is too high then the limit of adhesion may be reached after which the tires will slip sideways. The present invention is a system and method that predicts when this limit of adhesion is being reached prior to the side slipping of the tire. This invention is described in terms of its applicability to a racing situation wherein the need to predict a loss of adhesion can be critical, however, it also applies to other vehicles such as passenger vehicles to a lesser extent.

Within the present invention, sections of the tire, preferably a narrow circumferential rib is adapted to lose traction slightly before the remaining portions of the tire. As the rib begins to lose traction its relative flexure changes which is sensed by the sensors connected to a system which determines that the limit of adhesion is being reached under the given conditions. The system generates an output signal in response to predicting how close the tire is to reaching the limit of adhesion.

Aside from predicting how close a tire is to its limit of adhesion, the data on flexure provides information on the composition of forces being applied at each tire, which can be very useful for improving race performance, such as for setting up the vehicle suspension to better distribute corner forces under the given conditions.

Rather than rib sections, other small protruding areas, such as conical sections, rods, and so forth (sense “whiskers”), may be utilized for predicting a loss of traction, however, it can be more difficult to configure these structures to lose traction a set G amount before the remainder of the tire under a wide range of conditions.

Rather than a single prediction based on a single rib flexure change event, the system is preferably capable of detecting the amount and nature of the flexure relating to slippage of the “sense rib” to determine how close the onset of traction loss appears to be. Furthermore, to provide additional information a “Sense rib” may be divided into sections that are each configured to slip at different loading. For example, consider a tire wherein a sense rib is divided into 4 areas, each area providing four separate sections with different thresholds that are below the limit of adhesion, such as 0.005-0.01G, 0.04G, 0.06G, 0.08G, below the threshold of the remainder of the tire. In this way the data can more readily provide additional information so that the current G loading in relation to the limit of adhesion may be accurately determined, and even an output to a linear display, such as a bar graph generated, in response to how close the vehicle is to the limit of adhesion. It will be appreciated that the system preferably takes into account similar information from each of the tires.

Sensors are connected to the sense rib(s) and the data from these is communicated to a processor which preferably collects data from additional wheels and predicts a probability factor that tire adhesion will be lost on the remainder of one or more tires. The sensors may comprise any convenient sensor capable of registering deflection. One preferred sensor type is a piezo electric material which generates an output voltage in response to changes in flexure. The piezo electric material can be sandwiched within a rib, or adhered externally the rib. If the sense rib is a structure nearest the sidewall then the piezoelectric material can be adhered to the rib and extend up the sidewall. Currently piezoelectric sensing element have begun to be integrated within the structure of a tennis racquet frame for converting impact forces into electrical energy which is used for changing the dynamics of the racquet.

The sensor may also reside inside the tire and be mechanically linked with the extension of one or more tire ribs, wherein the flexure of the extended rib and the information regarding loss of traction is registered by the mechanically coupled sensor. By way of example, a sensor strip, such as pressure, motion, or flexure, (e.g. piezoelectric, or others) may be connected through a protrusions, such as small spine, that connects the sensors up into the rib, wherein deflection of the rib deflects the spines connected to the sensors which then register the amount of deflection. Furthermore, sensor whiskers may be retained within the tire orthogonal to the direction of flexion during a turn that generate a signal in response to the bending that occurs as a result of taking a hard turn.

The sensors from each of these areas is communicated to a processor which performs the predictions. Before communicating with the prediction processor, the information from the sensors is preferably registered by a small controller which encodes the data into a serial bit stream for communication to the prediction processor, which may be incorporated within or an adjunct to one or more of the vehicle control computers. The communication may be by way of an RF link, or any other desired form or wireless communication pathway. The prediction processor is preferably configured to receive the data from each of the wheels.

The system may be utilized to alert the driver manually, wherein they may make manual corrections to prevent traction loss; connected to an automated system which can make minor corrections for rapidly fluctuations that may induce a slip, for example in response to a bad road condition wherein speed is automatically bled; and/or be connected to a data acquisition system wherein the information may be utilized for further processing, determination of tire materials and pressure, replacement interval and so forth.

Furthermore the flexure data itself can provide information as to the force being applied at each of the tires, during cornering and other conditions, wherein the setup of the vehicle may be improved. The information available from processing the flexure data can be utilized to (1) inform the driver; (2) be coupled to other automotive systems such as suspension control systems, variable aerodynamic control systems, and so forth to automatically make adjustments to the vehicle; (3) be communicated to computer systems used for tracking vehicle performance and so forth to increase the accuracy of the decision making process both during and subsequent to the race.

28.2 Description of Example Embodiments

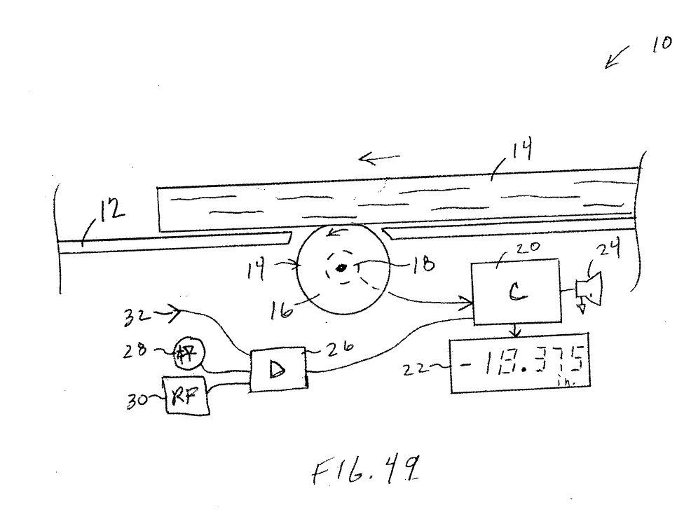

FIG. 50 is a block diagram of a adhesion limit prediction apparatus 10 according to the present invention. A conventional racing tire 12 attached to a four-spoke wheel 14 are shown with a deflection sensing net 16 attached to the exterior of a tire rib, shown in the side tire view inset of FIG. 51, showing a sense rib near each edge of the tire. Deflection sensing 16 is shown comprising four sections of sensors 20a-20d, each having four segmented rib sections which are adapted to have adhesion limits that progressively differ from the remainder of the tire, wherein additional data may be collected in response to a progressive adhesion loss nearing the adhesion loss point for the remainder of the tire. In this embodiment the sensor sections are formed in a single circular pattern that surrounds and is adhered to the surface of the tire. Wiring 22a-22d from each of the four sections 20a-20d of sensors is routed to a central circuit module 24, shown within the hub, which conditions the data from the sensors, converts it to digital data, and communicates it as a serial bit stream to a prediction processor 26, preferably within the vehicle. (It will be appreciated that the in-vehicle system may alternatively operate as a simple relay station, however, this would make the use of the data subject to wider area communication problems as the vehicle traveled about the course.)

If sensors on the interior face of the tire are to be collected the wiring from the sensors may be routed from the opposing side toward the hub. The collection of the data and the communication of it to a prediction circuit need not take place in the hub, as the circuits may be placed around the wheel so long as they are properly weighted so as not to effect tire balance.

Data from the flexure sensors is shown being received by a first of four RF receiver unit 28a. If less than four RF channels are utilized to collect, then synchronization should be employed. The data is collected by a processor 30, or a series of processors (i.e. a microcontroller may be coupled to a digital signal processor, or a neural net, wherein control operations and signal processing may be performed in relation to the received data; separate elements may be utilized to process the data for each tire of the algorithms are otherwise to slow to render real time response). On a simple level the processor can use the flexure data from the ribs to look up the separation (in terms of Gs) from where the remainder of the tire under the given conditions should reach its limit of adhesion. It will be appreciated that additional digital signal processing algorithms and/or neural net techniques may be utilized typically based on data collected under actual running conditions to extract every subtle flexure nuance from the data. Processor 30 performs predictions in relation to each of the four tires, and may perform calculations for both the front and back side of the tire. The system can determine overall conditions, such as checking for mismatches in relative proximity to the limit of adhesion between front and rear, and other checks for assessing both performance factors and safety. Processor 30 preferably receives data from additional sensors 34, such as temperature 34, speed 36, and from other systems within the vehicle 38. This information can provide for increasing the accuracy of prediction.

The system generates outputs in response to the flexure data, and preferably keeps the driver apprised on how close the front and rear of the vehicle are to the adhesion limit when cornering. This output may be in the form of a visual output 40, audio output 42, or tactile output 44. The output may be a binary output such as a warning, however, the driver can better assess the situation if analog information is presented wherein they are provided with information on their relative G position in relation to the actual adhesion limit under the given conditions. Therefore, a set of bar graphs are shown 46 for the depicts the how close adhesion limits on both the front and rear, while a conventional G-meter is shown to give the driver a better feel for the “Stick” of the tires. A user interface 50 is preferably provided wherethrough the user can turn on the system 52, establish aspects of use 54, and preferably set the scaling factor for output 56 and even select different coarse conditions 58, or levels of aggression to which the system should be configure itself. The prediction output signal may be routed to other vehicle systems 60 to allow the vehicle to configure itself properly in relation to tire deflection and the proximity to the limit of adhesion.

The prediction information generated by the system may be optionally communicated through a data link 62 to a remote receiver 64, which is preferable connected to a data acquisition system and computer 66, such as that utilized for monitoring the vital statistics of the vehicles and the raceway conditions. The prediction information may be routed through existing onboard telemetry systems to the remote locations.

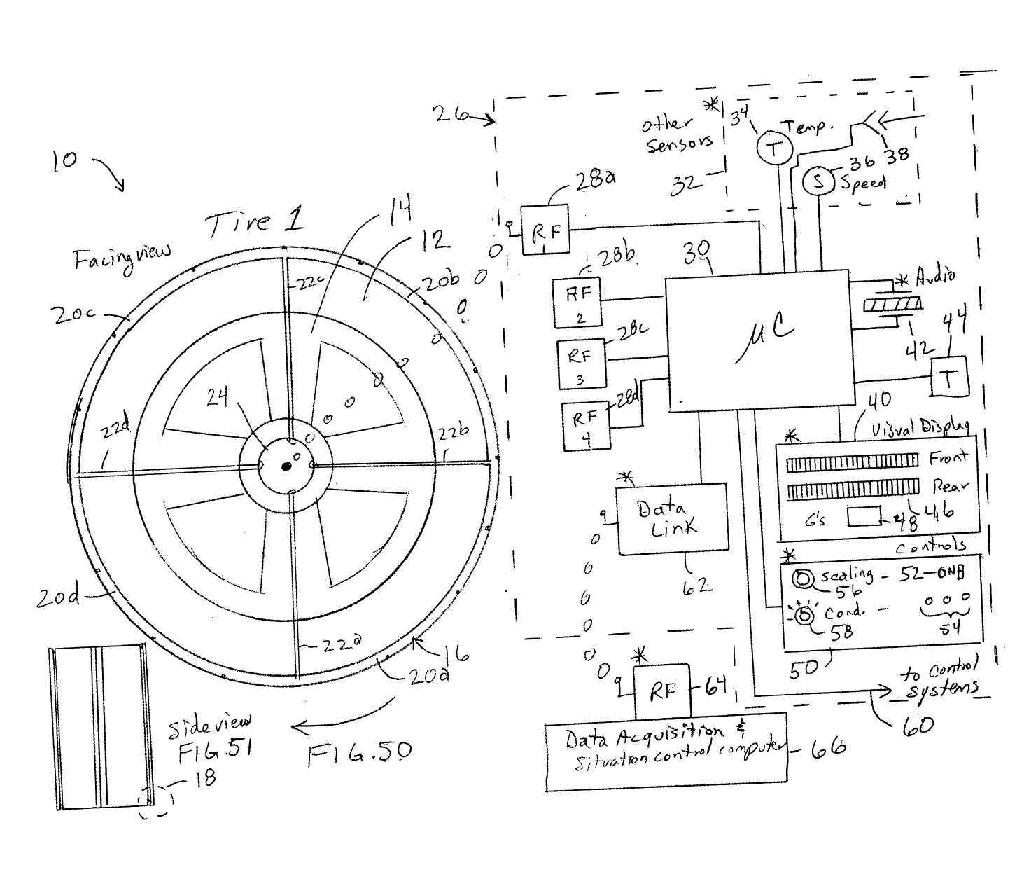

FIG. 52 depicts a tire 70 with a center sense rib 72 while the remainder of the tire 74 is conventional. FIG. 53 depicts a detailed cross section of sense rib 72 wherein it is seen that the rib attaches to a base 76 shared by the remainder of the tire and various belts of material 78. A sensor strip 80 is shown attached to a “T” shaped spine 82 that passes through the sensor strip and into rib 72. Alternatively the head may take on a two dimensional shape such as circular, oval, rectangular and so forth; wherein the flexure associated with braking and acceleration may also be registered. the shape Deflection of rib 72 causes the top of the spine to move which reduces the pressure on one side of the sensor while increasing it on the other side of the sensor strip. In this way the sensor strip can respond to even slight changes in deflection. Sensor strip 80 preferably comprise a differential arrangement of piezo electric material, while spine 82 may be formed from carbon composite or other stiff material. A covering is shown over sensor strip 80 for and spine 82 to provide added security from separation. The signals from the sensor strip are routed out to the perimeter of the tire at balanced locations about the tire, and connected to a unit for communication to the prediction circuit, or computer.

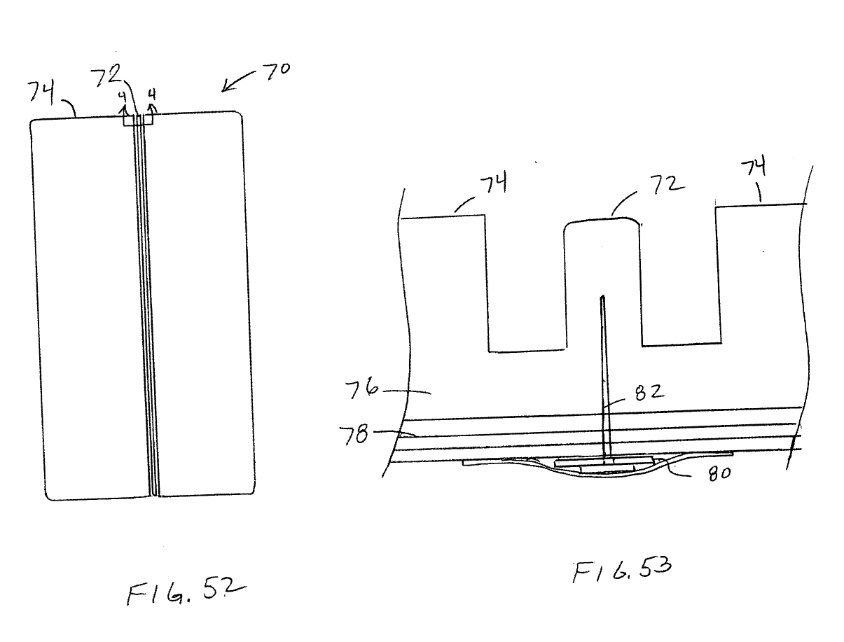

In instances wherein a sense rib, protrusion, or whisker is used for sensing tire flexure in response to cornering, it may be preferable to stiffen the rib to reduce its compliance so that it may match the amount of flexure exhibited by the remainder of the tire surface. Stiffeners may be molded into the tire, or added afterward, these may take the form of stiffer tire compounds or the use of additional structures, such as the spines described in relation to FIG. 54 and FIG. 55.

FIG. 54 and FIG. 55 depict a sense rib 72 (similar to that shown in FIG. 53 but facing downward as if in contact with a roadway surface 84 (shown in dashed lines, although it would be generally following the line at the bottom of the tire surface). In FIG. 54 the tire is subject to a large cornering force but is not close to its limit of adhesion, in FIG. 55 rib 72 has reached the limit of adhesion as is slipping from the flexed position of FIG. 54 to the lower flex of FIG. 55. It is this flex change that is registered and processed within the system of the current invention. As the roadway surface is subject to debris and other perturbations the prediction processor is adapted to filter the noise components, to properly evaluate the flexure data over intervals and in response to historical information, the conditions present at the other tires, and within other aspects of the vehicle system to properly predict the proximity to the adhesion limit and the forces being applied at each tire.

Aspects of Invention:

Flexure only sensing—the above sensing of flexure for the ribs may be utilized for sensing flexure only, wherein portions of the tire that exceed the limit of adhesion before the remainder of the tire are not necessary. Sensing members may be distributed within the tire that directly respond to flexing, or that like the spines described have their mechanical deflection coupled to a remote sensor.

Sensing braking and acceleration flexure—the flexure that occurs in response to braking and acceleration may additionally or alternatively be sensed within the system by making flexure sensor responsive to longitudinal flexure as well as or alternative to the lateral flexure that occurs during cornering. A single sensor may be configured to response to either event, or it may be preferably configured so that the flexure in the lateral and longitudinal directions are sensed separately, wherein the respective flexure components may be discerned for more accurately gauging the response of the tire to road interface.

The flexure of the sense rib may be less preferably sensed acoustically with an audio processor, or by image processing of the rib flexure, however, these approaches are generally more subject to external conditions.

The present aspect of the invention may be described as a system for predicting tire traction loss as a result of turns, comprising:
generally narrow circumferential portions of a tire adapted to lose traction prior to the remainder of said tire;
said circumferential portions adapted to flex during turning of an associated vehicle in response to traction with the road surface and to exhibit flexure changes as said circumferential portion loses traction with the roadway prior to the remainder of the tire surface;
a sensor coupled to said circumferential portion which generates an electrical signal in response to the flexure thereto; and
a prediction circuit adapted for registering the signal from said sensor and generating a traction estimation output signal responsive to a prediction of the onset of traction loss for the remainder of the tire surface.

The system may include the following in any combination.

Further comprising an audio annunciator adapted to generate an audio warning signal in response to said traction estimation output signal if a danger of traction loss has been predicted.

Wherein said audio annunciator is located so that the driver may hear the warnings.

Further comprising a visual display to warn the driver of traction loss conditions based on the traction estimation output signal.

Wherein said visual display comprises a warning lights. Wherein said visual display may comprise a multi-element sequence of lights indicating different traction estimation output signals. Wherein said visual display may comprise a bar graph display of the traction estimation output signal. Wherein said bar graph display may comprise a green center portion bordered by yellow elements and then red elements toward the edges; wherein the green indicates good traction and the probability of traction loss is shown to increase the elements nearer the edge of the display, moving toward yellow and red, are activated.

Further comprising: a transmitter for communicating said traction estimation output signal to a remote receiver; a remote receiver for receiving said output signal; and a data acquisition system connected to said receiver for processing said signal in relation to the tire and track conditions wherein changes to the driving strategy may be made.

Wherein said generally narrow circumferential portion comprises a narrow bead, or tread, along the surface of the tire. Wherein said narrow bead is located on the exterior edges of the tire. Wherein said bead is located on both exterior edges of the tire. Wherein said narrow bead is located on the central portion of the tire surface.

Wherein said generally narrow circumferential portion of the tire is configured in different sections which are adapted to lose traction at a different relative G-loading amount in relation to the remainder of the tire; wherein sensors are connected to register the flexure of these separate sections; wherein generation of traction estimation output signal by the prediction circuit may provide additional accuracy in predicting the onset of traction loss.

Wherein said circumferential portion is slightly less diameter than the remainder of the tire to lose traction slightly before the remainder of the tire surface.

Wherein said circumferential portion is profiled so that during side loading it will lose traction slightly before the remainder of the tire surface.

Wherein said circumferential portion is of a material, or the tire material in that area is altered so that during side loading it will lose traction slightly before the remainder of the tire surface.

Wherein said sensor comprises a piezoelectric flexure sensor which generates a voltage in response to flexure changes. Wherein said sensor is attached to the exterior portions of the tire and communicates a signal in response to flexure.

Wherein said prediction circuit comprises a computer or microprocessor adapted with software for executing prediction routines and outputting a responsive signal.

The present aspect of the invention may also be described as a method of predicting the adhesion limit of a tire in real time, comprising: allowing a sense portion of the tire surface to be subject to a slightly lower adhesion limit that the remainder of the tire surface; sensing flexure changes in said sense portion; and generating a responsive output when said sense portion reaches its adhesion limit and begins to slip, wherein the proximity of the adhesion limit may is predicted for the remainder of the tire surface.

29.0 Predicting Tire Pressure—Circumferential Sensors

Included by reference is the traction loss sensing system described above, although it can sense tire pressure it is not optimized toward that function.

29.1 Overview

The present invention is a system and method of determining if tire pressure is outside of a given range of tire pressures, wherein the driver may be alerted thereupon.

A circumferential sensing ring is incorporated within the tire construction or attached as a circumferential band of material within the interior of the tire, preferably near the center. Deflection of the tire where it meets the road distorts the shape of the sensing ring, the amount of distortion being indicative of the tire pressure. It will be noted that as the tire rotates a different portion of the tire is deflected, wherein the piezoelectric material continually supplies power in an amount that is responsive to the distortion of the tire as it meets the road surface.

The sensing ring is preferably of a piezo-electric material that generates a voltage output in response to the flexure. In this way the system need not operate from batteries while it is capable of generating alerts in response to tire pressures that are outside of a predetermined range, such as under-inflated or over-inflated. It will be appreciated that if a tire were non-compliant (“rock-hard”), then no deflection of the circumference of the tire would occur. Preferably the sensing ring is divided into at least two separate sections, each spanning a portion of the circumference, wherein the speed of rotation of the tire may also be sensed as a parameter, but also if this data is desired for correcting the deflection data generated by the sensing ring.

Other sensors may be included with the sensing ring to provide additional tire data. One sensor that is readily incorporated is a temperature sensor, that registers the actual temperature of the tire. Temperature data is important not only for determining if a tire is running “hot” and may have an increased likelyhood of delamination; but also the temperature data can be used for correcting the deflection sensing of the sensing ring as it will be noted that a cold tire is subject to less deflection at a given tire pressure than a warm tire.

The sensor is coupled to a communication link over which the inflation information is directed to a controller which is configured to annunciate information to the driver, and/or for recording the state of the tires in a data log, such as associated with a “black box”. The communication link preferably comprises an inductive ring, or alternatively an RF ring, following the circumference of the tire over which a signal is generated in response to the registered tire data.

In one embodiment a small controller operably connected to the sensor ring, communicates information about the tire by pulsing current through the inductive ring at a high frequency, preferably prefaced by a pattern known to the receiving controller, wherein it can positively discern the pattern of electromagnetic disturbance from background conditions. The data can be transmitted in a raw form, which is particularly well suited for use in race vehicles, or it may generate data or alerts in response to a particular set of conditions being met, or not being met. A controller within the vehicle is configured to receive the transmissions from each of the tires and from this data to properly alert the driver or even to allow the system to make corrections that prevent possible problems, such as limiting the maximum speed if tire inflation is low and the tire has heated up and reaching a dangerous level.

The present aspect of the invention can be described as an apparatus for sensing tire pressure based on tire deflection as described herein.

30.0 Generating Power from a Wheel or Tire

Included by reference are the tire sensing systems and method described above.

30.1 Overview

The present aspects of the invention describe methods of generating power from a tire or wheel such as for powering a stem-mounted tire pressure sensor, tire pump device, parametric collection/dissemination devices, output elements such as lights, indicators, sounds and so forth.

Incorporation of a deflection beam having piezo electric material, wherein even minor roughness or bouncing is converted to deflection of the beam and an electro conversion device, such as piezoelectric, which generates a power output for charging a capacitor in response thereto. In this way the tire sensor can operate from its own source of power and need not rely on a battery.

Furthermore, the generated power may be utilized for operating a pump, preferably one having a fixed upper pressure limit, wherein a tire that is low will be inflated to a suitable pressure level while operating the associated vehicle.

A tire mounted sensing and/or generating device, as described in the included references, may also be coupled through the attached rim to a stem mounted pump, sensor, or controller, such as by integrating contacts along the rim which engage contacts along a portion of wheel interface of the tire. For example a positive contact is placed along the a first tire bead on a first side of the tire, while a negative contact is placed along a tire bead o the opposing side of the tire. The bead may be provided with raised contacts to facilitate making contact. It will be appreciated that these contacts must be securely bonded with the tire surface to prevent damage during installation. The contacts on the wheel interface connect with sensors or power generation devices within the tire, such as the described tire sensors and generators within the referenced application. The rim is also provided with contacts, which may be circumferential about the rim or provided only at one or more fixed locations, such as near the tire stem itself.

In this way sufficient power may be provided for keeping tire pressure maintained at an appropriate level.

Additionally, it will be appreciated that materials, such as conductive nanotubes may be added to the tire compounds, and/or cord materials, which can be used to form the contacts. It will be appreciated that the nanotubes are about two orders of magnitude stronger than steel while they can be made conductive or semiconductive. Therefore, the nanotube material is a natural for incorporation within the cords of the tire. Furthermore, the temperature coefficient for the nanotubes in a given arrangement are more compatible with the steel, not to mention that the chemical composition of the nanotubes is more compatible with the rubber compounds. By way of example and not limitation, the outer layers of cord may be formed in two adjacent bands, each incorporating conductive nanotubes. These cords therefore provide a conductor between the piezo electric sensor/generator which is capable of connecting directly to the wheel, or a stem mounted device connected to the rim.

The present aspect of the invention can be described as a method of powering a tire mounted pressure sensor in response to the motion of said tire.

30.5 Piezo-Electric Cored Wheels.

30.5.1 References.

Incorporated herein by reference is a description of powering a stem-mounted tire pressure sensor within provisional patent application 60/413,199 filed Sep. 23, 2002.

30.5.2 Introduction.

Small wheels such as those for skateboards, scooters, roller-blades, and similar devices with light load bearing wheels can be configured according to this invention with a flex core that both absorbs shock and generates power for sensing load forces or more preferably for driving electronic circuits, such as lights, RF sources, sound systems and so forth.

Piezo electric material is coupled to a hub that is capable of flexing within the wheel. The deflection of the hub flexes the piezo material to generate a voltage. The piezo-electric material can be formed in a cylinder about the hub or in a plane generally orthogonal to the hub axis (same plane as the wheel), or a combination thereof.

A cylindrical strip, or strips, of piezo-electric material can be wrapped within one or more compressible layers surrounding the hub of a wheel, or in combination with a compressible wheel material. Multiple layers of piezoelectric may be utilized to increase the power output in response to wheel motion. In either case under load the compressible wheel or layer in the wheel is slightly compressed allowing the piezo to deform in that area as another area is losing its deformation and returning to the circular shape. The flexure of the piezo electric material generates a current that can be stored and utilized for a variety of purposes.

30.6 Embodiments.

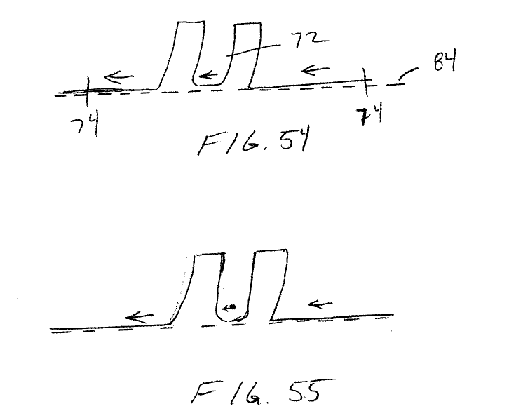

FIG. 56 depicts a first embodiment 10 in which the power from the piezo electric is stored and utilized for intermittently powering one or more light sources, such as LEDs, contained within the wheels 12 which are preferably translucent allowing the light from the LEDs to shine through the wheel for viewing.

A bearing assembly 14 with mounting hole 16 is shown within wheel 12 within a compliant core 18 that contains one or more piezoelectric strips 20 configured to generate a voltage in response to flexure. The details of construction are not herein disclosed as these are readily known in the art. The piezoelectric strip is shown fabricated with a ridge pattern to increase the material flexure. Although not shown in this embodiment the piezoelectric strip can be configured as the circuit board for connecting the LEDs and controller, or be colocated with the circuitry being driven.

During use, force F compresses compliant core 18 under bearing assembly 14 which flattens the piezoelectric strip(s) thereby generating a voltage, the location that was previously flattened returns to its nominal shape and it also generates a voltage. The voltage output is responsive to the pressure applied as the wheel rolls, wherein heavier loads and heavier accelerations are transformed into higher output voltages. The strip can be a single strip or broken up into multiple strips whose voltages are utilized individually, in series, or in parallel, depending on the desired application.

In the present embodiment, the voltage is used to charge capacitors, wherein a controller circuit 22 modulates the activity of LEDs 24, shown as surface mount LEDs, although any form of lighting element may be driven.

The lights are preferably driven intermittently for short duty cycles to increase the apparent brightness. The circuitry can be configured for various drive arrangements, for example, random, lighting a specific portion (or portions) of the wheel depending on orientation (as sensed by the piezo), circling light at a fixed rate in relation to the sensed rate of the wheel (for example slightly faster, or slower than the wheel speed wherein a slow rotation is seen). Generating a pattern in response to the force being generated on the wheel as sensed by the voltage level generated by the piezo-electric strip.

FIG. 57 depicts an embodiment 30 in which wheel 32 has a bearing assembly 34 and mounting hole 36 retained within a compliant region 38. The piezo electric strips 40 are mounted to the exterior of the wheel over a recessed area 39 wherein the bulk of the piezo electric does not contact the wheel surface and is free to stretch. The strips are formed in a single spoked element joined to the wheel, or more preferably with its exterior portions molded within the wheel itself. A control circuit 42 is shown mounted on one of the spoke elements 40, and LEDs 44 are shown mounted to each of the spokes as well.

Each spoke element is configured to have a degree of compliance wherein the change in tension on the element as the wheel rotates is converted by the piezo electric strip to power for driving the LEDs. The piezo electric strip may be configured in a wavy pattern to simplify the generation of voltage in response to changes in length. It should be appreciated that the controller can in some cases be eliminated and the LEDs driven directly, however, then the pattern of LED activations could not be controlled.

It should be appreciated that although discrete LEDs are shown in the embodiment, that OLEDs can be utilized, wherein they are integrated into the wheel or the piezo electric elements. Furthermore, other forms of light output or color changing devices may be utilized such as electronic ink, to generate an output in response to the wheel motion. These may be applied to any of the embodiments.

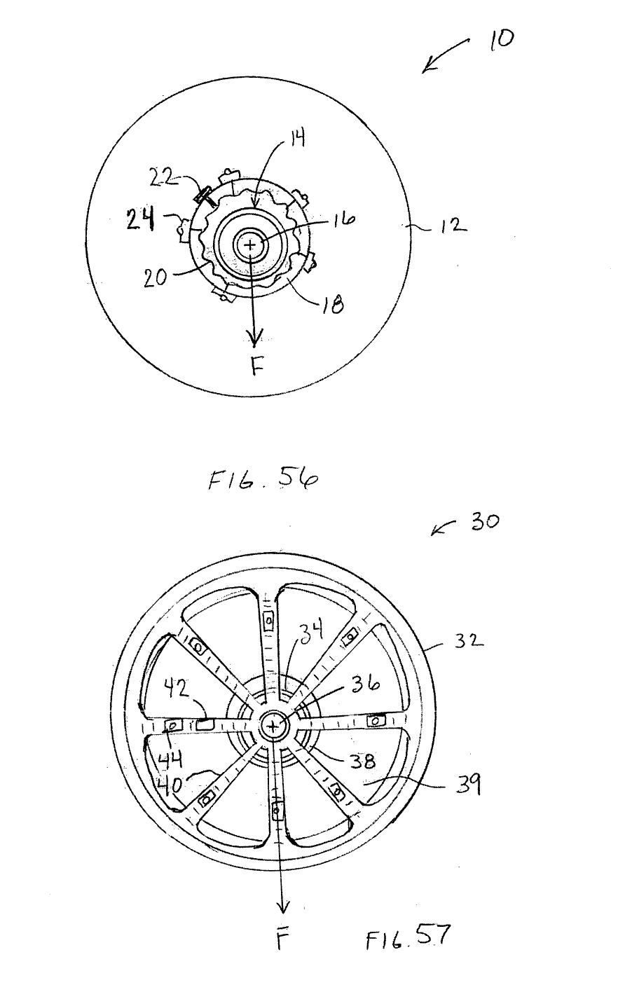

FIG. 58 depicts another embodiment of a wheel 50 with tire 52 and slightly compressible spokes 54. The spokes contain piezo electric elements, or other electronic devices for converting motion or pressure into electrical energy. Additional embodiments can be produced similar to the active spoke embodiment above without departing from the teachings of the present invention.

31.0 Conductive Tire Compounds and Cording

31.1 Overview

Fabricating tires that have higher conductivity to enhance safety. It will be appreciated that situations, such as a lightning strike, downed power lines, or the like can subject the occupants to danger as the metal of the vehicle is substantially insulated from the underlying ground by the insulating properties of the rubber tires. Furthermore, static can build up in the vehicle which poses a danger to electronics, and personnel. On particularly important application is for tires on aircraft, wherein the static buildup can be so severe, that proper grounding is not provided prior to fueling, the fuel vapors in the tank can be ignited in response to sparking.

Conductive compounds, molecules, may be added to the tires which can increase their strength while increasing their conductivity. By way of example, conductive nanotube structures may be added to the tire compounds and/or the cording of the tire to increase the conductivity of the tire.

32.0 High Traction Vehicle Tires

32.1 Overview

To improve high traction tires, in particular those utilized in snow.

Traditional steel studs that are utilized to improve tire traction, such as in cold climates subject to snow and ice, suffer from a number of drawbacks. For example, they are noisy, visible, subject to corrosion, subject to heating, malleable, and have different chemical and thermal responses in relation to the tire material into which they are attached, which are both adverse to the proper retention of the studs.

Studs formed from high temperature composites, preferably nanotube materials or other carbon based high strength structures, can overcome these limitations and be mixed in a composition to render desired wear characteristics, and thereby to reduce the wear on the road surface, perhaps thereby allowing them to be used in regions that prohibit the use of conventionally studded tires.

Studs formed with nano structures, such as the nanotubes, may be formed into studs conventionally and attached to the tires. Furthermore, the attachment portion of the stud which is inserted within the tire can be fabricated with an open lattice structure that is capable of bonding with the rubber, for example by heating the rubber compound to flow into the lattice structure. The studs may be inserted and then heated or inserted into a hot hole, such as a laser zapping a small hole into which the stud is immediately inserted to bond with the flowing rubber material.

Studs formed with nanostructures may integrated within the tire during its manufacture. The studs may be part of, or attached to, a webbing around which the tire is molded. The webbing retains the studs in position during molding. The shape of molded in studs can prevent their loss from the tire surface. For instance triangular shaped with the flat portion toward the center of the tire, as the studs wear additional material of the stud is exposed to the exterior of the tire. Molded in studs are preferably fabricated as open lattice structures into which the compounds of the tire infuse and surround, such that the resultant tire becomes very homogenous and is not subject to the dangers associated with conventional studded tires that require their use only at reduced speeds. It will be appreciated that the manufacture of open lattice structures is being utilized within prosthetics for allowing the bone to “knit” with the materials, such as within the bone interface shafts of an artificial hip joint.

33.0 Abrasive Materials and Methods of Manufacture

33.1 Overview

The creation of abrasive material wherein the abrasive particles are firmly retained in the underlying material to which they are attached.

Attaching nanocomposite materials to an underlying material to form an abrasive that is capable of working steels and other materials. It will be appreciated that a carbon nanotube is one instance of a nanostructure that is approximately 100 times stronger than steel, and may therefore be utilized in working steel or other hard materials. The elongate shape of a nanotube makes it ideal for embedding within a carrier, base material, to provide an abrasive surface. It will be appreciated the conventional abrasives typically must rely on particles bonded with adhesives to a given surface.

One method of manufacturing this material is to prepare the base material so that its surface is liquid, or at least a highly deformable semisolid, such as melting at least a surface layer or utilizing a material that is in the process of curing, such as resins and so forth. The nanocomposite material are then dispensed and accelerated toward the material at a sufficient velocity so as to be embedded within the base material upon impact. Preferably the nanotubes are dispensed through a collection of micronozzles that aid in orienting the nanotubes along their axis as they sent at high velocity toward the liquid/semi-solid state base material. As the base material hardens it will have a surface from which the nanotubes extend that is abrasive. To increase adherence, the nanostructures may be modified by forming them with molecule chains extending from portions of the tube, wherein these extension can be embedded in the base material to prevent dislodging of the nanotube therefrom.

The above describes a material having a micro abrasive surface, however, more coarse levels of abrasion may be created using variations of the technique.

Although nanotubes, and other nanostructures are themselves a tight lattice, they may be formed with other nanostructures into more open lattice structures which may be sufficiently open to allow the base material to be infused into the interstitial spaces therein, and to provide extension from a base material. By way of example a lattice of carbon nanotubes may be formed into a supertube, or other easily implemented structures, which may then be embedded in a layer of other material, such as being thermoformed or cured upon structure having nanocomposite elements.

34.0 System and Method of Authenticating Surveillance Data

To communicate and authenticate data from surveillance equipment and make it available for non-alterable use.

It is often desirable to monitor certain characteristics (typically audio, video, or both) at a given location. Unfortunately, the monitoring of the area is presently only as useful as the person(s) that are viewing the monitored data to discern “problems” that arise. In some cases the monitored data is simply stored and utilized at a later time IF something happened warranting the action. In many situations, however, such a plan generates excessive data. The current methods are not well suited for stopping some activity in progress and does not provide for storage only of selected data. As the data is generally stored nearby, the data is subject to being destroyed. Furthermore, since data stored by a given party is subject to their own manipulation its value as a “incorruptible witness” is limited.

The present invention provides a surveillance system that can be utilized in stationary locations or at moving locations. The present invention provides a number of advantages that are particularly well-suited for use in vehicles. The system allows the nature, time, and preferably location of the event to be chronicled in a manner wherein its veracity may not be brought into question.

The advent of sophisticated signal processing and neural net software allows for event types to be recognized within a data stream, such as audio and/or video stream. These events may comprise violent activities toward an individual, destruction of property, along with other “problem” activity and “suspicious” activity. The “problem” activity and “suspicious” activity is any activity which fits within sets of predetermined criterion established for the system.

The present system utilizes a data collection system at a first location whose stream is processed for detecting “problem” or “suspicious activity”. Herein the data collection system will be exemplified as a video camera system which includes a microphone. Other forms of data collection, such as parametric data (proximity, heat maps, equipment status, etc.), and so forth may be alternatively or additionally collected, however, the applications of video camera data collection are readily recognized and so will be discussed.

Upon the predetermined activities being detected the data is communicated to a second location, or additional locations, for data collection. Furthermore, upon detecting the activity a response may be generated at the first location, such as sounding an alarm, flashing lights, announcing that the perpetrator has been caught on a surveillance video.

The data may be communicated in a number of ways, including various networks and/or radio frequency. The data may also be communicated either from said first location, or by said second location, to additional locations. For example, considering an alert generated via a wireless telephone network, the alert may also be communicated to the cellular phone of an individual associated with said first location (i.e. the owner of a vehicle).

By way of example—a camera system within a vehicle may capture sound and images data corresponding to activity nearby the vehicle. When traveling, data may be collected forward, rearward, sideward, of the vehicle. If an event occurs such as a crash then in response to the event (crash) the data can be communicated to dispatchers. When stationary, the data may be collected nearby the vehicle and analyzed for problems (i.e. someone attempting to break in to the vehicle) and suspicious activity. The system allows the data to be communicated and stored at a remote location without allowing any party to tamper with the data thus collected. The data may be utilized at the remote location to generate an appropriate response, such as dispatching personnel, or communicating information to other systems or personnel.

The data being sent preferably incorporates a timestamp sent with data so that a timeline of events may be constructed. Location data, such as coordinates as registered by a GPS system, may be transmitted in addition with the data to facilitate taking action on the alert.

The data upon receipt is stored in a database associated with a given party, and/or location identifiable from the data received.

Additional Aspects:

Activating one or more verification systems in response to a fire, or other emergency alert notification. The verification systems being capable of allowing a remote party (i.e. dispatcher) to ascertain the extent of the problem. The system comprises a data collection unit, a communication means, and a controller configured for being triggered by an unverified event.

By way of example, the controller of a verification system may be connected to a fire alarm. Upon the fire alarm being activated, the controller collects data from a camera or other data source, and sends it to a remote location for verification of the fire alarm. It will be appreciated that the alarm event may be verified readily by viewing the visual and acoustic information collected by the camera. The status of the event can be readily determined and the proper course of action taken without the delay of first having a party on the scene to determine the status.

Preferably, the camera continuously collects images and stores them at least for a predetermined time period. Upon an event occurring, such as the fire alarm, data associated with the time period leading up to the event may be sent in addition to the data for time periods extending from that event.

The data may be communicated to the remote location via a network connection, (wired or wireless), a radio link, a phone line, or other communication medium capable of carrying the data from the data source. It will be appreciated that the data may be first encoded, encrypted, compressed, or otherwise operated on in a predetermined manner prior to transmission to the remote location.

The alarm event may be any desired condition being monitored. It may for example be a fire alarm, burglar alarm, collision alarm, terrorist alarm, hijacking alarm, and so forth. Furthermore, the alarm may be generated from conventional sensors, or from signal processing equipment that analyzes data, such as from a camera and/or audio information from the location.

The present aspect of the invention may be described as a method of collecting and authenticating security data, comprising: (a) collecting data at a first location; (b) detecting problem or suspicious activity registered within said collected data; (c) communicating data associated with said problem or suspicious activity to a second location; (d) storing said data associated with said problem or suspicious activity; (e) preventing said data from being modified; and (f) providing secure access to said data.

Any combinations of the following may be included.

Further comprising transmitting an identifier with said data being communicated to identify said first location.

Wherein said data is encrypted to prevent unwarranted access.

Further comprising generating an alert based on said communicated data. Wherein said alert comprises the notification of a security related organization. Wherein the data or a portion thereof is communicated to the security organization. Wherein the data communicated includes additional information about the location where data collected. Wherein images of the location are transmitted along with said data to aid in finding or qualifying the location.

Wherein said data associated with said problem or suspicious activity is recorded along with a timestamp value.

Wherein said data associated with said problem or suspicious activity is transmitted along with a timestamp value.

Wherein said data associated with said problem or suspicious activity is transmitted along with location information. Wherein said location information comprises coordinates from a global positioning system.

Wherein said data comprises a data stream from a camera.

Wherein said data comprises a data stream from a acoustic transducer.

Wherein said data comprises a data stream from sensors.

The system may also be described as a method of verifying an alarm condition from a remote location, comprising: (a) registering that an alarm condition has occurred at a first location; (b) collecting data at a first location associated with said alarm condition; (c) communicating said data associated with said alarm condition to a second location; and (d) verifying if an alarm condition truly exists at said first location and providing an appropriate response.

Any combination of the following may be incorporated as taught herein.

Further comprising transmitting an identifier with said data being communicated to identify said first location.

Wherein said data is encrypted to prevent unwarranted access.

Wherein said second location is associated with a dispatcher of a security related organization.

Wherein the data communicated includes additional information about the location where data collected.

Wherein images of the location are transmitted along with said data to aid in finding or qualifying the location. Wherein said images of the location include image taken at a time sufficiently prior to the occurrence of said alarm condition to be recognizable to those familiar with the location.

Wherein a timestamp value is transmitted with said data.

Wherein said data comprises a data stream from a camera.

Wherein said data comprises a data stream from a acoustic transducer.

Wherein said data comprises a data stream from sensors.

Wherein said alarm condition comprises a fire alarm.

Wherein said alarm condition comprises a burglar alarm.

Wherein said alarm condition comprises a crash alert, hijacking alert, or terrorist alert.

Wherein said verification of said alarm is performed by an individual at said second location to which the data has been made available. Wherein said data is made available in the form of video and audio from said first location. Wherein said data is made available to an emergency dispatcher.

35.0 Displaying Musical Lyrics to Groups

Most individuals are unable to read conventional music notation, however, they often want to sing, such as in Church, Synagogue, Mosque, Lodge, and so forth while following the correct patterns of pitch and amplitude found in the music. Currently only the lyrics are generally provided to the group which contains insufficient information to allow the users to follow the patterns of the music.

The present system enhances the display of lyrics on the screen to allow the persons of the group to more readily follow the pattern of the music as well as the words displayed.

Two principle aspects of the invention exist:

(1) Document generation software that can analyze vocal music and generate a document, referred to as VocalPath Document (*.vp), wherein the pattern of the vocals are represented within the score. Alternatively, the changes may be represented using control codes for a conventional text editor, such as Wordperfect, MS Word, and so forth. This generation software is preferably provided with a document containing the conventional lyrics to simplify generating a correct output document with proper notations.

(2) Display routines for properly displaying the notation on screen. The software may be a separate program operable on a computer system, but is preferably provided as a module within presentation software, wherein the integration of the accentuated vocal text is seamless, and does not require additional work on the part of the person creating the presentation.

Additional aspects of the present invention are also described, which utilize aspects the document generation software for providing synchronization symbology to further enhance the display of the lyrics. This can be thought of as a “follow the bouncing ball” feature, however, it does not require that the choir or musicians follow the bouncing ball, rather that they set the pace which is detected by the system in synchronizing the symbology to the position. The output which signifies the current lyrical position may generate a number of forms of display to indicate position within the lyrics, a “bouncing ball” being just one form of display that is commonly thought of in this context as it was made popular by the “Sing along with Mitch” productions.

36.0 Price Quotes by Email—equoteme.com

Incorporates by reference application entitled “A System and Methods of Maintaining Consumer Privacy During Electronic Transactions” Ser. No. 10/066,495, filed Feb. 2, 2002 and provisional patent application Ser. No. 60/266,279 filed on Feb. 2, 2001.

Allow users to select items for purchase and get price quotes via email. A quoting application is opened on the user system, which contains menuing and methods of providing generic information on the wants of the consumer. They need not divulge their personal information. They select the item wanted and the criterion, such as features. On a digital camera, for example, the user may specify memory, zoom range, interface, capacity, and so forth.

The quote is requested as the application generates an email to a entity handling the quoting, referred to conveniently herein as “eQuote”. The user is known by eQuote by their email address. Preferably, their charter prevents them from selling or otherwise using the email address for solicitations.

The eQuote system then posts the items for quote on a web site, or may alternatively or additionally, send emails to get quotes, such as from preferred vendors. The quotes are returned and compiled by eQuote system, tossing out non-relating items, and preferably vendors that have been problematic. A summary is created and sent to the user periodically as requested by the user.

The user may get additional information by accessing the web site of eQuote to look at the details of the offers.

37.0 Methods of Correcting PC Clock Settings

37.1 Overview

To eliminate clock drift in computer systems, in particular in personal computer systems.

Often the clock generation hardware within a computer system is subject to significant drift due to inaccuracies in the crystal or temperature coefficients of the components. The clock timing is typically generated by a real time clock chip utilizing a crystal time base. In some cases the PC clock may gain or lose up to ten to twenty minutes a month. It is troublesome for the individual, or employee, to continually reset the clock to the proper time, however, the cost of modifying the hardware with more accurate timing components, and/or calibration of adjustable components, can add too great a cost burden to the hardware.

The present invention, therefore, provides a method of using the information provided by user setting of the clock to the correct time to reduce subsequent clock errors.

The method is preferably performed by:

Recording date, time, and adjustment amount whenever the clock time and date value is adjusted to a new time setting within the computer. (this is exclusive of time and date changes for daylight saving time, leap year, or time zone shifts which generally comprise adjustments that approach or exceed sixty minute values and are typically one or multiple hours.

Determining a periodic correction factor based on the amount of time drift per unit of time between successive adjustments. The time between successive adjustments can be calculated by subtracting the initial date and time from the subsequent date and time to arrive at a minute offset. (In many systems the date and time is retained in seconds, or minutes, and a calculation performed to convert this to an hour, minute, second, format; it will be appreciated that the time difference calculation is performed using a formula that suits the particular method of date and time encoding utilized.) The amount of adjustment is generally divided by the time between successive adjustments to arrive at a correction factor. If the correction factor is insignificant, falling below a predetermined threshold, then it is ignored.

For example, first recorded adjustment at Mar. 3, 2002 at 1:00 PM, second recorded adjustment at Mar. 13, 2002 at 1:00 PM added 4 minutes to the time. The number of minutes in the ten day period was 14400 minutes with a change of 4 minutes. The drift is then given by 4/14400. The correction factor is determined based on the period utilized between correction intervals, although percentage could be alternatively applied at any time.

Periodically applying said correction factor to said time clock. It will be appreciated that applying the correction factor at any time during the day may disrupt the user, as they may see the indicated time jump forward or backward by one or more minutes. Therefore, it is preferable that the time correction be applied whenever the computer is booted up, or at a specific time(s) each day accompanied with a message if the computer is left running for a period of time.

By way of example, if the computer system is left running the correction is preferably applied one or more times daily, such as once each midnight. For the time adjustment example above, the correction factor of 0.4 minutes (24 seconds) per day is added to the value of the real time clock value. If the time is to be applied at bootup then the time from the prior correction is first calculated to which the correction factor is then applied.

The invention is preferably implemented within the operating system of a personal computer with the time values of the adjustments, and optionally the periodic times at which the clock is corrected, within a non-volatile memory, such as within a file on disk, a non-volatile section of memory such as the battery-backed RAM within the real-time clock, or similar areas wherein the values may be retained even when power is turned off.

Additional Aspects:

Tracking adjustments in relation to periodic or system factors. The adjustment data may be saved with additional information as to the time of year the change was made, or an operating temperature reading from the computer system. In this way the correction may take additional factors into account over time to reduce the amount of corrections necessary.

The adjustments value, time and date of adjustment, along with any desired additional factors may be stored in a data base from which more accurate correction factors may be computed.

As few systems provide an actual temperature sensor, the temperature is preferably estimated from determining operating characteristics of one or more devices, or circuits, within the computer, such as current flow, voltage drops across junctions, and so forth.

The present aspect of the invention may be described as a method of correcting time clock errors on a computer system, comprising: registering a date and time at which a time clock circuit within a computer system is manually adjusted to a new time setting; registering the amount of adjustment being introduced at a subsequent date and time at which said time clock circuit within said computer is manually adjusted to a new time setting; calculating a periodic correction factor based on the amount of time drift per unit of time determined in response to the time gain or time loss represented by the adjustment over the period of time between the first and second time adjustment; and periodically updating said time clock circuit to offset said time drift.

Any combinations of the following may be incorporated.

Further comprising displaying a message to a user of said computer upon executing said periodic update, if said computer is operating. Wherein said message is displayed for a brief period of time. Wherein said brief period of time does not exceed one minute. Wherein said message may be turned off by said user. Wherein said message includes collecting either an accept and decline command from said user which determines whether correction is to be applied.

Wherein the updating of said time clock based on said periodic correction factor comprises: periodically reading the time and date value of said time clock; adding or subtracting said correction factor to or from said time and date value; and writing said time and date value back out to said time clock. Wherein said periodically reading of said time and date is performed the updating of said time

Further comprising: storing time at date at which said updating of said time clock to offset drift was last performed, wherein the updating of the time clock may be performed at irregular periods. Wherein said irregular periods comprise times at which an event occurs. Wherein said event comprises times at which the computer is booted up or a user logs on to said computer.

Further comprising: storing said correction factors; and averaging new correction factors with previously determined correction factors to increase correction accuracy.

The present aspect of the invention may also be described as a method of correcting time clock errors on a computer system, comprising: recording date, time, and adjustment amount, whenever a time clock circuit within a computer system is manually adjusted to a new time setting; determining a periodic correction factor based on the amount of time drift per unit of time between successive adjustments; and periodically applying said correction factor to said time clock.

Wherein the application of said correction factor comprises: periodically reading the time and date value of said time clock; adding or subtracting said correction factor to or from said time and date value; and writing said time and date value back out to said time clock.

Wherein said time clock comprises a real time clock circuit whose internal time and date value registers may be written by said computer.

Wherein said manual adjustment is performed by a computer user manipulating a time clock correction interface.

Wherein said manual adjustment may be performed by service personnel, users, or other parties accessing said computer.

The present aspect of the invention may also be described as a media that is computer readable and includes a computer program, routine, or segment thereof, which, when executed by a computer system configured for maintaining time and date, causes the controller to perform the steps comprising: recording date, time, and adjustment amount, whenever the maintained time and date setting is adjusted to correct for time drift; determining a periodic correction factor based on the amount of time drift per unit of time between successive adjustments; and periodically applying said correction factor to said time clock.

Wherein time adjustments made to correct for daylight savings time, or movement through time zones of said computer system, are not considered as time drift adjustments for the purpose of determining correction factors. Wherein the changes for daylight savings time are performed automatically by said computer and correction factors are not computed.

Wherein manual changes to the time which are approach, equal, or exceed an hour are not recorded as an adjustment amount. Wherein the offset from an even hour increment or decrement is determined and considered to be the manual adjustment amount from which a correction factor is determined.

38.0 Browser Enhancements

To enhance the use of browsers by modifying the software therein, a number of enhanced browser features are described.

Open closed sessions—accidental closures “undoable” when browser reopened within a given period of time. All information, including viewing position is saved, and can be restored at user command.

Marking view of the web page—such as saving ones place in a long search list. Copy file and apply marks in HTML, such as a shadow above selected position. Applying lines, or adding notes to the document. Marking different sections of the document for subsequent extraction.

Boxing out a portion of the document pages to be printed, i.e. leave off advertising graphics.

39.0 Positional Indications within Viewed Document

To provide a hierarchical position indicator in relation to a location within a given document, such as a document being edited in a word processor, spreadsheet or similar document capable of being displayed and edited on a computer.

A view of the hierarchy in the document is shown, such as on the left side of the screen in typical browser manner. In response to the cursor position being moved the relative location of the cursor is indicated within the hierarchy shown.

Currently in a document view such as in Adobe® Acrobat 5.0™ a hierarchy of bookmarks may be displayed to allow the user to select a location within the document. A thumbnail view may be shown wherein moving the cursor highlights a given thumbnail within the pages of thumbnails within the document.

The present invention allows for creation of the hierarchy in a number of different ways, including from bookmarks, placemarks, automatic determination based on headings, automatic determination based on paragraph structure, user selected regions, sections demarked within a template as belonging to these specific sections.

An index is determined to translate location to the bookmarks. When cursor is moved a long distance, the index can be checked to give a rough determination of location wherein the text (or other type of info in file) is checked to find the correct location, which is then highlighted within the hierarchy displayed.

The present aspect of the invention can be described as a media adapted with software as described herein.

40.0 Automatic Generation of Activity Metrics and Costing for Job Product Creation Application Software

40.1 Overview

To generate cost metrics from an application within which object or other content is created, such as a web authoring program, drawing program, photo editing package, video editing program, word processor, programming language development environments, or any other program whose results comprise a all or at least a portion of a billed-for service or product.

The actual costing of many services and developments currently must rely on determining the time element and charging accordingly. There are many instances, however, when this does not provide a sufficient metric for billing customers, and for determining and improving the efficiency with which the end result is created.

A “costing metric” software package which may be integrated into various software applications that create a job object or portion thereof. A “job object” being considered any output created using the commands of the given software application. The costing metric software package preferably provides a standardized set of interfaces for collecting, logging, analyzing, and reporting costing metrics based on commands within the application, that may be linked to a given software application. It should be appreciated, however, that software applications according to the present invention may be alternatively built from the ground up with the “costing metrics” built in.

In either case the software may be provided within the program data distributed with an application, (i.e. as on a computer readable media), as an add on option, or utilized in conjunction with the internet wherein the analysis, and other functions, may be performed remotely from the user application (or the entire application being an internet application with the job costing SW included).

The software includes costing metrics (CMET) built into the program wherein a cost profile can be generated based on the commands utilized within the application when a result product is created that takes many more factors into account than just time. This set of features would be useful in many instances, including:

Developer Costing Use:

(1) Aid developers in the proper pricing of work product from the software.

(2) Ease the burden of job costing based on the actual use.

Management Use:

(3) Provide a tool for improving developer productivity.

(4) Provide management/mentoring insights into how SW used to create product.

External Use:

(5) Allow for providing services with “verified value”.

The CMET routines gather information about how the workpiece has been created. The following example considers the CMET routines to be operating in conjunction with a drawing program such as Corel Draw, although it will be appreciated that the software may be implemented for use with a variety of software from which a “product object” is created.

CMET preferably comprises the following sections:

(1) CMET Tracking:

This module performs the actual tracking and collection of low level action metrics.

(2) CMET Event Log:

This module allows user control of what and how the information is stored for later use. It preferably also allows aliasing of a collection of events into a logged account of a higher level of activity.

The event log software may be configured for use with a given program wherein it flags selected combinations of activity—such as associated with inefficient ways of accomplishing a given task. For example generating a series of reference numbers pointing with arrows to portions of a drawing. If for example the user individually sets line text and line parameters for each object, the system can flag this event for study.

(3) CMET Developer Costing:

This module preferably allows the company/developer to set costing factors associated with the tracked activity so that accurate cost estimates for the given firm, or individual developer may be created. Cost sheet files may be created with different sets of costs for different jobs, individuals, and so forth, wherein estimates may be created as job dependent or user dependent entities.

(4) CMET Analyzer:

A routine for analyzing the logged actions and extracting useful information for reports and costing. A default set of templates is preferably provided while the user is allowed to create their own templates. The objects analyzed as well as the formulas associated with performing the analysis may be modified depending on the job situation, entities involved, and method for which job is to be analyzed.

(5) CMET End-User Costing:

This is an optional module that allows the system to generate protected standardized reports on the activities performed for a given job. These reports being provided to end users to assure them that they received commensurate value;

(6) CMET Reports:

This module reports the desired information collected with the tracking in a format and with priorities that may be set within the workplace.

(7) CMET Network:

This module preferably allows the information from a variety of CMET and other sources to be combined for creating a final costing.

(8) CMET Database:

This module preferably allows all or a portion of the work products to be stored in a database for use as benchmarks. The user may then use the database as a comparative means for assessing similar jobs and the relative costs therein. The data base allows information to be derived over a historical periods of time for both job costing, and any other factors which may be extracted as trends based on command execution as tracked.

(9) CMET Estimations:

This module preferably allows the user to select metrics for a given new job, wherein similar metrics are looked up in the database wherein the associated jobs are shown. The user can iteratively determine a best match for the current job based on actual job product creation. The module then uses cost factors determined for actual jobs to estimate the cost for the present job. In this way a very accurate costing is created based on jobs executed in the past.

CMET preferably is configured to track a large number of metrics that may affect costing of the job, the following are but some examples. The use of external files, photo, etc., macros, utilized within the workproduct. It tracks the time for aspects of the creation. Created elements that are later discarded. It can track the complexity of commands utilized, and the frequency of different command usage (an expect can tell what commands “should have been used” in creating a specific job product). The time spent per section of the drawings. The processor delays encountering during creating the work product (allows determining equipment needs). The relative speed of input, such as the average number of simple elements created per hour, and similar entry creation valuations.

The tracked data may be used for determining action based costing—wherein the factors associated with personnel, equipment, and technique may be isolated. The system allows companies that create job products using computer applications to improve their management, training, human resource, job cost estimations, and other functions by using data tracked about actions (commands) performed in relation to one or more applications and preferably the underlying operating system.

40.2 Example Embodiments

The following embodiments are provided by way of example.

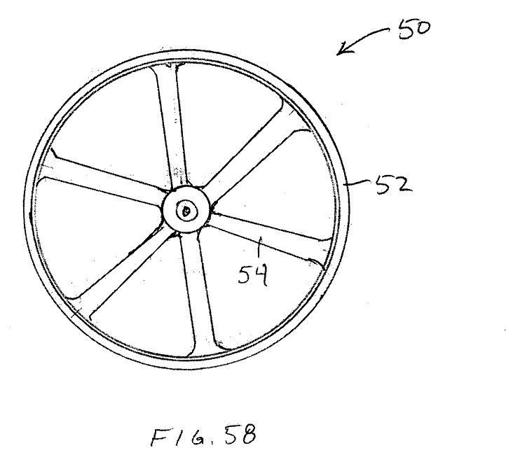

FIG. 59 depicts a general bock diagram of the “actual costing metrics software” 10 wherein a set of action are shown 12 comprising time 14, and command operations performed 16 which appear on the screen, and other operations 18 that pass through the associated application, such as finding and collecting necessary files for completing (i.e. related operating system operations, and so forth). The set of actions 12 are those that are performed by executing commands within an associated “job product” creation application.

As a user creates a job product with the application, the set of actions 12 are captured in response to command execution and stored in a log 20. The stored data then may be accessed or analyzed in either in-line or off-line operations. It is preferred that the data only be accessed off-line (while the application is not running) wherein interactions and logging of the actions associated with the logging of cost metrics are not included within the costing metrics).

The user, supervisor, job coordinator, mentor, and so forth may analyze the operations that were performed in creating the job using an analysis module 22. The cost of the job and elements therein may be determined in response to looking up associated costs within an actual costs table 24. This may be created by the company that created the job product creation application, or user, and may preferably be modified by the user in either case to suit their job types and working operation types.

A cost list 24 is shown being input to an analysis module 22 for generating a report on costs 26. Cost figures may then be determined for the given job based on the work that has been input to the job, instead of merely logging a time based figure. Although this effort based may not be seen by the customer it provides a basis for determining productivity, job estimating, development management, training programs, and so forth which can decrease job costs and increase profitability.

Reports 28 for management, time tracking, performance, training, and so forth may also be generated by analyzing the tracked information 20.

A database of actual costing data 30 may be created and utilized as a base line for estimating costs of new jobs 32. For example, the user enters upper level job criterion, such number of figures, types of figures, estimated number of elements, and additional metrics. These are translated into lower level metric that may be compared to the metrics from actual created “job products”, wherein the user can hone in on jobs which are actually similar to the one being proposed. The actual costs from the most closely matched job then provide a baseline from which cost may be estimated for the new job. In this way the costs may be very accurately estimated as they are based on the actual commands executed for actual jobs, wherein guess work is eliminated.

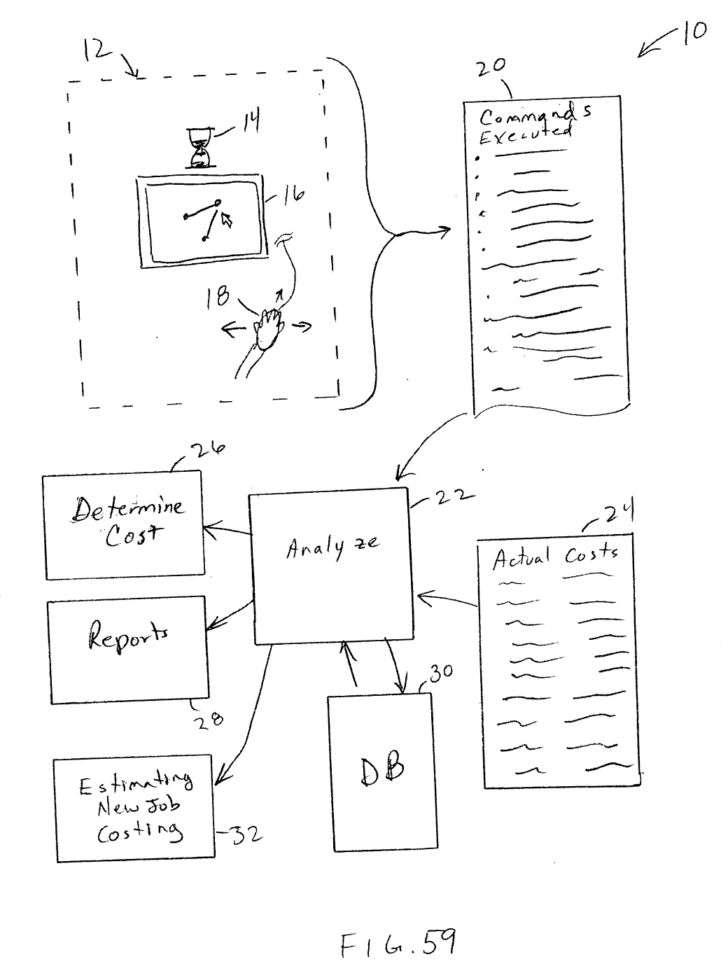

FIG. 60 and FIG. 61 exemplify flowcharts of the costing metrics software according to the present invention. The tracking of commands being executed within the application are depicted as being recorded from within the command entry interrupt service routine 100, which captures keystrokes, mouse movements and so forth. This may be performed in conjunction with any routines that are triggered in response to user actions, such as operating system calls and the like. All or a selected portion of the commands executed by the user are recorded (tracked) 102 by the system while the associated application which is creating the job product is operating. Optionally a timestamp 104 may be stored for each command. All or a portion of the commands may then be selected for later retrieval 106. The logging may include summarizing activity into higher level categories (i.e. a set of lines may be created and connected to form a polygon, the high level action may record the creation of a polygon along with or as an alternative to recording the lower level command operations). The selected elements are then logged 108. Each command continues to be logged while the program executes and the log is saved when the object is closed, save, or exited. The tracking data preferably includes information about the sessions for each job product and accumulated the associated changes.

Information such as costing and use may then be extracted from the collected tracking data. This is exemplified as an off-line operation, with only a single type of information gathering shown, specifically determining cost based on actual job actions 130. After selecting the “job object”, the user selects the conditions under which the job object is to be analyzed 132, such as the type of job, person performing the job, or other metrics that should be taken into account when analyzing the job. The costing data 134 is then pulled up and the tracked data analyzed 136 in response to the costing data. A costing report 138 is then generated based on the commands/activity executed when making the job product. The user may continue honing the report to extract the desired information, and when fully satisfied exists the program 140.

Another aspect of the invention is that it can provide the basis for a verification on the value of the services being performed. It will be appreciated that the end user is currently charged a given amount based on time, but they have no idea how productive the time has been spent. The present system can be utilized to provide a “measuring stick” by which the relative value of a job product may be assessed. This may implemented in a number of different ways.

A report may be generated by company creating the work product using the present system. The report is submitted to the purchaser so that it details the actions performed in creating the job. This can go a long way toward allowing the customer to understand the costs involved in creating the work product.

An unalterable file may be created by the present system (to assure that corporate tampering has not occurred), and delivered to the customer wherein the activity details, optionally including all time spent, are detailed. Although a copy of the data may be made for the in-house manipulation desired to summarize or extract other management information. The cost metrics, or action metrics file is then given to the user, wherein they may run their own analysis.

The present invention may be implemented to generate incremental activity reports on a given job project for a specific client. It is preferable that the activity reports be encrypted and sent as email object, although any desired form of communication may be utilized. In this way, the client is continually information about what is being done, or not done, on their work product while they gain confidence that they are not being taken advantage of.

The present aspect of the invention may be described as a system for tracking and analyzing the commands performed within a given job product creation application, comprising: means for determining and storing user activity when operating said application in association with a given job product; cost data records; and means for analyzing said stored user activity information based on said cost data records to generate cost reports.

The present aspect of the invention may be described as a system for tracking and analyzing the commands performed within a given job product creation application, comprising: means for determining user activity when operating said application in association with a given job product; means for summarizing user activity into high level actions; means for logging a fixed, or user selected, level of activity into computer memory or a file; and means for generating reports on activity associated with a given job product.

The present aspect of the invention may also be described as a system for tracking and analyzing the commands performed within a given job product creation application, comprising: means for determining and storing user activity when operating said application in association with a given job product; means for storing a collection of said activity records associated with job products; means for collecting information on estimating actions required for a job product whose cost is to be estimated; means for querying the database for selecting a closest action based match for the new job; means for modifying the set of actions for said selected match to accommodate the new job product; cost data records; and means for generating an estimated cost report based on activities required for performing the new job product.

41.0 Optically Sensing Deflections Along a Path

Included by reference application “Fiber-optic Guitar Strings” Ser. No. 60/394,160 filed Jul. 1, 2002, and “OFXD Drive (Optical Fixed Head Drive)” Ser. No. 60/394,160 filed Jul. 1, 2002. Included by reference article: Bell Labs: Jan. 22, 2001 “Novel Fiber Converts Single Color Into a Rainbow”.

41.1 Overview

Provides for sensing deflections of an elongated member, a path along a plane, or a path in space (such as coupled to a 3D shape). Traditionally one has had to rely on using sensors distributed across the surface, but the present invention allows sensing multiple perturbation events along a fiber and can discern the perturbations in relation to angular positioning along the fiber span.

Use a color changing, such as an Air-silica microstructure optical fiber, with a pickup fiber, or cladding. Current air-silica fibers exhibit the effect for short pulses, on the order of 100 femtoseconds, at powers of a few kilowatts peak. Deflection causes energy to be coupled to the second fiber, or housing around the color changing fiber. The deflection along the length of the fiber occurs at different frequencies, therefore the perturbations along the fiber may be sensed on a per frequency basis. This may be utilized in a large variety of applications.

It will be appreciated that perturbations along a fiber may be sensed by registering the relative light loss on the span of fiber.

Furthermore, it will be appreciated that the distance along a fiber can be determined of a single event or perturbation using reflection techniques. However, if perturbations, such as vibration or bending moments occur at multiple locations along the fiber, they can not be sensed using these techniques.

The present technique couples the energy lost at a given location along a span of frequency-shifting fiber, location being determined as a function of wavelength, to a detector for registering perturbations as a function of wavelength. It will be understood that registering only the optical loss at the far end would again only be capable of providing cumulative perturbation information and would not be able to register information about multiple perturbations along the given span. The light from each wavelength must be coupled to one ore more detectors, preferably at either end of the fiber span, for registering the relative optical energy and changes thereof as a function of wavelength.

Optical sensing arrangement, perturbations along length:

The system may be created according to a number of implementations.

(1) Single fiber—a single fiber having a color shifting core surrounded by a non-color shifting transparent cladding allows the increased optical energy loss as a result of flexure to be picked up along the out fiber and transmitted to a detector for processing. This is the preferred design with the detector located at the far end of the fiber or coupled back through another fiber to the point of origin. Alternatively the inner and outer roles may be reversed.

(2) Dual fiber—a color shifting fiber coupled to a second fiber used for detection. The color shift is known in the second fiber, and preferably is not color shifting wherein the output along the color shifting fiber in response to perturbations is coupled to the second fiber toward a detector.

(3) Multiple fibers—a plurality of fibers may be retained proximal to one another wherein losses from the wavelength shifted fibers is coupled to the other fibers toward one or more detectors.

Optical sensing arrangement, axial direction detection:

In some situations it may be preferable to detect not only that a perturbation has occurred a given distance along the length of the fiber, but to determine which direction the perturbation or angular movement has occurred. For example, in a sensor on an elongated rod configured for flexure in both an X and Y direction, it may be desired to determine which direction it is bending and the perturbations along each axis of motion.

In this instance a fibers are created whose sensitivity to bending moments is accentuated in one axis. For example in the instance of a wavelength shifting core surrounded by a optical transmission “cladding”; a additional layer of cladding, (or an interface layer) may be included that includes a reflective material around a large portion of the fiber allowing the light escaping in response to a bend to reach the detection fiber only along specific angular portions of the fiber, for instance a ten degrees arc in a first direction and an opposing direction. In this way the deflection information may be registered for each axis.

It will be appreciated that two fibers or a single fiber may be utilized in the two axis which span different wavelength ranges, so that a single detector may be utilized for detecting the perturbations along each axis.

It should be appreciated that detectors may be placed at one or both ends of the detection fiber (or detection portion of a single fiber), depending on the direction that the optical energy is coupled into the detection fiber in response to the bending moments which are experienced.

It should also be appreciated that the color shifting fiber may be folded back on itself, forming a loop, wherein every location along the path is represented by two wavelengths, which increases the ability of the system to discern information. Also it can simplify routing in many cases, since the source and detector can be co-located.

Application Examples.

By way of example, and not of limitation an example of a guitar string having an embedded fiber are described. The response of the fiber can determine the fingering along the fiber in addition to the pitch and amplitude as the guitar is played. The LED and detector are preferably connected on the same side of the string, wherein the other end need not be terminated at a detector.

In addition, an application is described for sensing vibrations along the a path on the wing of a jet aircraft.

In addition, the application is described for use with a MEMs based fixed head disk drive. The wavelength shifting optical fiber allowing multiple tracks to be simultaneously read (so long as the locations are spaced apart enough to provide sufficient detector selectivity with regards to wavelength.) Multiple tracks may be accessed (read and optionally written) simultaneously to dramatically increase throughput for the device.

Furthermore, the invention is described for use on a data glove device, wherein fibers are attached within the glove for sensing the amount and location of perturbations along the span of each fiber.

Simplifies Sensing of Position.

Although the distance along a fiber of a perturbation, or bending moment, can be sensed using techniques that utilize a coded transmission and a detector configured to discern the temporal shift of the reflected signal from the perturbation, these techniques require highly precise time differentiating, in particular along short lengths of fiber as the distance resolution is provided by being able to sense the difference in time of the light travel through the fiber.

The present invention, using frequency shifting cable, allows a simpler encoding of a single event to be determined. For example, the techniques described above may be utilized with a scanning detector, which detects the wavelength of the returned light to detect the position, it is then not necessary to provide extreme precision in determining the temporal shift between a generated signal and its detected reflection.

The technique may be utilized for creating a simple position encoder, wherein a moving element is coupled to the fiber so as to induce a bending moment in relation to its location. Wherein the motion of the moving element can be registered based on the location of the perturbation as sensed by the wavelength of optical energy being detected.

The present aspect of the invention may be described as a method of detecting multiple perturbations along the length a straight or curving path, comprising: generating a spectrally shifting optical electromagnetic signal along a fiber; coupling optical energy at the spectrally shifted frequency to an optical detector configured for registering the optical energy; extracting the modulation information on a per wavelength basis; and determining the location of modulation in relation to the frequency shifting along said fiber.

42.0 Vibration and/or Acceleration Sensing Tag

Included by reference eInk invention aspects within RAST070102, Ser. No. 60/394,160 filed Jul. 1, 2002 and application entitled “A System and Methods of Maintaining Consumer Privacy During Electronic Transactions” Ser. No. 10/066,495 filed Feb. 2, 2002, and the provisional application entitled “Display Systems and Methods Utilizing Electronic Ink” Ser. No. 60/267,115 filed on Feb. 7, 2001.

42.1 Overview

An inexpensive non-volatile tag for sensing vibration and/or accelerations. A piezo-electric strip configured in a beam provides a voltage output in response to vibration or accelerations in a given axis. The output of the piezo-electric strip is coupled to an electrode of an electronic ink display, whose other (common) electrode is connected to the opposing side of the piezo-electric material. It will be the piezo electric material may be structured as any desired number of piezo-segments in series or parallel to provide the desired drive profile.

A circuit may be incorporated for selecting areas of the eInk display to be written. This may be electronic, mechanical, or electromechanical. For example a switching circuit, an electrode moving with the piezo electric member, a switch activated by the motion of the piezo-electric material.

A charge retention circuit may be incorporated, such as a capacitor, that is charged in response to the motion of the piezo-electric strip. The power being available for activating portions of the eInk display, such as in response to crossing a threshold. A circuit may be fabricated conventionally, or preferably using polymeric circuit fabrication which may be incorporated within the label material that contains the electronic ink. For example, a capacitor may charge in response to vibrations until the voltage on the capacitor reaches a threshold such as set by comparator, or the switch over characteristics of a transistor or FET, or similar. The circuit then applies the voltage of the capacitor across the electrodes of the electronic ink, to display the detected condition.

The output from the piezo-electric transducer, being a transient event, may alternatively, or additionally, be coupled through a transformer circuit to up the voltage to the desired operating voltage of the electronic ink display.

42.2 Description of Example Embodiments

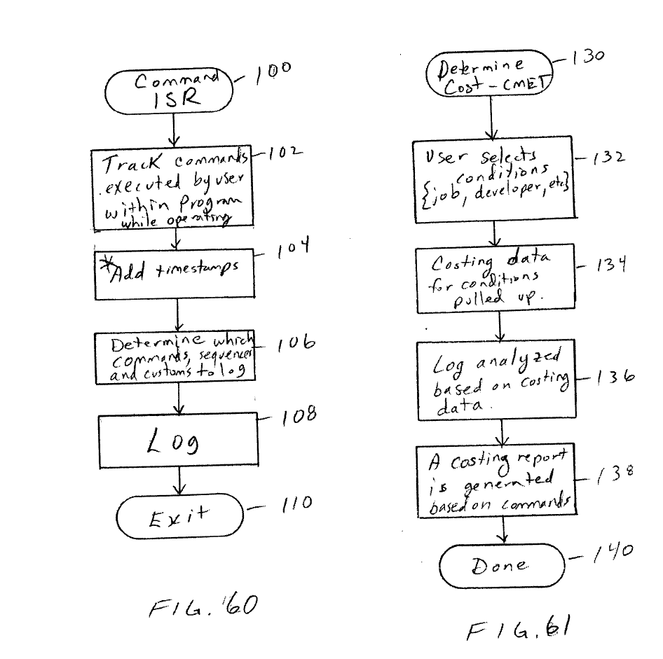

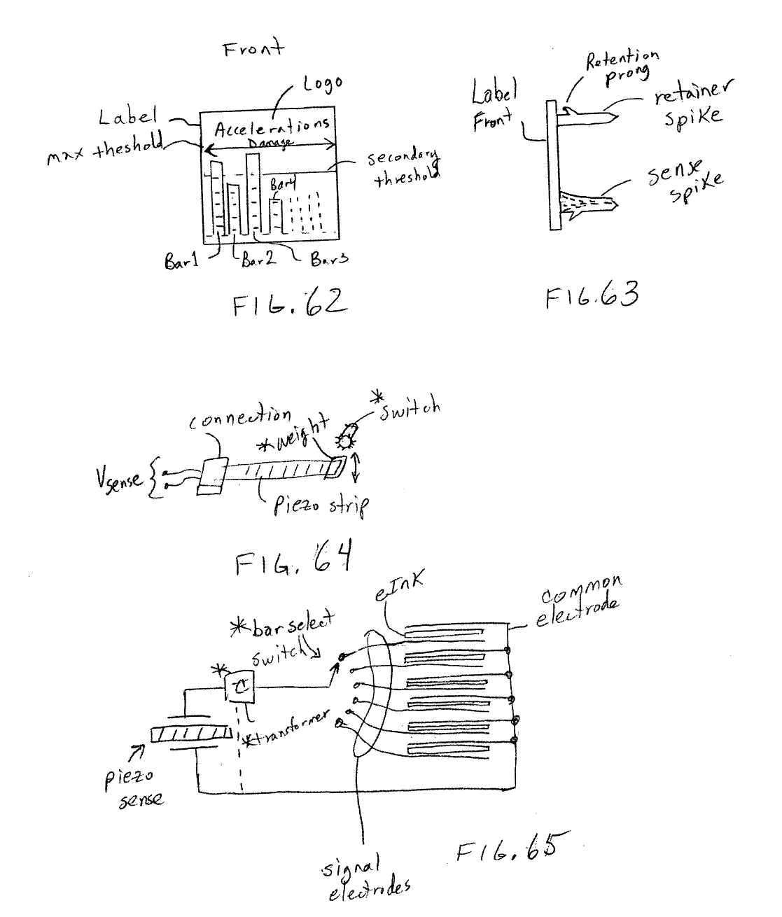

FIG. 62 shows a label facing which depicts a bar graph of high accelerations loads to which the device has been subjected. The bars are depicted as segments wherein the maximum load per occurrence may be read off. Four bars are displayed, although this tag is capable of showing up to six acceleration events which exceed the display threshold. It will be appreciated that any number of separate events may be registered as desired, while a single acceleration profile is the easiest case to implement as no non-volatile switching element is necessary for selecting the bar to be output.

FIG. 63 depicts a side view of the device having a display portion with twin retention prongs. The larger of the prongs being a sense spike which contains a section of piezo electric material capable of moving in response to acceleration for generating a voltage output responsive to the extent of deflection.

FIG. 64 depicts a piezo strip with a weight at the tip to increase the deflection of the strip. A voltage (Vₛₑₙₛₑ) is generated as the piezo-electric material is deflected. An optional selector switch is shown in the present embodiment wherein the deflection of the piezo-electric material can trigger the switch to move to a next position wherein the output of the piezo for a following event may be registered. It will be appreciated that any convenient switching mechanism may be utilized within the present invention for selecting elements to be written, such as mechanical switching, electromechanical switching, and electronic switching.

FIG. 65 depicts an circuit for FIG. 62 wherein the bars are fabricated from voltage sensitive sections of eInk, which are described in the included by reference applications, such as altering the spacing of the electrode from the eInk material. The output from the piezo material, or combination of piezo materials (series and/or parallel connection) is shown passing through an optional circuit, such as a voltage translation transformer, although active circuits may be utilized. The power output is routed through the switching circuit to one of the bars on the eInk display.

FIG. 66 illustrates an embodiment wherein the tip of the piezo electric material is configured as one of the electrodes for the eInk display, wherein the motion of the material generates a voltage that activates the portion of the electronic ink display to which the piezo tip has been deflected. It will be appreciated that multiple sense axis may be configured in this manner, wherein the output can be seen as a graph about a center of the deflections of the piezo, which of course correspond to the accelerations to which the device (and article to which it is attached) is subjected.

It should be appreciated, that the units may be reused by resetting the eInk back to an initial state (On or Off), such as by providing a secondary reset electrode wherein a resetting voltage is applied between it and the common electrode to reset the state of the eInk.

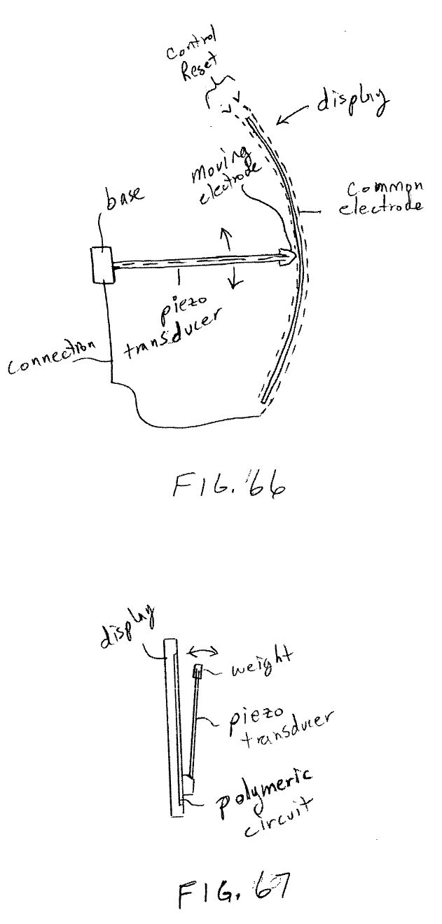

FIG. 67 depicts another embodiment wherein the piezo material is retained parallel to the plane of the label, or at a slight angle, such as on the back on the eInk label. The deflection of the deflected and generates a signal which charges a capacitor, wherein the voltage is applied to activate sections of the electronic ink display. The voltage applied to the capacitor or directly from the piezo may be applied to the display through the base of the piezo, or alternatively at the preferably weighted tip as it contacts the back of the display which may provide a thresholding mechanism for the display.

It will be appreciated that piezo material may be coupled through various forms of circuits prior to driving the eInk display, such as selectors, counters, comparator circuits, voltage conversion circuits, and so forth.

The resultant devices may be flush mounted, such as FIG. 62, FIG. 63, to an article, such as a package, or they may be configured within a small housing for attachment to an article, such as the interior of a package.

Furthermore, the displayed acceleration or vibration information may be additionally stored within a circuit within the unit which may be read electronically.

Additional Aspects of Invention:

A switch contact integrated across the exterior of the display unit, such as in an interior mounted device, wherein as the package is opened the switch contacts are broken thus preventing the unit from registering subsequent accelerations, vibrations.

A trace for the common electrode, or other trace necessary for writing the display, which is routed in a specified location on the tag, wherein a device may be pressed into that location to break the trace and prevent further activation of the display unit. For example, when a package is delivered the delivery person inserts a device that breaks the contact and simultaneously marks the package with a delivery date and time. The delivery date and time may be easily coded on the display itself by energizing electrodes which are retained against the surface of the tag while the inserted probe makes contact with the trace (although it breaks its through continuity). Alternatively, the package may be marked using conventional methods.

43.0 Motion Platform System and Method

To provide a method and system for moving elements resting upon a surface to selected positions on that surface.

Electromagnets are coupled to the rear of a piezo-electric audio transducer. Elements, such as figurines and so forth, having magnets within their bases are may then be moved over the surface by modulating the activity of the electromagnets in combination with activations of the transducer which vibrate the elements so that their static friction with the surface is reduced wherein they are more readily moved by the electromagnets.

It is preferred that the audio transducer is utilized for generating sounds associated with the given application while it also provides the vibratory friction reduction.

The elements resting on the piezo-electric device preferably have a base containing a permanent magnet over which a low friction material is placed, such as a thin layer of high molecular weight polyethylene (HMWPE).

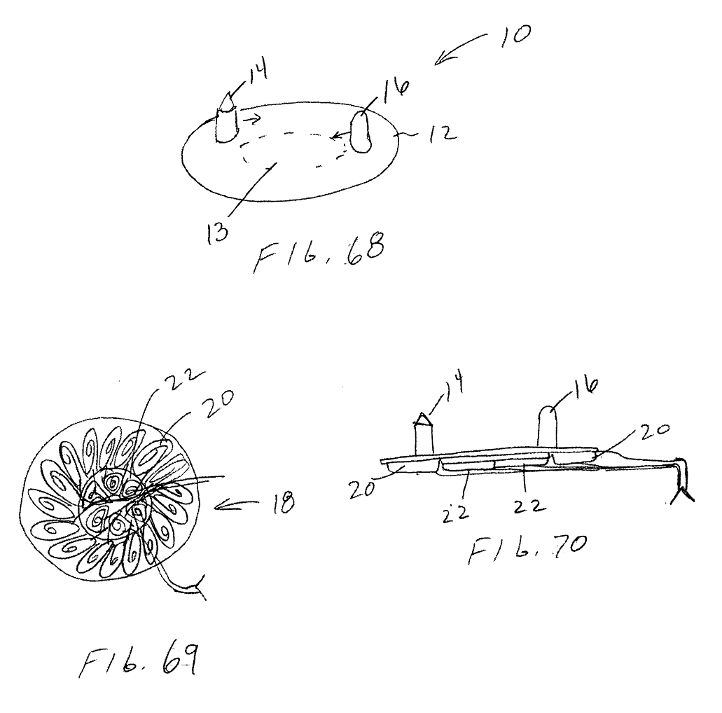

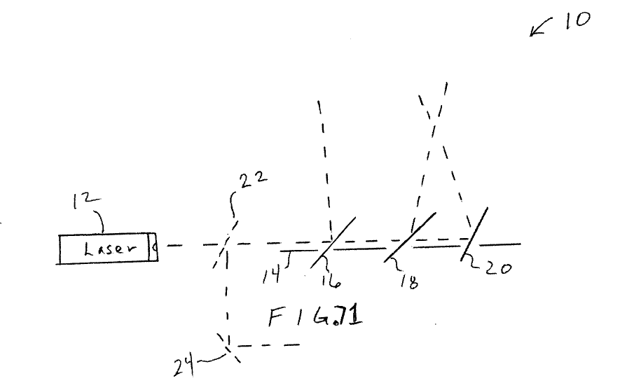

FIG. 68-FIG. 70 depict a motion platform 10 shown as a piezo-electric material surface 12, with opposing electrode on the backside between which the piezo-electric crystal material is sandwiched. Two elements 14, 16 are shown moving over the piezo-electric material. FIG. 69 depicts the underside 18 of the transducer 12 with a set of outer magnetic coils 20 and a set of inner magnetic coils 22. It will be appreciated that using multiple rings of elements allows the magnetic elements to be moved in opposing directions as they may traverse into different tracks which may be driven to induce motion in a different direction. FIG. 70 depicts a side view wherein the coils are shown attached to the underside.

The coil drivers may be additionally configured for sensing the amount of inductance of the coil, wherein the position of elements on the surface of the piezo-electric material may be determined. In this way the elements may be specifically positioned by the selective activations of the coils, as opposed to moving magnetic waves over the surface to induce movement for any element within that region. The use of permanent magnets with differentiable characteristics, such strength, allows the determination of which specific element is at a given position.

It will be appreciated that the piezo-electric transducer and the electromagnets may be controlled by a single controller that is preferably adapted with drive circuits for the transducer and the electromagnets. The actions of the controller depend on the application for which this technology is utilized. Similar circuits utilized for controlling linear motors may be utilized herein for controlling the electromagnets, while conventional audio driver circuits may be utilized for controlling the output of the piezo-electric transducer.

Although the invention may be practiced in many diverse applications, it appears particularly well suited for toys, games, and industrial control applications.

The present aspect of the invention may be described as an apparatus for inducing motion on an element surface, comprising: a piezo-electric transducer; a plurality of electromagnets coupled to a first side of said piezo-electric material; and means for controlling the vibration of said piezo-electric transducer while selectively activating said electromagnets for inducing motion of magnetic elements being retained on a second side of said apparatus.

44.0 Splitting and Directing Multiple Laser Beams within a MEMS Device

To provide multiple beam output from a single laser source.

Mirrors which may be interposed along the path of an optical beam (i.e. any desired reflectable spectrum from infrared, visible, to ultraviolet) from a laser source to split and direct separate beams to desired locations.

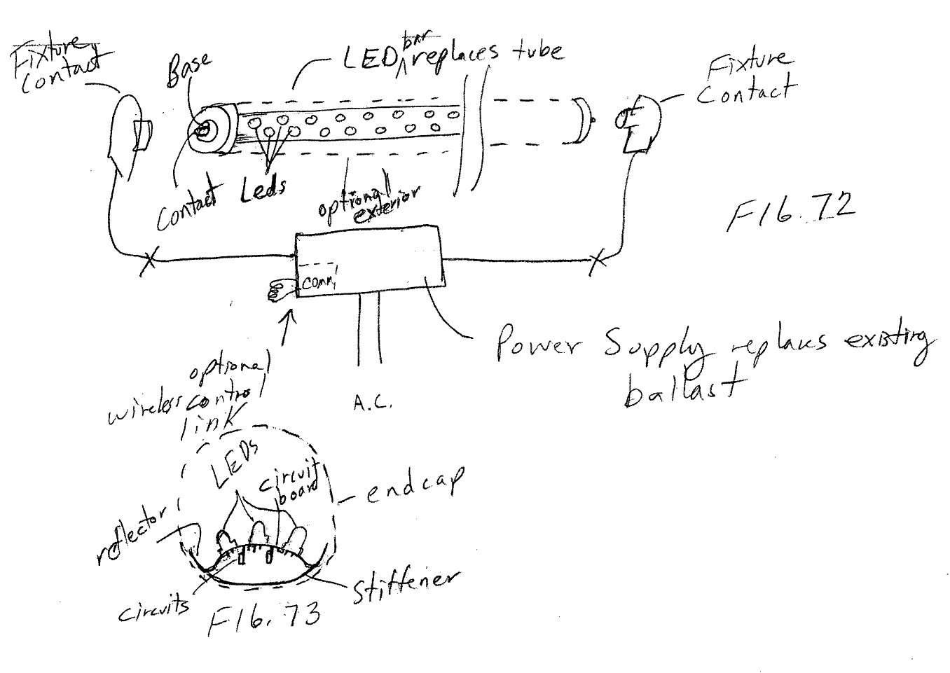

FIG. 71 illustrates a schematic view 10 of the method, wherein a laser 12 is positioned in relation to a MEMs device 14 having multiple reflectors 16, 18, 20, such as mirrors, which are each configured for being angular positioned along at least axis of rotation. The mirrors are adapted for being only partially reflective, wherein a portion of the optical energy impinging on the surface of the mirror passes through the mirror to the following mirror and so forth. For example, with the three mirrors shown the three output beams may be set to a substantially equivalent output by silvering the first mirror to about 33%, the second to 50%, and the third to 100%. In this way each mirror direct a beam containing about one third of the total optical energy leaving the laser.

It will be appreciated that the laser may be integrated within the MEMs device having the mirrors, to reduce cost and alignment considerations. The device is particular well suited for use in alarm systems, ornamental displays, multi-beam scanning systems, text displays, and so forth.

By way of example, if each of the mirrors have two axis of motion, then each may be utilized for “writing” a single character beam toward a distant surface, screen or whatever. Since a constant beam is shown in the example, each mirror follows a pattern to display a character or graphic. The speed of the scan determines the amount of light that the viewer sees corresponding to any display location, for example in displaying the lowercase letter “i” the beam can write the vertical bar slowly, then jump quickly up and stop or oscillate in a circle slowly to dot the “i” and then repeat the motion in the opposing direction.

A display may also be created by using a series of fully silvered mirrors that are generally retained out of the way of the laser beam, and only moved into position when selected. The mirrors may be positioned as shown in FIG. 1, or any desired configuration. The portions of the display output, such as characters, are then written separately, for example the first mirror is tilted up to write the first character, then it is lowered and the second mirror tilted and moved to write the second character, and so forth. In this way intermediate reflections and aberrations are prevented from disrupting the beams toward the remote end of the MEMs device.

The beam may be further divided for directing the light to additional rows of mirrors, as depicted with optional half silvered mirrored 22 and full silvered mirror 24, which is positioned to direct light to a second bank of mirrors.

45.0 LED Lighting for Tubular Fluorescent Fixtures

45.1 Overview

To allow the use of LED lighting within existing tubular fluorescent fixtures.

A housing is created having connectors and a shape that is compatible with conventional tubular fluorescent lighting, such as that use single or bi-pin bases that are most traditionally used in 4′ and 8′ lengths. The housing contains a strip of LEDs lamps directed in a predetermined pattern (from unidirectional to multidirectional). The LEDs are preferably white light sources, although a combination of other colors may be utilized, or phosphor color changing elements used, such as ultraviolet lighting.

The replacement light need not be tubular and need not have the traditional exterior of glass of conventional fluorescent tubes, however, the replacement light must be sufficiently rigid to support itself without excessive drooping, in particular if 8′ length is used. The housing may therefore be provided using a plastic tubular housing on the ends which the bases are threaded. The tube may be provided with ventilation if desired. Alternatively the rear of the device may be adapted as a heat sink for conveying heat from the drivers or LEDs to the outside. FIG. 2 illustrates a example of a curved element that can act as a printed circuit for mounting the LEDs and any control electronics desired. A stiffener is coupled to the curved element, which also provides a reflector at the edges. The endcap is shown in outline, and an optional transparent shield may to attached to the stiffener to protect the LEDs from dust accumulation and so forth.

A power supply for converting the AC power for driving the tubular fixtures is configured in a shape that is compatible with the previous ballast design, wherein the ballast is replaced with the power supply prior to installing the new LED lights.

The LEDs may be connected in any desired configuration, such as series, parallel, or combinations thereof. Furthermore, the control of current through the LEDs may be controlled within the LED strip itself, within the external power supply, or a combination thereof, such as wherein a fixed voltage is provided, current from which is then supplied with separate regulators to the diodes. The external power supply may be configured to supply a fixed current wherein the LEDs are arranged in series, or parallel connected sections of series LEDs, depending on the voltage provided.

It is preferable that the drive of the replacement elements be standardized to a fixed drive configuration, wherein tubular LED lights need not be matched to particular replacement power supplies.

45.2 Description of Example Embodiments

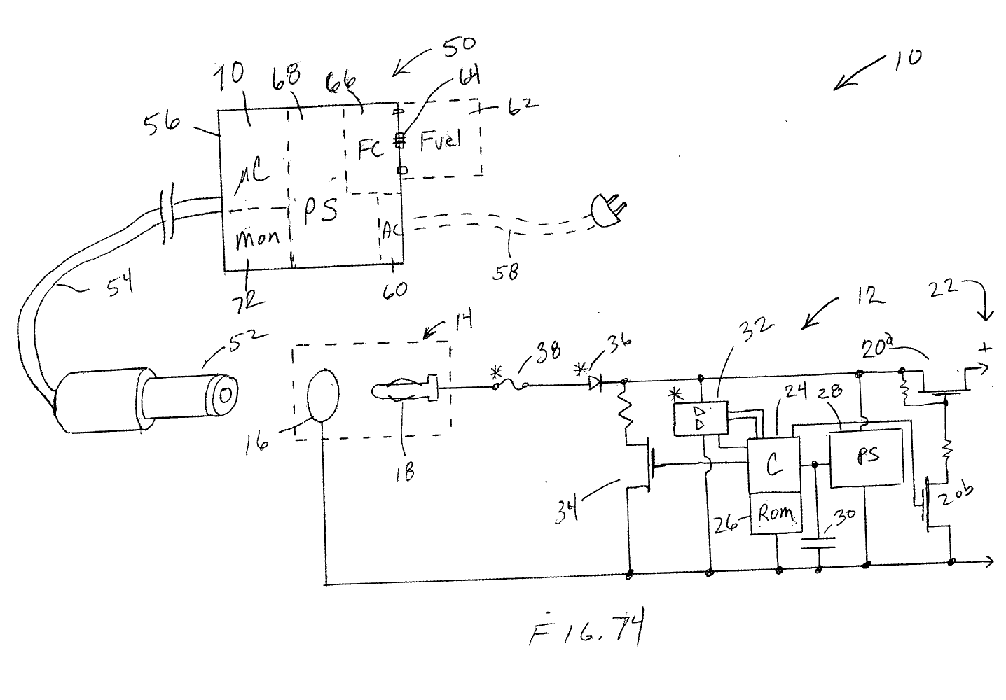

FIG. 72 depicts a single pin base LED tube and power supply for replacing conventional fluorescent lights and ballasts. Power is supplied from the power supply through the opposing fixture contacts. It will be appreciated that a bi-pin base will be capable of routing a separate power and ground to each end, which can provide additional benefits. For example, less power drop, ability to control which side of the fixture is lit, or otherwise to provide control signals to the light fixture. FIG. 73 is a cross-section view showing LED mounted on a circuit carrier/stiffener and a integral reflector.

Unlike fluorescent lighting, an LED lighting fixture may be readily adjusted as to intensity and furthermore special effects can be provided, such as dithering various lights (when not at maximum power) to provide “outdoorsy” effect, such as being under a tree. Other effects may be produced such as having selected portions of the fixture activated.

Conventional controls for fluorescent lighting comprise ON/OFF switches and in rare cases an additional temporary position for starting the fluorescent light. The ON/OFF switch can be used as is, or replaced such as with a conventional dimmer switch. It will be appreciated that the power supply can sense the lower voltage, or more typically the phase clipping (TRIAC style regulation), wherein the intensity of the light is modulated accordingly.

It is preferred that if intensity is to be set to intermediate values (i.e. between off and full intensity), then a reduced number of lights are activated to achieve better efficiency, or the lights be controlled in a PWM manner at a sufficient frequency so as not be apparent.

It will be appreciated that efficient light output from the LED only occurs toward the higher current settings for the LED. Therefore, reducing light intensity is best performed by dropping the number of active elements if current would otherwise stray outside of that required for efficiency. Furthermore, to increase longevity, a round robin, or other technique be used so that each LED sees equivalent duty despite the desired intensity setting.

One method of providing intensity control, provided herein by way of example, is to provide a power control circuit within the light that regulates which LEDs are active. For instance, consider the use of 4 separate series connected sets of LEDs that span the length of the lighting fixture, each series connected to a driver. A signal received by the light from the power supply, such as superimposed on the power signal, is registered by a controller circuit that turns on all string in full or vacillates between different strings for lower intensities. In this way the PWM speed need not be that fast since the strings are controlled separately. The speed of the LEDs lamps is such that they may be driven in a PWM mode, wherein the user won't even be cognizant of any flickering. Driving all the lights in a PWM mode from the power supply may be performed as well.

Special effects may be created using these lights, that were not available with conventional lighting. However, controlling the lights in a fixture configured for an ON/OFF switch must be overcome. The use of a dimmer has already been described, while additional forms of controls may be implemented. It will be appreciated that in a new installation a series of wires could be connected to the light fixture for selecting the different operating characteristics, however, in existing and conventional installations only a single pair of power wires is routed to the light fixture. Therefore, signals for controlling additional features is preferably superimposed on the power routed to the light. For example, the light switch maybe replaced with a switch device having additional control inputs that generate different AC signal components that can be registered by the power supply to set the mode of lighting. A few of the lighting features which are preferably provided include:

Partial use—only a linear portion of the unit is light, (i.e. one half)
this is particularly easy for a bi-pin base wherein the power supply can supply power to each side separately, such as in response to toggling a conventional power switch multiple times (e.g. “On”=select all; “On/Off/On”=select a first half; “On/Off/On/Off/On”=select a second half).
   Outdoors—light flickering.
   Starlight—twinkling of selected LEDs.
   Patterns—moving patterns
time—the LEDs can be set a pattern such displaying time or other info scrolling display—bulletin board messages or emergency information

It will be appreciated that the patterned features described above require that some level of control be provided within the LED tube or the LEDs themselves. Such a control system is described in detail within the patent application entitled “A system and method of driving an array of optical elements” Ser. No. 09/924,973 filed Aug. 7, 2001, which is included herein by reference.

To provide messaging on the LED tubes the power supplies to the lights may be connected, such as a daisy-chained two wire communication channel, to a controller having a network interface, wherein messages may be generated over a network for distribution to a number of lighting fixtures. Although application appears limited, the display could provide scrolling messages, scrolling arrows showing exit directions, emergency information and other information of such importance to alter the lighting for everyone.

Another method of easily controlling the light fixture is with a separate port, that may be wired to the power supply or connected in a wireless mode. The power supply is shown with a communication port, shown herein as a wireless communications port comprising an antenna, or inductive loop. This communication port can allows the lighting fixture to be controlled in a variety of ways. A wireless communication port can be controlled by electromagnetic signals, such as RF, or voltages coupled to an inductive loop (i.e. RFID devices), optical signals, voice, and so forth.

It will be appreciated that a plurality of high efficiency incandescent light sources may be utilized instead of the LED elements described. It should be appreciated that new incandescent lights utilizing MEMs micro machining can provide an order of magnitude efficiency increase over existing incandescent lighting, and can thereby provide greater efficiency than either fluorescent lights or LED lights.

Aspects of Invention:

Voltage protection—each LED tube is preferably protected from high voltage, such as would occur if the LED strip is installed in a fixture that still has a conventional ballast. One simple way of providing this protection is with a fast acting fuse wherein, the fuse will be readily activated to triggered to prevent damage to the LED strip. The LED circuit can be otherwise protected, such as providing voltage regulation within the housing of the LED strip. Unlike a fluorescent tube the unit need not be sealed wherein an end cap can be unscrewed to access a fuse or for removing the LED strip for replacing one or more of the LEDs.

Activation sensitive—the device can be configured with a detector wherein the light fixture can activate when an individual moves within the range of the fixture, such as a infrared sensor coupled to a switch and timer. The light in this case can be set to automatically shut off and to activate when persons are present. This feature can reduce lighting costs, while maintaining building safety. It will be appreciated that a number of sensor varieties are available which may be utilized herein without departing from the present invention.

Cooling devices—It will be appreciated that “in general” the LED strips should operate at greater efficiency than even the fluorescents they replace. However, in some situations the need for cooling devices may be warranted, in particular if high output or special effects is desired. The LED tube may be configured with cooling devices, such as if the LEDs are to operate at very high power levels, or operate at a low efficiency. For example, an electronic cooling device or a fan may be utilized. As active, semiconductor, cooling devices are expensive it would be preferably that if heat sinking were not sufficient, then small fans could be integrated within the units. The fan could be used to normalize temperatures within the tube to eliminate hotspots or to bring in cooler outer air to cool the interior of the tube. If exterior air is brought in, then it is preferably that the air be passed through a filter prior to be forced over the circuits, and or LEDs, before being exhausted. It will be appreciated the intake and exhaust may be configured at the ends of the unit though slots.

The present aspect of the invention can be described as a lighting tube device as described herein. The lighting tube containing a power supply as described. The aspect of the invention may also be described as a system of lighting as described herein, or as a method of replacing tubular fluorescent lights with LED light bars as described herein.

46.0 Method of Communication Power Needs with Universal Adapters

6.1 Overview

To facilitate the use of universal power and charging adapters with electric and electronic equipment. A signaling interface is provided at the power input of a electric or electronic device, such as laptop computers, phones, PDAs, lights, stereo equipment, and any other device that is adapted for being powered or charged from an external source. The power requirements of the device are then communicated to an adapter, such as a universal adapter.

A universal adapter is a device according to this invention which configures its power output according to the needs of the device, as communication during connection. It will be appreciated that various power supply configurations may be adapted to provide a selected output, in particular switching power supplies that are easily able to efficiently supply power spanning a wide range of voltages.

A external power control (EPC) circuit is incorporated within the electric and/or electronic device where the power connection is made to an external power source or charger. Conventionally, these are two wire connections within a power jack. Connected to the power input is a circuit, preferably a single integrated circuit that communicates power requirements (type {DC, Rectified AC, AC}, voltage, typical current, maximum current, allowable ripple, etc.) to a remote power source while retaining the device isolated from the power input. The remote power device then communicates back to the circuit a response indicating whether it can supply the given needs. If the response is negative, then it is preferable that the external power device annunciate a warning to the user that the units are not compatible.

Otherwise, if the external power unit communicates an “affirmative” response, then it generates the correct voltage to the devices and generates a “commence” signal to the power unit when the correct power is established. The affirmation message and/or the confirmation preferably include information on the power to be supplied, this is preferably a restatement of the information received from the EPC circuit, so that improper communications may be eliminated (if the originally sent information on the needs of the device were incorrectly received, then this provides another chance for correction before power is applied). The EPC circuit upon registering the “commence” signal may optionally verify that correct power conditions have been established, or trust the message (preferably depending on the cost of the connected device being powered and the possible problems that would occur is incorrect power were received), wherein it proceeds to connect the device to the power being received from the external device.

It is preferred that universal adapters made to operate with the EPC circuits within devices being powered be configured to generate a low voltage limited current power onto which signaling is superimposed for signaling to the EPC. If the universal adapter has thus been connected to a device that does not have an EPC circuit, then the universal adapter will be unable to communicate with the EPC and will thus not energize its output to the device which in fact could be harmful if set to the wrong power.

The communication may take a number of forms, for example the EPC circuit may modulate the amount of load placed across the input to communicate bits of information to the universal unit. The universal adapter unit after sending an initial query to the EPC circuit can then measure line fluctuations to determine if bits of information are being returned by the EPC. Preferably a portion of the communication between the universal adapter and the EPC comprises known codes of sufficient length such that transient conditions and so forth could never be mistaken for the codes. Furthermore, the EPC can return a response that is based on a code sent from the EPC, wherein this indicates the EPC is operational.

Alternatively, the universal adapter may generate a voltage with an embedded code upon detecting a connection being established, current flow; and then temporarily enter a hi impedance output mode while monitoring for a response from the EPC circuit. The EPC circuit can generate voltage signals on the output connection to the universal adapter which communicate correct operation and parameters of operation.

46.2 Description of Example Embodiments

FIG. 74 depicts the connecting of a Universal Adapter according to the present invention with a device containing a EPC circuit according to the present invention. A power connection 14, receptacle, herein shown comprising a conventional ring 16 (ground) and post 18 (positive). A means for controlling power application 20a, 20b the circuits of the device from output 22 is represented as insulated gate FETs (preferably MOSFETS, VFETs, or other low impedance power switches), it will be appreciated that the switching elements herein are all represented symbolically as FETs, although a variety of FET, Bipolar, and other forms of linear and digital power control may be alternatively utilized.

A controller element 24 is preferably provided as an inexpensive microcontroller, although a number of other circuit types, such as logic circuits, gate arrays, sequencers, and so forth may be alternatively utilized. Information as to the power needs of the device are stored in a section of ROM memory 26 which may be communicated by controller 24 to the external power source. In addition, data in the ROM preferably also includes information about the manufacturer, a device type, and device number.

A power supply circuit 28 is shown for controlling the power being supplied to controller 24, this circuit may simply comprise a series of diode drops with a resistor to supply the small power needs of controller 24 at a fixed voltage. The power supply prevents high voltages, which may be needed by a particular set of device circuits, from exceeding the maximum voltage allowed for controller 24. An optional capacitor 30 (internal or external) may be provided if the power to controller 24 needs to be retained when insufficient power is available from the power input (such as if the controller is signaling to an external power source that has switched to a high impedance (non-power-sourcing) input mode for receiving a voltage signal from the EPC circuit).

An optional power sensing unit 32, shown as a dual threshold voltage sensing detector is connected to the controller for signaling transitions on the input power connection. Preferably, the thresholds may be set by the controller so that the signaling levels may be detected as well as the voltage being supplied. Alternatively, the controller may have, or be connected to, an analog to digital converter wherein a wide range of voltage conditions may be detected. Alternatively, or additionally, other forms of sensing may be included such as temperature sensing, current sensing of the current flowing into the device, wherein the controller may limit the exposure not only to dangerous voltage levels but to problematic current levels as well. Preferably, the unit may also signal the external power source to make small changes to the supplied power, wherein maximum device efficiency may be maintained.

A switching circuit 34 is shown across the input connection for signaling to the external power source by modulating the load in response to a signal from controller 24. An optional protection diode 36 and fuse 38 is shown for protecting a device operating from DC to prevent damage from the use of improper supplies.

A universal adapter 50 is shown with connector 52 for connection to device 10 that contains the EPC circuitry. Connector 52 is wired 54 to a housing 56, although it may be configured to attach directly to the device at the connection without the need of the wiring. The universal adapter may be adapted to receive any of a number of power sources. By way of example an AC power system is depicted with an AC connection 58 and an AC power circuit 60, such as a transformer. Alternatively, the present system may be operated to draw power from a fuel cell, represented as a fuel container 62 connected through a sealed connection 64 with a fuel cell 66 which converts the chemical energy to electrical energy for use within universal adapter 50. A controllable power supply 68 receives the power from the input source, AC, DC, Fuel cell, and so forth and converts it to the desired voltage and current profile desired by the device being powered. A controller 70 monitors operation within the universal adapter and can communicate with the device being powered, as well as preferably control the settings of the power supply 68. An optional monitor 72 within the adapter for preventing operations that may be harmful to the device being powered.

Although it will be appreciated that the universal adapter is implemented to complement the functioning of the EPC circuit as described above and to adjust its output accordingly, a number of points should be made regarding its design.

A power watchdog circuit may be incorporated within the unit, this watchdog is preferably a power monitoring device that is programmed to set thresholds (preferably hi and low) by a controller within the universal adapter, wherein it is configured to shut down the output of the universal adapter and to annunciate a warning (sound, or display) if a power excursion occurs outside of the programmed boundaries. This is preferably utilized in addition to sensing by the power supply controller, and augments that circuit, wherein a failure in either the monitor circuit or the power supply controller, will not lead to erroneous levels of power being directed at the device.

An adapter need not be truly “universal”, however, it may be created to supply a range of power needs for various devices. In addition, an adapter may be configured with multiple outputs wherein power may be simultaneous supplied to more than one device at a time.

Adapters are generally powered from the AC line (110 VAC in the United States), however, the present universal adapter may be implemented to operate using a fuel cell to generate power for powering the external device. The input to the adapter may be driver from the power output of a fuel cell, which receives fuel from an internal storage receptacle or through a flow and retention coupling adapted for connecting a small fuel storage unit. In this way the remote adapter can power a device that is typically configured for being operated or charged where AC is available, at any location irrespective of whether AC power is available. Eventually, portable devices may incorporate their own fuel cells for providing power, however, the use of the universal adapter with power from a fuel cell allows convenient power to be provided to devices which were produced without a fuel cell due to the time of manufacture or cost considerations.

Although the universal adapter as described, is configured to automatically receive information on power needs from the remote device and to set its power output accordingly, it will be appreciated that the adapter may be preferably configured to also allow a person to manually selection power output setting for use with devices that do not contain an EPC circuit. These manual setting may comprise any desired form of electronic input device, such as switches, dials, sliders, DIP switches, insertable personality modules, keypads, on up to a full user interface. In this circumstance the unit, upon detecting that the device does not have an EPC, can output the user selected power conditions. Preferably, the adapter generates a warning to assure that the user has properly set the parameters of power to be supplied to the device to which the adapter is being connected.

The adapter may be implemented with a switching power supply configured to span a given range of voltage and maximum current conditions, with a controller adapted for controlling the output of the power supply, and adapted for monitoring the current and voltage sent to the device, which allows for communicating with the device, and properly setting the output conditions. In addition, inputs may be provided to the controller to allow a user to make a manual selection of power setting. Furthermore, a separate power monitor and cutout circuit is preferably provided which receives parameters from the controller as to the supply limits, wherein should the controller and/or power supply fail the monitor prevents incorrect power levels from being generated to the device.

Additional Aspects of the Invention:

Periodic refresh—the universal adapter and EPC circuit (preferably following a convention for the design thereof may perform periodic checks to assure that the units are operating correctly. For example, the universal adapter sends a message superimposed on the power bus to which the EPC then respond by modulating power according to the bits of an identifier response along with a status update message. It will be appreciated that the device being powered may want the power altered slightly, for example if the power regulator is heating up it may want the output voltage reduced, or alternatively if running too cool it may want it raised. In this way the device and external power source can communicate and set their operation to best suit the conditions.

Memory in the universal adapter—the adapter may be configured with sufficient memory wherein it establishes a database of each device to which it has been connected (or recently connected) based on the ID code, or other device specific identification (e.g. manufacturer+model number). The database is particularly useful if the device is subject to desiring power corrections from the universal adapter, wherein the universal adapter may be preconfigured for the units quarks (quarks being that it asked for a particular setting but then needs that adjusted based on current, temperature and so forth; so why fiddle with the inefficient operation until proper power is established?).

The universal adapter can provide an ID chip to generate ID periodically over the power line. This can be used for a less expensive charger meant for use with a particular associated device. The device may be powered by devices giving that ID, or universal adapters that go through the described handshaking process.

The present aspect of the invention may be described as a power control circuit for use in an electronic device which receives external power for operation and/or charging from an external power source, said power control circuit configured for communicating power needs to said external power source and controlling the flow of power to the circuits in said electronic device, comprising: a) a power input connection adapted for receiving electrical power from an external source of power; (b) a power control switch connected to said power input connection and adapted for controlling the flow of power to the circuits within an attached electronic device; (c) means for transmitting information to an external power device; and (d) means for activating said power control switch to allow operational and/or charge power flow to the circuits within said electronic device in response to the confirmation of proper power conditions.

The invention may incorporate the following separately or in combination.

Wherein said means for transmitting information to an external power device comprises a switching elements connected to said power input connection, wherein current or voltage changes are induced thereupon to signal an external power source.

Wherein said means for transmitting information is adapted for transmitting information about the power needs of the electronic device to which it is adapted for attachment. Wherein said information about power needs includes one or more of the following power parameters operating type of power, voltage, typical current, maximum current, frequency, maximum ripple. Wherein type of power defines how the power is to be supplied. Wherein the definition of type of power comprises DC, AC, rectified AC, current limited supply, and voltage limited supply.

Wherein said means for activating said power control circuit switch comprises a circuit adapted to register that proper power conditions have been established.

Wherein said means for activating said power control circuit switch comprises a circuit adapted to detect a confirmation message sent by an external power source that it is configured for the described power conditions.

Wherein said confirmation message includes information about the power conditions which have been established, whereby the original communication of information is verified to prevent incorrect powering of the device.

47.0 Water Filter for Providing Carbonated Water

47.1 Overview

To allow individuals to have access to carbonated water for use in drinking, use with flavorings to create carbonated beverages and so forth.

(1) Carbonated Water Only

A first embodiment provides only carbonated water, wherein a pitcher is provided with a filter element for filling. After the water has flowed into the filtered water chamber then a valve is preferably closed over the filter and the CO₂ briefly engaged to carbonate the water.

(2) Water or Carbonated Water

A first and second chamber are provided. Water is filtered into the first chamber, wherein the user can press a button for water to flow to the second chamber. Activation of CO₂ into the second chamber can carbonate it prior to, or at the time the user activates a second nozzle (or alternate flow path in a single nozzle) to pour the carbonated water into a container for use.

Preferably, the CO₂ is provided from a large canister from which single charges may be dispersed into the pressure vessel containing the water to be pressurized.

Separate output controls may be utilized, or a single output control configured with multiple positions including one for the regular water and one for carbonated water.

The present aspect of the invention may be described as a water filter with a carbonated water reservoir as described herein.

48.0 Temporary Scrolling Shade

48.1 Overview

Temporary scrolling shade particularly well suited for augmenting shade provided by a conventional set of blinds. It will be noticed that most conventional shutters do not block out all the light from the window, light still getting through the edges, between slats, and through the holes provided for the control cords.

A rollable shade that can be attached to any desired section of the window temporarily. The invention describes methods for attaching the unit using a mechanical biasing mechanism wherein it is self retained within the window frame, and the use of magnetic retention which attaches to ferrometalic portions of a window frame, or to optional ferrometallic strips.

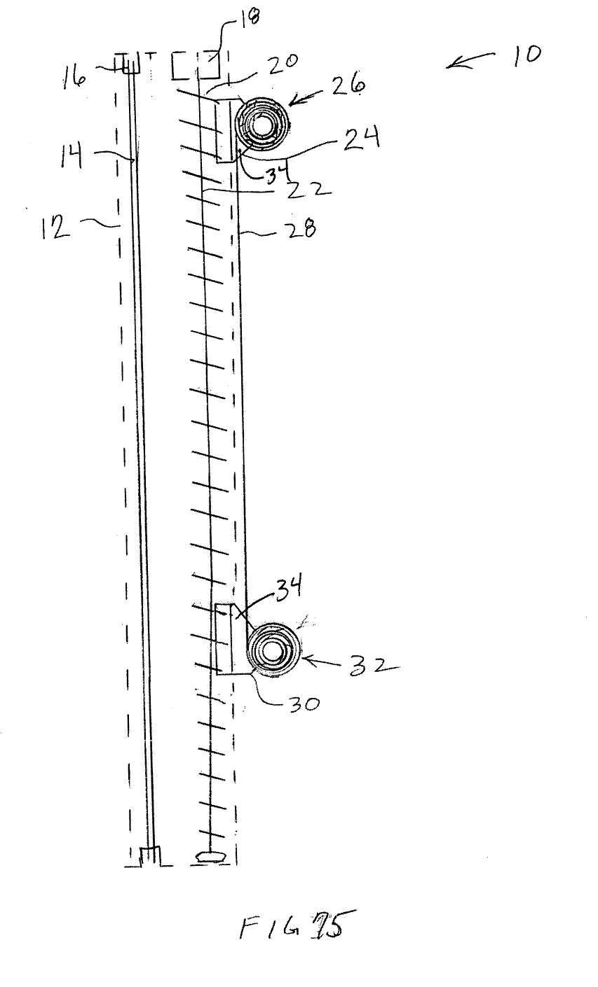

FIG. 75 exemplifies a scrolling shade 10 installed to a window with a set of blinds. A window frame is depicted 12 within which a window 14 in frame 16 are retained. A set of blinds 18, such as venetion blinds, are retained within the window frame hanging from the top of the frame. From the top of blinds 18 extends a set of louvers 20 retained by a cord 22.

The invention is a device for blocking light that may be used in conjunction with a set of blinds. It will be appreciated that a set of blinds leaves little room in the window frame for inserting other forms of blinds.

The temporary shade comprises a means for fastening to a window frame 24, generally referred to as a frame clamp, which is shown depicted as a spring loaded bar configured for being retained within the interior of the window. A first material spool 26 is rotatably attached to said means 24. An extended portion of the shade material 28 is shown extending from spool 26. The bottom of the section of material may be held down using a sufficient weight, or a second spool as shown 32 with a second frame clamp 30.

The shade material may be any material that is suitable for reducing the amount of light penetrating through the blinds. Furthermore, it may be porous wherein air may flow through the material for ventilation, although somewhat less shading efficiency can then be generally provided.

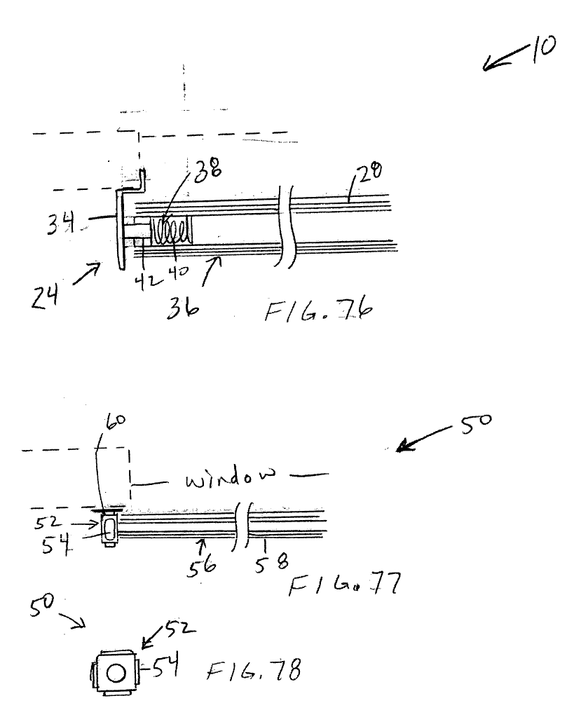

FIG. 76 depicts a top view of the frame clamp 24 with a insert plate member 34 which is configured to be inserted between the shade and the surrounding frame. An elongated housing 36 is supported between two insert plate members 34. A biasing means 38 is provided for one or both insert plate members, such as a spring 40 driving a elongated member 42. The shade material 28 is wrapped around housing 36 in one or more sections. It will be appreciated that it may be easier to size the unit to different windows by overlapping more than one section of shading material. Otherwise the material may be cut to size.

With biasing means 38 provided in a first end of the device the other end may be configured in a constant profile so that it may be cutoff along with the shade at any desired size, after which the insert plate member 34 may be inserted for holding that side of the window frame. This mechanism allows the user to size the device readily to a given window.

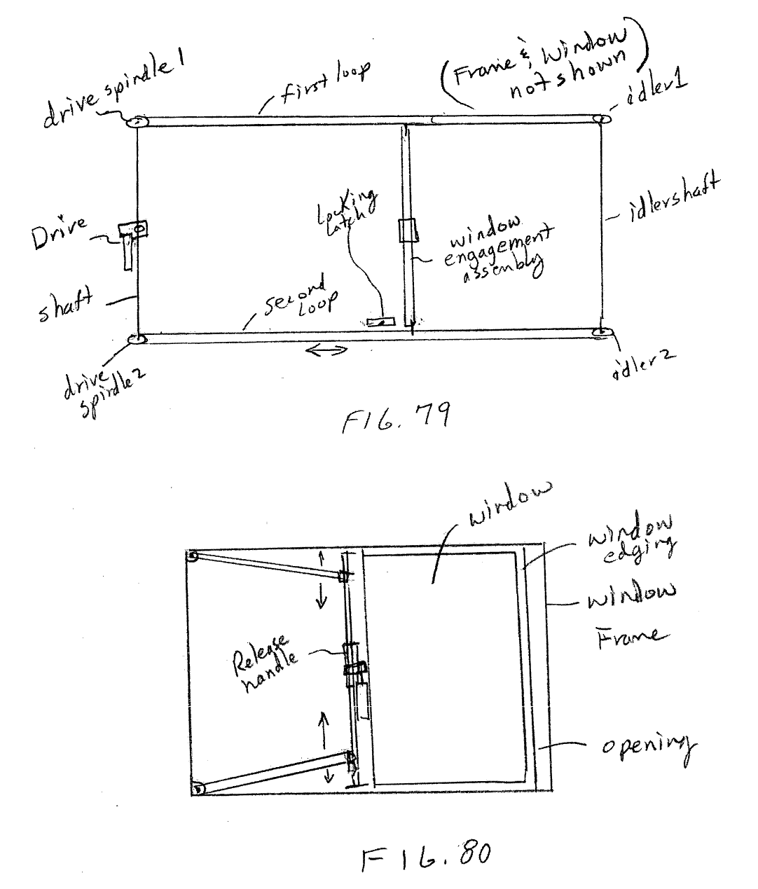

FIG. 77 and FIG. 78 depict a top view and end view of an alternative mechanism for retaining a shade to a frame. The frame clamping means 52 is magnetically attached to the frame using magnets 54, allowing the device to be put up without the spring clamps shown previously. A body of the device 56 is shown surrounded by material 58 to be unrolled to any desired region of the window. If the frame does not contain sufficient ferrous material for the magnet to operate, then a strip of metal 60 may be adhered to the front of the window frame, or preferably around the corner of the window frame to increase sucurement.

A hook and loop fastener or other form of temporary fastening means may be utilized as an alternative to the magnets.

49.0 Automated Window Control Actuators

49.1 Overview

To allow an environmental control system to automatically control the operation of windows to maximize system efficiency and comfort.

Embodiments are described for controlling the opening and closing of windows electronically, such as by an environmental control system. The embodiments also allow the user to control the windows manually without preventing automatic operation.

FIG. 79 depicts a window frame with a window pane that may be automatically moved. A drive actuator is shown connecting to a rod that drives an upper and lower spindle. A cable, or other circular drive member, is attached from the spindle to a spindle on the opposite side of the window, referred to as an idler. A window engagement assembly, which preferably looks conventional, is configured with a means for grasping the cable in response to releasing of a handle. The window can thus be moved manually by the user to any desired location, or when the handle is released, the window can be moved automatically using the drive mechanism as once the handle is released the top and bottom of the bar extending from the handle have engaged the cable that may be driven by the drive spindles.

A locking latch may be provided although a switch should be provided to inform the system not to attempt to move the window past the lock.

A set of sensors may be utilized in conjunction with the window to sense the position of the window in the frame, wherein the control system can move the window to a desired position. Alternatively, the system may sense closing position or pressure, and then always close the window before opening it to a known setting. In this way the system calibrates the system with the correct position of the window. Once the closed position is known then the controller can meter out the motion of the drive mechanism to determine any subsequent positions. The system may also be configured to detect with the window is adjusted manually, such as when the electrical continuity between the upper and lower drive cable is broken, indicating the window latch has been released.

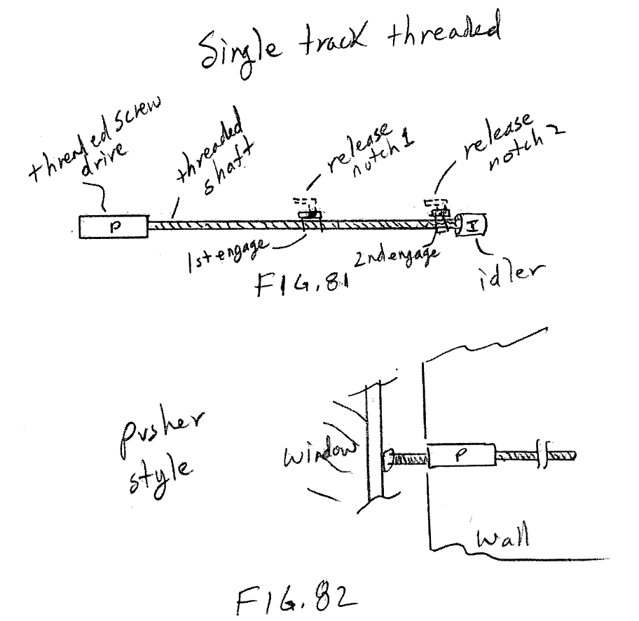

FIG. 80 depicts another embodiment with a screw drive mechanism in the middle of the window and which drives a complementary pair of spreaders having threaded ends connected to the screw drive on the movable portion of the window and whose opposing ends are secured to the non-movable frame of the window. This form of mechanism is less visually attractive than that of FIG. 1, however, it can be installed as a retrofit without the need of ripping up the exterior about the window frame.

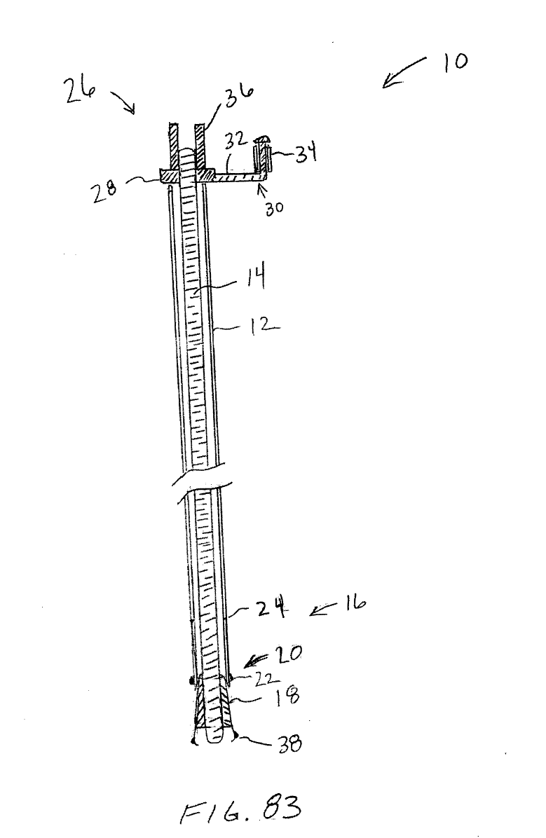

FIGS. 81 and 82 depicts another embodiment wherein a form of jackscrew is mounted in the wall and can extend and contract for moving the window frame open or closed. Upon extending from the wall, the jack screw may engage the window frame in a number of ways, such as mechanical or magnetic. For example, the jack screw may extend into a notch and then a second actuator may direct the jackscrew in a downward direction to engage a catch slot whereupon the window may be pushed or pulled. Alternatively, an electromagnet may be engaged on the end of the jack screw when it contacts a ferrous, or magnetic, material positioned in the movable frame of the window.

A simple pusher style jack screw may be utilized if the windows are only subject to automatic closing or automatic opening, depending on which side of the window the jack screws are located.

Aspects of Invention:

Wireless motorized actuator deriving its power from a fuel cell charging an energy storage capacitor. It will be appreciated that a fuel cell may provide substantial power over a period of time without losses that plague both primary and secondary battery systems. It would be impractical to create a battery power actuator as the batteries are unreliable and store little power for a power hungry application such as this.

The present aspect of the invention may be described as an apparatus for automatically adjusting sliding windows in response to commands from a environmental controller, as described herein.

50.0 Dip-Stick Tube Retention Tool

A tool for use in securing a dip-stick tube within the engine block.

Often dip-stick tubes have only been secured according to a tight friction fit, wherein as the vehicle ages the rod may disengage from the engine block whenever the dip-stick is removed for inspection.

The present invention provides a simple device for securing the dip-stick tube to the housing. It operates by expanding a lower portion of the dip-stick tube against the engine block so that it will not be subject to dislodgement.

The unit comprises an elongated member having a proximal end adapted with a force inducing means, at least one force carrying member engaged within said elongated member, and a force redirecting means at a distal end of said elongated member.

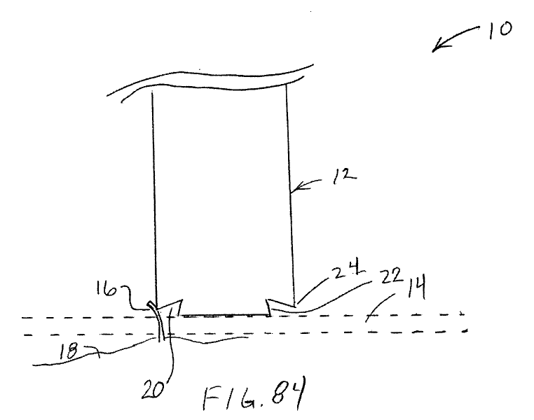

FIG. 83 depicts a cross-section of the dip-stick retention apparatus 10. An elongated housing member 12 is shown configured for insertion within a dip-stick tube (not shown). Preferably the housing member is a circular tub of at least a slightly smaller outside diameter than the interior diameter within the dip-stick tube. A force carrying member 14 is exemplified as a threaded rod. A force redirecting means 16 is located on a distal end of the elongated member to redirect forces applied external to the proximal end of the dip-stick tube to a portion of the distal end of the dip-stick tube through the force carrying member.

The implementation of the force redirecting means 16 is dependent on how the force is transferred by force carrying means 14. Within this embodiment the force is transferred by the a threaded engagement. Force redirecting means 16 within this embodiment comprises a threaded sleeve 18 threaded on a distal end of force carrying member 14, and an expansive member 20. Threaded sleeve 18 is configured so that it is unable to rotate within the interior of elongated member 12, such as by engaging protrusions from threaded sleeve 18 into slots along the exterior of the elongated member 12. The expansive member 20 herein being formed by an expansively compliant portion of the elongated member 12, having at least one protrusive expansion structure 22 to concentrate force on the dip-stick housing. Expansive member 20 is configured for expansion within this embodiment by slits 24 along the sides of the elongated housing member 12 that allow portions of its exterior to flex toward a larger expansion.

A force inducing means 26 is coupled to the proximal end of force carrying member 14. Within this embodiment utilizing a threaded force carrying member, that transfers force based on rotation of a threaded shaft, the force inducing means comprises a threaded nut member 28 adapted for being rotated on the force carrying member 14. To simplify rotation threaded nut member 28 may be configured with a manual rotation input 30, shown as a handle 32 extending from one side of threaded nut member 28 and terminating in a handle assembly 34, preferably having a pivoting handle. Alternatively, or additionally, threaded nut member 28 may be configured for rotation by using power equipment, such as a power nut driver, and is shown with a hex nut extension 36 adapted for being driven by a power nut driver.

Optionally a mean for sensing the distal end of the dip-stick tube 38 is provided so that the user can assure that the proper portion of the dip-stick tube will be expanded properly. This means is shown to comprise compliant extensions from threaded sleeve 18 which extend when elongated member 12 is sufficiently inserted

In use the apparatus is inserted into the dip-stick tube, the end of which can be sensed by the change in force as the compliant extensions reach past distal end of the dip-stick tube. Wherein the apparatus is finely positioned up or down from that point so that the portion being expanded is the correct area of the tube being held within the block or other carrier member into which the dip-stick tube is inserted.

Force is applied to the force inducing means, which in this embodiment may be performed by cranking handle 34 or connecting a nut-driver to hex nut 36. As threaded shaft 14 rotates in a first direction threaded sleeve 18 moves toward the proximal end of the elongated member 12 and causes outward extension of protrusive expansion structures 22 which engage the interior of the dip-stick tube. Continued rotational force to the handle causes the expansion structures 22 to continue expanding a portion of the dip-stick tube against the block. In the process of which the dip-stick tube is expanded to supply a sufficient retention pressure within the block, or other structure, into which it is inserted. The rotation of the handle may then be reversed to back our the threaded sleeve 18 so that the apparatus may be removed from the dip-stick tube. The dip-stick tube is now properly retained and the dip-stick may be reinserted for use.

The elongated member may be implemented as a flexible tubular housing, such as a tight spring, that is not substantially compressible, with a fixed tubular section at the end that provides for the expansion. The threaded rod may also be configured with one or more flexible couplings therein to allow the unit to be bent to follow the curvature of a given dip-stick tube. Other mechanisms may also be utilized for making the apparatus flexible.

It will be appreciated that the elements described within the invention may be practiced in a number of alternative ways without departing from the teachings of the present invention. Force may be transferred from the proximal end of the apparatus to the distal end by any convenient methodology. The following being provided by way of example and not of limitation: (1) Compressive impact rods are driven (struck or otherwise longitudinally induced (i.e. threaded sections, etc.) at the proximal end of the elongated member while their force at the distal end is directed outwardly to expand the dip-stick tube. The force may be redirected using pivoting bell cranks, curving sections that redirect the force, and other mechanical force transfer devices. (2) Tension impact rods connected to bell cranks or similar devices are pulled upon while the elongated member is held in place. The tension force is thereby redirected against the exterior of the dip-stick tube causing expansion.

It will be appreciated that the present concept may also be extended to non-mechanical means of securing the dip-stick, such as using a spot welding head extended down the dip-stick tube for welding the distal end of the tube into the block.

The present aspect of the invention may be described as an apparatus for securing a dip-stick tube inserted within a block, or other carrier member, comprising: (a) an elongated member adapted for insertion within a dip-stick tube that is inserted within a block or other carrier member; (b) a force carrying member retained within said elongated member; (c) means for redirecting force from said force carrying member to apply pressure to the interior of said dip-stick tube near a distal end of said elongated member; and (d) means for inducing force into said force carrying member at a proximal end of said elongated member to control the expansion of a portion of said dip-stick tube in response to the motion of said means for redirecting force.

The following aspects may be incorporated separately or in combination.

Wherein said force carrying member comprises a threaded shaft.

Wherein said means for redirecting force comprises a threaded coupling attached to said force carrying member that moves in relation to said elongated member in response to rotation of said force carrying member.

Wherein said means for inducing force comprises a threaded nut adapted for being manually rotated on said threaded shaft comprising said force carrying member.

Wherein said elongated member is approximately the length of said dip-stick tube.

Wherein said elongated member is at least ten inches in length.

51.0 Cutting Head for Electric Razor

Increase the closeness of shaving with an electric razor. The cutting blade is profiled with structures on either side of the blade which do not extend as far as the cutting blade but that extend the hair prior to being cut by the edge of the blade.

FIG. 84 depicts a portion of a cutting head 10 according to the invention. One of the cutting blades 12 is shown edge-wise in contact with a micro screen 14 through which hairs 16 can extend from the skin 18 of the user for being cut by the cutting blade 12. Cutting blades are typically fabricated from hardened steel for clean cutting and long wear, although the invention may be practiced with cutting blades of any material. A recess 20 has been cut into the corner of the each side of cutting blade 12, to result in a cutting blade edge 22 and a extender surface 24. Hair 16 is first contacted by the extender surface 24 which extends the hair slightly prior to be cut the edge of the blade surface 22.

It will be appreciated that the puller edge of the blade may be formed by subtractive methods, such as cutting into the blade edge, or additive methods wherein materials are added to the sides of the blade surface to extend therefrom and to contact the hair prior to the edge of the cutting blade into contact with the hair. For example, a polymeric material could be adhered to the sides of the blade which could tack onto the hair to aid in extending it prior to cutting.

It should be appreciated that the shape of these “extending” structures may take many forms, and provide a force against the hair by mechanical engagement, adhering contact, or other forms of extension.

To increase surface area contact with each hair the edge of extender surface 24 may be serrated with a small pitch, preferably about 25% less than the average diameter of “stubble” hairs typically encountered, wherein the hair is better engaged for extension and a close shave resulting.

The blade may be manufactured by conventional processes with an edge profiling operation performed to remove the materials to form the extender surfaces, which are preferably provided on both sides of the cutting blade. Laser cutting operations may also be utilized to remove material.

Materials may be added to the exteriors of a conventional blade, such as a polymeric material which is molded or adhered to the side of the blade material.

The present aspect of the invention may be described as a cutting blade for an electric shaver as described herein, or a method of profiling a cutting blade for an electric shaver.

52.0 Powering of Shaving Razors

To provide more convenient mechanisms for powering portable razors, which typically utilize a cutting blade that moved over a screen surface through which hairs to be cut protrude.

Currently electric shavers have rechargeable batteries that suffer from a number of drawbacks: long recharge times, charge depletion when not connected to a power source, very limited use between charges, and the onset of memory within the battery due to short cycling which can significantly reduce power under battery operation and necessitate a connection to an AC outlet for a proper shave.

Therefore, a need exists for methods and systems of powering portable shavers that will increase their ability to be truly portable, the present invention satisfies that need as well as others and overcomes many shortcomings of the present devices.

(1) Fuel Cell Charged Super Capacitor Powered Electric Razor:

A low output fuel cell operating from a fuel cartridge is utilized for generating a low current substantially constant output during the charging of a super capacitor, which retains sufficient charge energy for about one shave. Once the super-capacitor is charged the fuel cell is deactivated, such as by preventing fuel flow. The fuel cell may be operated in a periodic trickle mode, in which a controller awakens periodically to assess the charge on the fuel cell, wherein it may operate the fuel cell for a period of time to recharge the supercapacitor. During operation of the razor the fuel cell is activated to aid in boosting the power to the electric motor, and to reduce the depth of discharge. Supercapacitors provide a number of benefits including fast recharge times and no charge memory. The fuel-cell supercapacitor combination may be utilized in additional portable devices and appliances.

The system preferably utilizes a voltage-variable input regulator that generates a desired constant voltage or current to the electric motor, and any other electric powered elements. The variable voltage regulator may be implemented as a switching power supply or any other convenient circuit that is adapted for generating the requisite fixed output current or voltage over a wide range of input supply voltages as the supercapacitor depletes.

(2) Fuel Cartridge Powered Otto Cycle Razor:

As fuel cartridges become available for powering fuel cells, the same form factor, and in many cases the same fuel may be utilized for powering a small otto engine within a razor for powering the mechanical movement of the heads. It will be appreciated that a fuel cell applied to a mechanical output application requires dual conversion—to electric power and then from electric to mechanical. Although the efficiencies may be high the cost may also be very high. The present invention, allows the compact use of preferably standardized fuel cartridges as a fuel source for a razor having a small gas powered engine operating from the fuel.

A supercapacitor, primary or secondary battery, may be utilized within the razor for starting the engine. The engine preferably operates a small generator, wherein once utilized, the unit can recharge itself so long as fuel remains.

A monitor may be provided that can automatically operate the engine, (preferably clutched so as not to activate the blades) for charging the capacitor if the energy is being depleted. Alternatively a mechanical energy coupling, such as a wind up spring, geared up winder, or so forth, mechanism that is coupled to a generator for providing sufficient charge to the supercapacitor and/or the mechanical engagement of the motor to turn it over during a startup operation.

To reduce noxious fumes the fuel cell may comprise pure hydrogen, or an otherwise hydrogen-rich fuel.

(3) Super-Capacitor Powered Electric Razor:

Providing a high current charging system coupled to a super-capacitor provides enhanced portability for an electric razor. The super-capacitor may be charged in a matter of minutes since no electrochemical conversion process is necessary. The charge retention is superior than that provided by conventional battery driven razor, while the charge memory problem is eliminated.

Since the voltage curve of the super-capacitor lacks a constant voltage shelf as exhibited by batteries, a variable voltage input regulator is provided within the razor that generates a fixed output current, or voltage, to the electric motor (and any other electrical systems) despite the variable voltage at the output of the supercapacitor. The variable voltage regulator may be implemented as a switching power supply or any other convenient circuit that is adapted for generating the requisite current over a wide range of supply voltages.

The present aspect of the invention may be described in a number of ways including (1) a fuel cell charged super capacitor powered electric razor as described herein; (2) a method of powering an electric razor from a supercapacitor whose charge is retained by the electrical output of a fuel cell as described herein; (3) a fuel cartridge powered otto cycle razor as described herein; (4) a method of powering an electric razor from a fuel cartridge powering a otto cycle as described herein; (5) a super-capacitor powered electric razor as described herein; (6) a method of powering an electric razor from a supercapacitor feeding a voltage variable regulator connected to the electrical motor, as described herein.

53.0 A Laptop Ventilation Device

A portable device for improving the ventilation about a laptop computer. A laptop prop—a portable device for retaining the rear of a laptop away from the surface on which it sets to facilitate cooling of the laptop as evidenced by the temperature of the underside of the laptop.

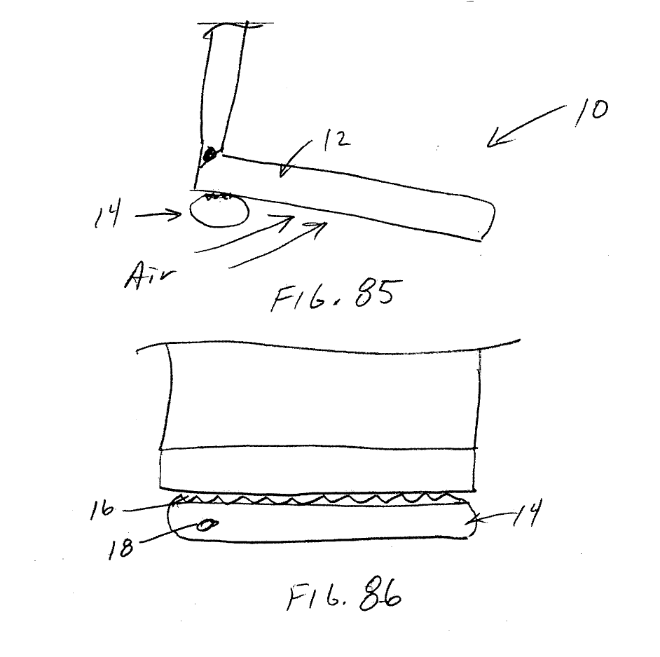

FIG. 85 exemplifies a prop under a laptop 10. A laptop computer 12 is shown with its rear propped on a ventilation device 14. This version of the ventilator device 14 is configured to be blown up prior to use, wherein it can stow in a deflated condition when not being utilized.

FIG. 86 depicts the ventilation device 14 engaged under the laptop with optional enhanced ventilation structures 16 which extend from at least a portion of device 14 to allow air to ventilate from front to back. These structures are preferably formed from a semi-rigid material and need not extend very far. The preferred enhanced ventilation structures extend from 1/16 inch to 1/2 inch and are attached to a plastic bar connected to the inflatable housing of the ventilation device 14. A filling aperture with plug 18 is shown for filling the prop to provide the desired amount of extension.

Alternatively, a strip which folds along a long axis or otherwise is engaged or assembled from a substantially two dimensional structure into a three dimensional structure configured for supporting a portion of a laptop to enhance ventilation.

The present aspect of the invention may be described as an apparatus for enhancing laptop ventilation as described herein.

54.0 Interpretation of Disclosure Interpretation

The aspects, modes, embodiments, variations, and features described are considered beneficial to the embodiments described or select applications or uses; but are illustrative of the invention wherein they may be left off or substituted for without departing from the scope of the invention. For example, one of ordinary skill may find other suitable substitutes for certain applications.

Moreover, inventive aspects according to the various embodiments of the invention may be provided with all with all of features described herein, or only portions thereof, which combinations may be sold together or separately. In this regard, embodiments may be “adapted to” include or otherwise couple to such equipment without departing from the intended scope hereof.

It should be appreciated that each aspect of the invention may generally be practiced independently, or in combinations with elements described herein or elsewhere depending on the application and desired use. Modes may be utilized with the aspects described or similar aspects of this or other devices and/or methods. Embodiments exemplify the modes and aspects of the invention and may include any number of variations and features which may be practiced with the embodiment, separately or in various combinations with other embodiments.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A method of controlling a display element within an array of display elements by utilizing row and column signals, comprising:
integrating a control circuit within a display element wherein said row and column lines are operably connected to said control circuit which connects to said display element;
maintaining a sufficient power on said row and column lines for continuously powering said control circuit and associated display element;
communicating an activation signal between said row and column lines to which said control circuit is connected;
activating said display element upon receipt of said activation signal by said control circuit; and
maintaining said display element activation by said control circuit from the power on said row and column lines for a predetermined duration after said activation signal is no longer being received.

2. A method as recited in claim 1, wherein said display element contains at least one light emitting diode.

3. A method as recited in claim 1, wherein said activation signal comprises a sufficient change in voltage across said row and column lines to be detected by said control circuit.

4. A method as recited in claim 3, wherein said activation signal comprises transitions in the signal between said row and column which are identified by said control circuit as an activation signal.

5. A method as recited in claim 1, wherein said predetermined duration comprises a time period bounded by the receipt of a subsequent signal.

6. A method as recited in claim 5, wherein said subsequent signal comprises a signal associated with a subsequent scan of the display element for setting it to a new state.

7. A method as recited in claim 6, wherein said subsequent signal comprises a row signal transitioning from a first state to a second state.

8. A method as recited in claim 6, wherein said subsequent signal comprises a column signal transitioning from a first state to a second state.

9. A method as recited in claim 1, wherein said predetermined duration comprises a count value received from said row and column lines by said controller, that is modified toward a terminating count value.

10. A method as recited in claim 1, wherein said predetermined duration comprises a predetermined time value as determined by control circuit configuration.

11. A method as recited in claim 1, wherein said predetermined duration comprises a duration value programmed in response to the signal relationships between said row and column lines.

12. A method as recited in claim 11, wherein said predetermined duration comprises the duration of the column signals while said row signals are active.

13. A method as recited in claim 11, wherein said predetermined duration comprises the duration of the row signals while said column signals are active.

14. A display element configured for being connected to a set of row and column addressing lines, comprising:
a visual output element adapted for displaying at least two states within a display element;
a control circuit within said display element which is adapted for connecting between a single row and a single column within the set of row and column addressing lines, and said visual output element;
an activation signal detector within said control circuit, said activation signal detector being adapted for detecting an activation signal on said row and said column lines; and
a visual output element driver within said control circuit, said visual output element driver being adapted for driving said visual output element from power received between the row and column lines;
said control circuit being adapted to activate said visual output element driver to supply power to said visual output element upon detection of an activation signal from said activation signal detector and to continue supplying said power for a predetermined duration after said activation signal is no longer present.

15. A display element as recited in claim 14, wherein said visual output element comprises at least one light emitting diode.

16. A display element as recited in claim 14, further comprising a reset signal detector within said control circuit; wherein upon detecting a reset signal on said row and said column lines said control circuit deactivates said visual output element driver to discontinue supplying power to said visual output element.

17. A display element as recited in claim 14, wherein said activation and reset signals are conveyed as changes in voltage potential between the row and column lines.

18. A system for displaying visual information on a multiplexed array of display elements interconnected on a grid of row and column address lines, comprising:
a row and column driver circuit adapted for activating selected display elements within said array in response to signals received from an image controller;
said row and column driver adapted for outputting a sufficient continuous power between said row and column and superimposing control signals thereupon for controlling said activating of said selecting display elements;
a display element adapted with a element control circuit interposed between the connection to said row and column lines and a visual output element;
said element control circuit adapted for activating said visual output element in response to controlling signals received over said row and column lines from said row and column driver circuit and maintaining the visual output element in an active state for a predetermined duration while other rows and columns of display elements are being activated during the multiplexing of the display.

19. A method of controlling a display element within an array of display elements by utilizing row and column signals separate from a power bus being applied to said display elements, comprising:
integrating a control circuit within a display element;
detecting the presence of an activation signal between said row and column lines by said control circuit; and
directing power from a power bus by said control circuit to said display element for a predetermined interval following said detected signal.

20. A method as recited in claim 19:
wherein said activation signal is detected as an electric field potential generated between said row and said column sufficiently proximal to said control circuit to be registered therein;
wherein said row and column signals are provided on a wiring grid retained in a substantially fixed position in relation to said display element.

21. A method of extending the active interval of a display element within a multiplexed array of elements interconnected with row and column lines, comprising:
integrating a control circuit within a display element;
charging a capacitor at a first rate in response to the presence of power between said row and column lines as said display element is being selected during multiplexing; and
supplying power at a second rate from said capacitor to a visual output element within said display element;
wherein said first rate substantially exceeds said second rate wherein the time over which the visual output element is active exceeds the time for which power was available between the row and column lines.

22. A method of programming individual input and/or output circuit elements within an array to an address associated with their physical position within the array, said elements within said array being operably connected to a common bus, comprising:
(a) entering a programming mode for said elements within which non-volatile memory locations may be loaded;
(b) receiving clocking from the common bus;
(c) maintaining an address count based on clocking from said common bus;
(d) comparing external events against a predetermined threshold; and
(e) loading said address count into said non-volatile memory when said external event crosses said predetermined threshold;
whereby said element when not in programming mode will be responsive to a relationship between the address on the common bus and the address count loaded in said non-volatile memory.

23. A method as recited in claim 22, wherein said programming mode is entered as a result of changing the voltage being applied to said element.

24. A method as recited in claim 23, wherein said voltage is increased from a normal range to a programming voltage range to enter the programming mode.

25. A method as recited in claim 23, wherein said programming mode is entered in response to a set of signals received over the common bus.

26. A method as recited in claim 25, wherein said set of signals comprises a predetermined specifier directing said element to enter programming mode.

27. A method as recited in claim 26, wherein said specifier may be directed at elements that have not been programmed.

28. A method as recited in claim 26, wherein said specifier may be directed at all elements, regardless of whether they have been programmed.

29. A method as recited in claim 26, wherein said specifier may be directed at elements programmed within a specified range of addresses.

30. A method as recited in claim 22, wherein said relationship between the address on the common bus and the address count loaded in non-volatile memory is that of equality.

31. A method as recited in claim 22, wherein said relationship between the address on the common bus and the address count loaded in non-volatile memory is that of a complement.

32. A method as recited in claim 22, wherein said relationship between the address on the common bus and the address count loaded in non-volatile memory allows said address on said common bus can be interpreted for selecting separate elements within said array.

33. A method as recited in claim 22:
wherein said common bus provides the same set of common signals to all elements within the array;
wherein said common bus does not provide separate address lines within the array;
wherein said common bus does not provide separate row and column address lines to the rows and columns of elements within the array.

34. A method as recited in claim 22, wherein said external event comprises sensing light intensity changes.

35. A method as recited in claim 22, wherein said external event comprises sensing field intensity changes.

36. A method as recited in claim 35, wherein said fields are generated between rows and columns.

37. A method as recited in claim 35, wherein said changes occur within predetermined frequency limits.

38. A method as recited in claim 35, wherein said changes occur in a pattern.

39. A method as recited in claim 38, wherein said pattern comprises an identifier.

40. A method as recited in claim 38, wherein said pattern comprises a command specifier.

41. A method as recited in claim 35, wherein said fields comprise magnetic field intensity changes.

42. A method as recited in claim 35, wherein said fields comprise electric field intensity changes.

43. A method as recited in claim 22, wherein said external event comprises sensing changes in pressure.

44. A method as recited in claim 22, wherein said external event comprises sensing changes in temperature.

45. A circuit element configured for being programmed to respond according to its specific position within an array of circuit elements interconnected by a set of common signals, comprising:
address extraction circuit within said circuit element adapted for extracting addressing information from said common signals;
sensing element operably connected to said circuit element;
non-volatile memory; and
control circuitry within said circuit element adapted for programming extracted addressing information from said common signals into said non-volatile memory in response to a predetermined threshold condition being crossed for said sensing element;
whereby said control circuitry is further adapted for responding to said programmed addressing information for outputting from said set of common signals and/or collecting data for communication over said set of common signals.

46. A method of programming physical element position upon a circuit element connected to a set of common signals within an array of circuit elements, said programming performed based on the proximity of neighboring elements, comprising:
(a) maintaining an address value based on signals registered from said set of common signals;
(b) entering a programming mode;
(c) registering a trigger signal from an adjacent circuit element;
(d) loading said address value which has been maintained at a predetermined offset from said trigger signal into a memory, wherein said address in said memory forms the address of said circuit element to which said element will respond when operating in a non-programming mode; and
(e) generating a trigger signal to a proximal circuit element at a predetermined time for programming this subsequent circuit element within the array.

47. A method as recited in claim 46, wherein said address value maintenance comprises counting in response to clock signals found within said set of common signals.

48. A method as recited in claim 47, wherein column and row clocks are embedded within said set of common signals.

49. A method as recited in claim 46, wherein said programming mode is entered in response to signals detected within said set of common signals.

50. A method as recited in claim 46, wherein said programming mode is entered in response to a detected change in operating voltage.

51. A method as recited in claim 46, wherein said memory comprises a non-volatile memory wherein the address value is maintained even when the operating power to said circuit element is no longer present.

52. A method as recited in claim 51, wherein said non-volatile memory comprises FLASH ram.

53. A method as recited in claim 46, wherein said trigger signal comprises an optical signal.

54. A method as recited in claim 46, wherein said trigger signal comprises an electric or magnetic field signal.

55. A method as recited in claim 46, wherein said trigger signal is selected from the group of signals capable of being communicated remotely consisting of chemical, mechanical motion, vibration, acoustic, sound, and heat.

56. An apparatus for displaying a text or graphics legend in response to rotating a control knob, comprising:
a rotating knob adapted for connection to a rotary encoding means;
electronic ink with a backing electrode; and
a plurality of electrodes adapted for passing over said electronic ink in response to the motion of said rotating knob and setting the display state thereof in response to signals received from a controller.

57. An apparatus for displaying text and graphics from a movable member subject to angular displacements of a non-predetermined rate, comprising:
a display providing at least one row of pixels and adapted for being aligned extending radially along said movable member;
means for determining angular position of said display during the travel of said movable member; and
a controller adapted to register the angular position of said movable member containing said display and generate a display output in response to angular position.

58. An apparatus as recited in claim 57, wherein said movable member is selected from movable member subject to angular displacements of non-predetermined rate consisting of: fans, windmills, wheels of moving vehicles, and pant legs of pedestrians.

59. An apparatus as recited in claim 57, wherein said means for determining said angular position of said display comprises:
a photosensor adapted for detecting lighting changes in response to angular position as said angular displacement changes; and
a controller adapted to determine rotational speed in response to the periodicity of said lighting changes being detected.

60. An apparatus as recited in claim 57, wherein said means for determining said angular position of said display comprises:
a magnetic sensor adapted for detecting changes in magnetic flux in response to angular position as said angular displacement changes; and
a controller adapted to determine rotational speed in response to the periodicity of said magnetic flux changes.

61. An apparatus as recited in claim 60, further comprising a magnet positioned proximal to said movable member and adapted for generating sufficient magnetic flux for registration by said magnetic sensor.

62. An apparatus as recited in claim 57, wherein said means for determining said angular position of said display comprises a compass.

63. An apparatus as recited in claim 57, wherein said means for determining said angular position of said display comprises an acceleration sensor for detecting changes in acceleration in response to angular position.

64. An apparatus as recited in claim 63, wherein said acceleration sensor is adapted for sensing the angular position of a movable member being angularly displaced along a plane having a vertical component of travel.

65. An apparatus as recited in claim 64, wherein said movable member comprises a vertically oriented wheel.

66. An apparatus for displaying text and graphics from the rotating blades of a fan, comprising:
a display providing at least one row of pixels and adapted for being aligned extending radially along said blades;
means for determining angular position of said display during the travel of said fan; and
a controller adapted to register the angular position of said blade containing said display and generate a display output in response to angular position.

67. An apparatus for displaying text and graphics from a rotating wheel, comprising:
a display providing at least one row of pixels and adapted for being aligned extending radially along said wheel;
means for determining angular position of said display during the travel of said wheel and
a controller adapted to register the angular position of said wheel containing said display and generate a display output in response to angular position.

68. An apparatus as recited in claim 67, wherein said wheel comprises the wheel of a motor vehicle, bicycle, or wheel chair.
